(19) United States
(12) Patent Application Publication
(10) Pub. No.: US 2025/0262839 A1
(43) Pub. Date: Aug. 21, 2025

(54) MULTI-MATERIAL SHEATHING SYSTEM WITH IMPROVED THERMAL INSULATION PERFORMANCE

(71) Applicant: Owens Corning Intellectual Capital, LLC, Toledo, OH (US)

(72) Inventors: Hai Fu, Pataskala, OH (US); José Luis Méndez-Andino, New Albany, OH (US); Xiaomin Guo, New Albany, OH (US); Brandon Michael Robinson, Sylvania, OH (US); Chase James Boudreaux, Canton, OH (US); Jeffrey Stephen Thomas, Mogadore, OH (US); Mitchell Zane Weekley, Tallmadge, OH (US); Christine Anne Heppe, Norton, OH (US); Laura Frazier, Kent, OH (US)

(21) Appl. No.: 19/053,589

(22) Filed: Feb. 14, 2025

Related U.S. Application Data
(60) Provisional application No. 63/554,270, filed on Feb. 16, 2024.

(51) Int. Cl. B32B 5/20; B32B 21/08; B32B 37/15

(52) U.S. Cl. CPC B32B 5/20; B32B 21/08; B32B 37/153; B32B 2255/102; B32B 2255/26; B32B 2305/022; B32B 2307/302; B32B 2307/3065; B32B 2307/704; B32B 2307/72; B32B 2419/00

(57) ABSTRACT

A sheathing system that envelops a building structure includes a multi-layer panel having at least one structural layer formed of a non-wood material, such as polycarbonate. The panel also includes at least one layer of a high R-value insulation material. The insulation layer includes a coated insulation product with a reduced fluorinated blowing agent concentration, while maintaining acceptable thermal properties. The coated insulation product includes a foam product that is coated with a barrier coating. The barrier coating includes a polymer having a minimum degree of crystallinity and at least one additive.

### CROSS-REFERENCE TO RELATED APPLICATION

This application claims priority to and any benefit of U.S. Provisional Application No. 63/554,270, filed Feb. 16, 2024, the content of which is incorporated herein by reference in its entirety.

### BACKGROUND

In contemporary building construction, wall sheathing systems are employed to provide structural support, insulation, and protection against external environmental factors. Conventional wall sheathing materials, such as plywood and oriented strand board (OSB), have been widely used and are typically seen as capable of providing structural support or rigidity to a structure; however, these materials generally lack sufficient thermal insulation properties. Among other shortcomings, the inadequate insulating property of conventional sheathing translates into greater energy expenditures to maintain the temperature and humidity levels of conditioned spaces.

To address the insulation challenge, traditional practice involves the application of separate insulation layers in conjunction with conventional wall sheathing materials. While this approach can enhance energy efficiency, it adds complexity to the construction process and increases material and labor costs. In addition to its limited ability to insulate, conventional wall sheathing materials are also susceptible to moisture infiltration and degradation over time, which can compromise both the structural integrity and thermal performance of the building envelope. To address the moisture problem, conventional building practices call for wrapping sheathing with a water-resistant wrap. Applying wrap is a labor-intensive task, which can increase labor and material costs. Moreover, wraps are generally susceptible to being displaced during construction and can trap moisture between the wrap and sheathing.

In an attempt to address the aforementioned problems, conventional sheathing materials have evolved into more complex assemblies, wherein multiple materials are joined together to form an integral multi-material sheathing (MMS) material. The MMS material is usually formed as a panel of a predetermined size, such as 4-foot by 8-foot.

For example, as shown in FIGS. 1A-1B, a conventional MMS material 100 (e.g., panel) comprises two distinct layers and is formed by coupling a layer of OSB 102 having a thickness of 7/16 inch and a layer of extruded polystyrene (XPS) foam insulation 104 having a thickness of ¾ inch. The panel 100 has a thickness Pₜ of 1.19 inches and a weight of 56 pounds. The panel 100 has a racking strength of 477 pounds per linear foot (plf), a max deflection of 3.4945 inches, and a nail retention of 60 pounds. Consequently, the panel 100 is considered a structural panel. A structural sheathing panel provides integrity and rigidity to the building structure, fortifying it against internal and external forces. For example, the structural sheathing panel provides shear resistance to the building. The structural sheathing panel also provides a suitable surface for application of other materials (e.g., siding).

The panel 100 has a nailing torque force of at least 270.9 pounds. The arrow 110 in FIG. 1B shows the panel 100 oriented in an installation direction (i.e., facing a frame of a building structure, such as wall studs or roof trusses). By virtue of combining the layers 102 and 104, the panel 100 is effective as both a sheathing and an insulating material, with the panel 100 providing adequate structural support when installed to the frame.

As another example, as shown in FIGS. 2A-2B, a conventional MMS material 200 (e.g., panel) comprises two distinct layers and is formed by coupling a layer of OSB 202 having a thickness of ¼ inch and a layer of extruded polystyrene (XPS) foam insulation 204 having a thickness of ¾ inch. Thus, the layer of OSB 202 is substantially thinner than the layer of OSB 102 described above. The panel 200 has a thickness Pₜ of 1 inch and a weight of 30 pounds. The panel 200 has a racking strength of 347 pounds per linear foot (plf), a max deflection of 3.1739 inches, and a nail retention of 20 pounds. Consequently, the panel 200 is considered a non-structural panel. The panel 200 has a nailing torque force of 206.3 pounds. The arrow 210 in FIG. 2B shows the panel 200 oriented in an installation direction (i.e., facing a frame of a building structure, such as wall studs or roof trusses). By virtue of combining the layers 202 and 204, the panel 200 is effective as both a sheathing and an insulating material; however, the reduced thickness of the layer 202 means the panel 200 itself does not provide adequate structural support when installed to the frame.

As yet another example, as shown in FIGS. 3A-3B, a conventional MMS material 300 (e.g., panel) comprises three distinct layers and is formed by coupling a layer of OSB 302 having a thickness of 7/16 inch between a layer of polyisocyanurate (polyiso) foam insulation 304 having a thickness of 1 inch and a relatively thin barrier layer 306. The barrier layer 306 comprises a bulk water resistant and water vapor permeable material (e.g., a resin-impregnated paper) having a thickness much less than 1/16 inch. The panel 300 has a thickness Pₜ of 1.5 inches and a weight of 60 pounds. The panel 300 has a racking strength of 388 pounds per linear foot (plf), a max deflection of 3.7245 inches, and a nail retention of 60 pounds. Consequently, the panel 300 is considered a structural panel. The panel 300 has a nailing torque force of 240.5 pounds. The arrow 310 in FIG. 3B shows the panel 300 oriented in an installation direction (i.e., facing a frame of a building structure, such as a wall or roof). By virtue of combining the layers 302, 304, and 306, the panel 300 functions as a sheathing material, an insulating material, and a water-resistant material, with the panel 300 providing structural support when installed to the frame. Use of the panel 300 may obviate the need for installing a separate house wrap.

Notwithstanding these conventional assemblies, there is still an unmet need for an improved integral sheathing panel that better balances physical properties (e.g., thickness, weight), short term performance (e.g., racking strength, max deflection, nail retention), and long term performance (e.g., nailing torque force) of the panel.

Additionally, as one of ordinary skill in the art may appreciate, the insulation layer in conventional wall sheathing systems can include a variety of materials, including polymer foams. Polymer foams, such as extruded polymer foams or “XPS” foam, are generally manufactured by melting a polymer matrix composition to form a polymer melt and incorporating one or more blowing agents and other additives into the polymer melt under conditions that provide for the thorough mixing of the blowing agent and the polymer. The incorporation of blowing agents and additives to the polymer melt facilitates proper mixing while preventing the mixture from foaming prematurely. This mixture is then typically extruded through a single or multi-stage extrusion die to cool and reduce the pressure on the mixture, allowing the mixture to foam and produce a foamed product. As will be appreciated, the relative quantities of the polymer(s), blowing agent(s), and additives; the temperature; and the manner in which the pressure is reduced will impact the quality of the resulting foam product. As will also be appreciated, the foamable mixture is maintained under a relatively high pressure until it passes through an extrusion die and is allowed to expand in a region of reduced pressure.

The solubility of conventional blowing agents, such as chlorofluorocarbons (“CFCs”) and certain alkanes, in a polymer melt tends to reduce the melt viscosity and improve cooling of expanded polymer melts. For example, the combination of pentane and a CFC, such as Freon 11 or 12 is partially soluble in polystyrene and has been used for generating polystyrene foams that exhibited a generally acceptable appearance and physical properties such as surface finish, cell size and distribution, orientation, shrinkage, insulation property (R-value), and stiffness.

However, in response to the environmental concerns regarding the use of such CFC compounds, the widespread use and accompanying atmospheric release of such compounds in applications, such as aerosol propellants, refrigerants, foam-blowing agents and specialty solvents, has been drastically reduced or eliminated by government regulation. The divergence away from the use of CFCs has led to utilization of alternative blowing agents, such as hydrogen-containing chlorofluoroalkanes (“HCFCs”). HCFCs, however, still contain some chlorine and are therefore said to have an ozone depletion potential (“ODP”).

Another class of blowing agents, hydrofluorocarbons (HFC's), have been used as more ozone friendly options, offering desirable improvements, such as zero ODP and lower (but still potentially significant) global warming potential (GWP). However, these compounds are expensive, tend to be less soluble in polystyrene, and can still have significant GWP. For example, HFC-134a has a GWP of 1430.

Hydrofluoroolefin (“HFO”) blowing agents, which are a type of fluorinated alkene, are more environmentally friendly than traditional halogenated blowing agents (e.g., (cis and/or trans)-1,1,1,4,4,4-hexafluoro-2-butene (HFO-1336mzz) and (cis and/or trans)-1,3,3,3-tetrafluoropropene (HFO-1234ze)). For example, HFOs have reduced ODP and GWP values when compared to traditional fluorocarbon and hydrofluorocarbon blowing agents. Although conventional blowing agent compositions comprising certain HFOs may be capable of forming foam insulation products with acceptable initial physical properties (i.e., thermal conductivity, R-value, etc.), any foam products foamed by entrapping gas within the cells of the foam will experience diffusion of the gas, which negatively impacts the foam's thermal performance. Additionally, due to such diffusion, there is a limit to the level of thermal performance such a foam can achieve. Accordingly, there exists a need for foam insulation products formed with environmentally friendly blowing agents (ODP not greater than 0.05 and GWP values below 150) that can reduce diffusion of glass blowing agents through the foam and achieve insulation or “R-values” (both initial and aged according to ASTM C578-22) above conventional insulation products, and maintain such insulation values over time.

### SUMMARY

The present disclosure is directed to a high strength but lightweight multi-material sheathing (MMS) system that, when utilized to envelop at least a portion of a building structure, provides enhanced thermal insulation and weather resistant properties. The disclosed wall sheathing system combines lightweight structural layer(s) and a high R-value insulation layer to provide a unique solution. Embodiments of the present disclosure relate to a sheathing system that utilizes one or more thin layers of strong yet lightweight material, combined with a high R-value insulation layer. In some embodiments, a layer of OSB is also utilized. The collective layers of the sheathing system may offer benefits including, but not limited to, decreased thickness, reduced weight, improved thermal insulation, improved structural strength, improved nailability, improved fire and smoke performance, and enhanced energy efficiency. All aspects of the disclosed sheathing system (alone or in combination) can contribute to the overall improved performance and sustainability of a building structure.

In accordance with aspects herein disclosed, a sheathing system is provided that includes one or more structural layers and an insulation layer. The structural layer comprises a polycarbonate material and has a first surface and an opposing second surface. In an exemplary aspect, the structural layer is substantially bulk water resistant and substantially water vapor permeable. The insulation layer comprises an extruded polystyrene and has a third surface and an opposite fourth surface. The third surface of the insulation layer is secured to the second surface of the structural layer. In some further aspects, the sheathing system also comprises an additional structural layer comprising the polycarbonate material and having a fifth surface and an opposing sixth surface. Alternatively, in some further aspects, the sheathing system also comprises an additional structural layer comprising OSB and having a fifth surface and an opposing sixth surface. The fifth surface of the additional structural layer can be at least partially secured to the fourth surface of the insulation layer.

In accordance with the disclosed aspects, the sheathing system weighs less than conventional systems. For example, the inventive sheathing panels have a total weight between 10 to 45 pounds, a thickness of no greater than 1.5 inches (preferably no greater than 1 inch), and an R-value of at least 3.5 (preferably at least 4.5). Thus, the disclosed sheathing system is superior to conventional structural panel systems, which are generally heavier, thicker, and have a lower R-value.

This summary is provided to introduce and not limit the scope of the general inventive concepts, provided hereafter in further detail. The general inventive concepts encompass an improved lightweight, high-strength multi-material sheathing panel, as well as methods and systems of using the panels as a sheathing material on at least part of a building structure.

In one exemplary embodiment, a 2-layer panel for use as a sheathing material for a building is disclosed. The 2-layer panel comprises: a first structural layer; and an insulation layer, wherein the first structural layer comprises a polymeric material, wherein a thickness of the first structural layer is in the range of 1/32 inch to ⅛ inch, and wherein a thickness of the insulation layer is in the range of ½ inch to 4 inches.

In some embodiments, the thickness of the first structural layer is about 1/16 inch.

In some embodiments, the polymeric material of the first structural layer comprises at least one of polycarbonate (PC), polyester, polypropylene (PP), polymethyl methacrylate (PMMA), polyvinyl chloride (PVC), polyethylene (PE), high density polyethylene (HDPE), polyethylene terephthalate (PET), polyethylene terephthalate glycol (PETG), polyamide 6 (PA6), polyamide 66 (PA66), polystyrene (PS), acrylonitrile butadiene styrene (ABS), and copolymers and/or blends thereof.

In some embodiments, the first structural layer comprises polycarbonate.

In some embodiments, the first structural layer consists of polycarbonate.

In some embodiments, the first structural layer further comprises one or more filler materials.

In some embodiments, the insulation layer comprises at least one of extruded polystyrene, expanded polystyrene, foamed polyurethane, polyisocyanurate, fiberglass, mineral wool, polyethylene terephthalate, polyester, phenolic foam, aerogel blanket, aerogel board, and polyurethane.

In some embodiments, the insulation layer comprises extruded polystyrene.

In some embodiments, the insulation layer consists of extruded polystyrene.

In some embodiments, the insulation layer comprises mineral wool.

In some embodiments, the insulation layer consists of mineral wool.

In some embodiments, the panel has a nail withdrawal force between 20 pounds and 400 pounds.

In some embodiments, the sheathing material has a racking performance greater than 250 plf.

In some embodiments, the sheathing material has a racking performance greater than 440 plf.

In some embodiments, a thickness of the panel is less than or equal to 1.5 inches and an R-value of the panel is at least 4.5.

In some embodiments, a thickness of the panel is less than or equal to 1 inch and an R-value of the panel is at least 3.5.

In some embodiments, a thickness of the panel is less than or equal to 1 inch and an R-value of the panel is at least 4.5.

In some embodiments, a weight of the panel is in the range of 10 pounds to 45 pounds.

In some embodiments, a weight of the panel is in the range of 10 pounds to 45 pounds, a thickness of the panel is less than or equal to 1.5 inches, and an R-value of the panel is at least 4.5.

In some embodiments, the panel further comprises a second structural layer to form a 3-layer panel.

In some embodiments, the second structural layer is identical to the first structural layer.

In some embodiments, the second structural layer comprises a polymeric material, and a thickness of the second structural layer is in the range of 1/32 inch to ⅛ inch.

In some embodiments, the thickness of the second structural layer is about 1/16 inch.

In some embodiments, the polymeric material of the second structural layer comprises at least one of polycarbonate (PC), polyester, polypropylene (PP), polymethyl methacrylate (PMMA), polyvinyl chloride (PVC), polyethylene (PE), high density polyethylene (HDPE), polyethylene terephthalate (PET), polyethylene terephthalate glycol (PETG), polyamide 6 (PA6), polyamide 66 (PA66), polystyrene (PS), acrylonitrile butadiene styrene (ABS), and copolymers and/or blends thereof.

In some embodiments, the second structural layer comprises polycarbonate.

In some embodiments, the second structural layer consists of polycarbonate.

In some embodiments, the second structural layer further comprises one or more filler materials.

In some embodiments, the panel has an ultimate shear strength according to ASTM E72 of at least 250 plf.

In some embodiments, the panel has an ultimate shear strength according to ASTM E72 of at least 500 plf.

In some embodiments, the panel has an ultimate shear deflection according to ASTM E72 of less than 4 inches.

In some embodiments, the panel has a nail retention according to ASTM D1761 in the range of 30 pounds to 200 pounds.

In some embodiments, a thickness of the panel is less than or equal to 1.5 inches and an R-value of the panel is at least 4.5.

In some embodiments, a thickness of the panel is less than or equal to 1 inch and an R-value of the panel is at least 3.5.

In some embodiments, a thickness of the panel is less than or equal to 1 inch and an R-value of the panel is at least 4.5.

In some embodiments, a thickness of the panel is less than or equal to 1.5 inches, an R-value of the panel is at least 4.5, and a racking strength of the panel according to ASTM E72 is at least 600 plf.

In some embodiments, a thickness of the panel is less than or equal to 1 inch, an R-value of the panel is at least 3.5, and a racking strength of the panel according to ASTM E72 is at least 700 plf.

In some embodiments, a thickness of the panel is in the range of 0.5 inches to 2 inches; and a racking strength of the panel according to ASTM E72 is in the range of 500 plf to 900 plf.

In some embodiments, a weight of the panel is in the range of 10 pounds to 45 pounds.

In some embodiments, a weight of the panel is in the range of 10 pounds to 45 pounds, a thickness of the panel is less than or equal to 1.5 inches, and an R-value of the panel is at least 4.5.

In some embodiments, the second structural layer comprises a wood composite material, and a thickness of the second structural layer is in the range of ¼ inch to 1⅛ inches.

In some embodiments, the wood composite material comprises at least one of oriented strand board, fiberboard, and plywood.

In some embodiments, the second structural layer comprises oriented strand board.

In some embodiments, the second structural layer consists of oriented strand board.

In some embodiments, the panel has an ultimate shear strength according to ASTM E72 of at least 250 plf.

In some embodiments, the panel has an ultimate shear strength according to ASTM E72 of at least 500 plf.

In some embodiments, the panel has an ultimate shear deflection according to ASTM E72 of less than 4 inches.

In some embodiments, the panel has a nail retention according to ASTM D1761 in the range of 30 pounds to 90 pounds.

In some embodiments, a thickness of the panel is less than or equal to 1.5 inches and an R-value of the panel is at least 4.5.

In some embodiments, a thickness of the panel is less than or equal to 1.1 inches and an R-value of the panel is at least 3.5.

In some embodiments, a thickness of the panel is less than or equal to 1.1 inches and an R-value of the panel is at least 4.5.

In some embodiments, a weight of the panel is in the range of 10 pounds to 45 pounds.

In some embodiments, a weight of the panel is in the range of 10 pounds to 45 pounds, a thickness of the panel is less than or equal to 1.5 inches, and an R-value of the panel is at least 4.5.

In one exemplary embodiment, a 3-layer panel for use as a sheathing material for a building is disclosed. The 3-layer panel comprises: a first structural layer; a second structural layer; and an insulation layer, wherein the insulation layer is disposed between the first structural layer and the second structural layer, wherein at least one of the first structural layer and the second structural layer comprises a polymeric material, wherein the panel has an ultimate shear strength according to ASTM E72 of at least 500 plf, wherein the panel has an ultimate shear deflection according to ASTM E72 of less than 4 inches, and wherein the panel has a nail retention according to ASTM D1761 in the range of 30 pounds to 200 pounds.

In one exemplary embodiment, a 3-layer panel for use as a sheathing material for a building is disclosed. The 3-layer panel comprises: a first structural layer; a second structural layer; and an insulation layer, wherein the insulation layer is disposed between the first structural layer and the second structural layer, wherein one of the first structural layer and the second structural layer comprises a polymeric material, wherein one of the first structural layer and the second structural layer comprises a wood composite material, wherein the panel has an ultimate shear strength according to ASTM E72 of at least 500 plf, wherein the panel has an ultimate shear deflection according to ASTM E72 of less than 4 inches, and wherein the panel has a nail retention according to ASTM D1761 in the range of 30 pounds to 200 pounds.

In accordance with further disclosed aspects, the insulation layer can comprise a coated foam insulation product formed with a low global warming potential (“GWP”) blowing agent composition and having a 180-day R-value per inch of total thickness (“R/in”) value of at least 4.8. The coated foam insulation product includes a foam product having a first major surface, an opposing second major surface, and a plurality of minor surfaces extending there between. The foam product is formed from a foamable composition comprising a matrix composition, and a blowing agent composition comprising 15 wt. % to 60 wt. % of a fluorinated alkene and 40 wt. % to 85 wt. % of a co-blowing agent. The foam product is coated with a barrier coating composition on at least one surface between 3 g/m² and 225 g/m². The barrier coating composition includes 40 wt. % to 99.9 wt. % of a barrier polymer having a minimum degree of crystallinity of 10%, and 0.1 wt. % to 20 wt. % of at least one additive. The barrier coating composition, as applied, has a surface tension no greater than 40 mN/m.

Additional disclosed aspects are directed to a coated polymeric insulation layer comprising a polymer foam product. The polymer foam product has a foamable polymer composition comprising a polymer matrix composition and a blowing agent composition, the blowing agent composition comprising 15 wt. % to 60 wt. % of a fluorinated alkene and 40 wt. % to 85 wt. % of a co-blowing agent. The foam product is coated on at least one surface. For example, each surface is coated with a barrier coating composition in a total amount between 3 g/m² and 225 g/m². The barrier coating composition comprises a semi-crystalline polymer and at least one surfactant and, as applied, has a surface tension no greater than 10 N/m above a surface energy of the polymer foam product and a viscosity between 50 cP and 175 cP at 30% solids or less. The coated insulation layer has a 180-day R/in value of at least 4.8 and a compressive strength between 10 and 110 psi, measured in accordance with ASTM C578. In some exemplary aspects, the coated polymeric insulation layer has an R-value after 180 days of at least 5.0 per inch.

In any of the exemplary aspects, the barrier coating composition can have a viscosity no greater than 250 cP at 30% solids, such as no greater than 150 cP at 30% solids, and no greater than 115 cP at 30% solids.

The barrier polymer can comprise, for example, any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

The barrier polymer is preferably at least semi-crystalline and has a minimum degree of crystallinity of 20%.

The barrier coating composition includes at least one additive, such as a processing aid, wetting agent, rheology modifier, defoaming agent, silicone, polydimethylsiloxane, pH adjuster; UV stabilizer; and hydrophobized silica.

In any of the exemplary aspects, the additive can include a rheology modifier present in an amount between 0.1 and 15 wt. %, based on the total solids content of the barrier coating.

In any of the exemplary aspects, the additive can include at least one wetting agent present in an amount between 0.005 and 8 wt. %, based on the total solids content of the barrier coating.

The present disclosure is also directed to a method of manufacturing a coated insulation layer with reduced fluorinated blowing agent content. A matrix polymer with a blowing agent composition is mixed to form a foamable polymer composition. The foamable polymer composition is then blown to produce a foam product having a first major surface, an opposing second major surface, and a plurality of minor surfaces extending there between. A barrier coating is applied to at least one surface of the foam product in a total amount between 3 g/m² and 225 g/m². The barrier coating is formed from a barrier coating composition comprising 40 wt. % to 99.9 wt. % of a barrier polymer based on a total solids content of the barrier coating composition, and 0.1 wt. % to 20 wt. % of at least one additive. The barrier coating composition has a surface tension, as applied, no greater than 40 mN/m, and wherein the coated insulation layer has a 180-day R/in value of at least 4.8.

In general, the coated foam insulation products described herein can be used in any of the multi-material sheathing (MMS) systems described herein (e.g., as an insulation layer in an MMS panel). In one exemplary embodiment, a sheathing system to externally envelop at least a portion of a building structure is disclosed. The system comprises: at least one panel including a first structural layer having a first surface and a second surface opposite the first surface; a second structural layer having a fifth surface and a sixth surface opposite the fifth surface; an insulation layer having a third surface and a fourth surface opposite the third surface, the third surface of the insulation layer being at least partially secured to the second surface of the first structural layer and the fifth surface of the second structural layer being at least partially secured to the fourth surface of the insulation layer, the insulation layer being formed from a foamable composition comprising: a) a matrix composition, and b) a blowing agent composition comprising 15 wt. % to 60 wt. % of a fluorinated alkene and 40 wt. % to 85 wt. % of a co-blowing agent; and a barrier coating applied to at least one surface of the insulation layer in a total amount between 3 g/m² to 225 g/m², the barrier coating being formed from a barrier coating composition comprising: 40 wt. % to 99.9 wt. % of a barrier polymer, based on a total solids content of the barrier coating composition, the barrier polymer having a minimum degree of crystallinity of 10%, and 0.1 wt. % to 20 wt. % of at least one additive, wherein the barrier coating composition has a surface tension no greater than 40 mN/m, and wherein the sheathing system has a 180-day R/in value of at least 4.8.

In some embodiments, the sheathing system has a distance from the first surface of the first structural layer to the sixth surface of the second structural layer of no greater than 3.5 inches.

In some embodiments, the sheathing system has a racking performance of greater than 640 plf.

In some embodiments, the first structural layer comprises a polymer material, said polymer material comprising any one or more of polycarbonate, polyester, polypropylene, polymethyl methacrylate, poly vinyl chloride, polyethylene, high density polyethylene, and copolymers and/or blends thereof.

In some embodiments, the first structural layer comprises polycarbonate.

In some embodiments, the first structural layer consists of polycarbonate.

In some embodiments, the first structural layer further comprises one or more filler materials.

In some embodiments, the second structural layer comprises a wood composite material, and a thickness of the second structural layer is in the range of ¼ inch to 1⅛ inches.

In some embodiments, the wood composite material comprises at least one of oriented strand board, fiberboard, and plywood.

In some embodiments, the second structural layer comprises oriented strand board.

In some embodiments, the second structural layer consists of oriented strand board.

In some embodiments, the panel has a weight between 10 pounds and 45 pounds.

In some embodiments, the foamable composition includes a total blowing agent concentration between 2.5 wt. % and 7.5 wt. %.

In some embodiments, the barrier coating composition has a viscosity no greater than 250 cP at 30% solids.

In some embodiments, the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

In some embodiments, the barrier polymer has a minimum degree of crystallinity of 30%.

In some embodiments, the additive comprises one or more of a processing aid, wetting agent, rheology modifier, defoaming agent, silicone, matting agent, polydimethylsiloxane, pH adjuster; UV stabilizer; and hydrophobized silica.

In some embodiments, the additive includes a rheology modifier present in an amount between 0.1 wt. % and 15 wt. %, based on the total solids content of the barrier coating.

In some embodiments, the additive includes at least one wetting agent present in an amount between 0.005 wt. % and 8 wt. %, based on the total solids content of the barrier coating.

In some embodiments, the additive includes at least one UV stabilizer present in an amount between 0.05 wt. % and 12 wt. %, based on the total solids content of the barrier coating.

In some embodiments, the barrier coating further comprises, based on a total solids content of the barrier coating: 40 wt. % to 99 wt. % solids of a barrier polymer; 0.1 wt. % to 15 wt. % solids of a rheology modifier; 0.005 wt. % to 8 wt. % solids of a wetting agent; 0.05 wt. % to 8 wt. % solids of a pH adjuster; and 0.05 wt. % to 12 wt. % solids of at least one UV stabilizer.

In some embodiments, the barrier coating has a pH between 4 and 7.

In some embodiments, the barrier coating is present on each surface of the insulation layer.

In some embodiments, the matrix material is a matrix polymer, selected from the group consisting of alkenyl aromatic polymers, styrenic polymers, styrenic copolymers, styrenic block copolymers, polyolefins, halogenated vinyl polymers, acrylonitrile copolymers, polycarbonates, polyisocyanurates, polyesters, polyacrylates, polyurethanes, phenolics, polysulfone, polyphenylene sulfide, acetal resins, polyamides, polyaramides, polyimides, polyetherimides, rubber modified polymers, thermoplastic polymer blends, and combinations thereof.

In one exemplary embodiment, a sheathing system to externally envelop at least a portion of a building structure is disclosed. The system comprises: at least one panel including a first structural layer having a first surface and a second surface opposite the first surface; a second structural layer having a fifth surface and a sixth surface opposite the fifth surface; an insulation layer having a third surface and a fourth surface opposite the third surface, the third surface of the insulation layer being at least partially secured to the second surface of the first structural layer and the fifth surface of the second structural layer being at least partially secured to the fourth surface of the insulation layer, the insulation layer being formed from a foamable composition comprising: a) a polymer matrix composition; and b) a blowing agent composition comprising 15 wt. % to 60 wt. % of a fluorinated alkene and 40 wt. % to 85 wt. % of a co-blowing agent; and a barrier coating present on each surface of the insulation layer in a total amount between 3 g/m² and 225 g/m², the barrier coating being formed from a barrier coating composition comprising a semi-crystalline polymer and at least one wetting agent, the barrier coating composition having a surface tension no greater than 10 mN/m above a surface energy of the polymer foam and a viscosity between 50 cP and 175 cP at 30% solids or less, wherein the sheathing system has a 180-day R/in value of at least 4.8 and a compressive strength between 10 and 110 psi, measured in accordance with ASTM C578.

In some embodiments, the sheathing system has a distance from the first surface of the first structural layer to the sixth surface of the second structural layer of no greater than 1.5 inches.

In some embodiments, the sheathing system has a racking performance of greater than 640 plf.

In some embodiments, the first structural layer comprises a polymer material, said polymer material comprising any one or more of polycarbonate, polyester, polypropylene, polymethyl methacrylate, poly vinyl chloride, polyethylene, high density polyethylene, and copolymers and/or blends thereof.

In some embodiments, the first structural layer comprises polycarbonate.

In some embodiments, the first structural layer consists of polycarbonate.

In some embodiments, the first structural layer further comprises one or more filler materials.

In some embodiments, the panel has a weight between 10 pounds and 45 pounds.

In some embodiments, the foamable polymer composition includes a total blowing agent concentration between 2.5 wt. % and 7.5 wt. %.

In some embodiments, the barrier coating composition has a viscosity no greater than 150 cP at 30% solids.

In some embodiments, the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

In some embodiments, the barrier polymer has a minimum degree of crystallinity of 30%.

In some embodiments, the wetting agent is present in an amount between 0.005 wt. % and 8 wt. % solids, based on the total solids content of the barrier coating.

In some embodiments, the barrier coating composition further includes at least one additive, the additive comprising a processing aid, rheology modifier, defoaming agent, silicone, polydimethylsiloxane, pH adjuster, UV stabilizer, hydrophobized silica, or mixtures thereof.

In some embodiments, the additive includes a rheology modifier present in an amount between 0.1 wt. % and 12 wt. % solids, based on the total solids content of the barrier coating.

In some embodiments, the additive includes a UV stabilizer present in an amount between 0.05 wt. % and 12 wt. % solids, based on the total solids content of the barrier coating.

In some embodiments, the barrier coating further comprises, based on a total solids content of the barrier coating: 40 wt. % to 99 wt. % solids of a barrier polymer; 0.1 wt. % to 15 wt. % solids of a rheology modifier; 0.005 wt. % to 8 wt. % solids of a wetting agent; 0.05 wt. % to 8 wt. % solids of a pH adjuster; and 0.05 wt. % to 12 wt. % solids of at least one UV stabilizer.

In some embodiments, the barrier coating has a pH between 4 and 7.

In some embodiments, the sheathing system has an R-value after 180 days of at least 5.0 per inch.

In some embodiments, the barrier coating is present on each surface of the foam product.

Other aspects and features of the general inventive concepts will become more readily apparent to those of ordinary skill in the art upon review of the following description of various exemplary embodiments in conjunction with the accompanying figures.

### DESCRIPTION OF THE DRAWINGS

The present invention is described in detail herein with reference to the attached drawings, wherein:

FIGS. 1A-1B show a conventional 2-layer sheathing panel. FIG. 1A is a perspective view of the sheathing panel. FIG. 1B is a side elevation (cross-sectional) view of the sheathing panel.

FIGS. 2A-2B show another conventional 2-layer sheathing panel. FIG. 2A is a perspective view of the sheathing panel. FIG. 2B is a side elevation (cross-sectional) view of the sheathing panel.

FIGS. 3A-3B show a conventional 3-layer sheathing panel. FIG. 3A is a perspective view of the sheathing panel. FIG. 3B is a side elevation (cross-sectional) view of the sheathing panel.

FIGS. 4A-4E show a 2-layer sheathing panel, according to an exemplary embodiment. FIG. 4A is a perspective view of the sheathing panel. FIG. 4B is a side elevation (cross-sectional) view of the sheathing panel. FIG. 4C is a separated perspective view of the sheathing panel. FIG. 4D is a side elevation view of the panel of FIG. 4B brought in proximity to a building structure. FIG. 4E is a side elevation view of the panel of FIG. 4B installed on the building structure.

FIGS. 5A-5G show a 3-layer sheathing panel, according to an exemplary embodiment. FIG. 5A is a perspective view of the sheathing panel. FIG. 5B is a side elevation (cross-sectional) view of the sheathing panel. FIG. 5C is a separated perspective view of the sheathing panel. FIG. 5D is a side elevation view of the panel of FIG. 5B (with two structural layers of different material) brought in proximity to a building structure. FIG. 5E is a side elevation view of the panel of FIG. 5D installed on the building structure. FIG. 5F is a side elevation view of the panel of FIG. 5B (with two structural layers of the same material) brought in proximity to a building structure. FIG. 5G is a side elevation view of the panel of FIG. 5F installed on the building structure.

FIG. 6 is a plan view of a portion of a 2-layer sheathing panel, according to an exemplary embodiment.

FIG. 7 is a plan view of a portion of a 3-layer sheathing panel, according to an exemplary embodiment.

FIG. 8 is a plan view of a portion of a 3-layer sheathing panel, according to an exemplary embodiment.

FIG. 9 is a plan view of a portion of a 3-layer sheathing panel, according to an exemplary embodiment.

FIGS. 10A-10B illustrate a coupling technique for a 3-layer sheathing panel, according to an exemplary embodiment.

FIGS. 11A-11B show a 3-layer sheathing panel having a central support layer, according to an exemplary embodiment.

FIG. 12 is a graph that plots racking strength values and maximum deflection values for several sheathing panels.

FIGS. 13A-13B show two exemplary 3-layer sheathing panels, each panel having a polycarbonate layer at different locations therein.

FIG. 14 is a graph that plots racking strength values for several sheathing panels.

FIG. 15 is a schematic drawing of an exemplary extrusion apparatus useful for practicing methods according to one or more embodiments shown and described herein.

FIG. 16 is a graph showing the thermal conductivity k-value (y-axis) as a function of time (x-axis) for various barrier coating configurations according to Example 1.

FIG. 17 is a graph showing the thermal conductivity k-value (y-axis) as a function of time (x-axis) for various barrier coating configurations according to Example 1.

FIG. 18 is a graph showing the thermal conductivity k-value (y-axis) as a function of time (x-axis) for various PVDC coat weight configurations according to Example 2.

FIG. 19 is a graph showing the thermal conductivity k-value (y-axis) as a function of time (x-axis) for various samples according to Example 3.

FIG. 20 is a graph showing the thermal conductivity k-value (y-axis) as a function of time (x-axis) for various concentrations of the barrier coating composition injected into the extrusion apparatus according to Example 4.

FIG. 21 is a graph showing the thermal conductivity k-value (y-axis) as a function of time (x-axis) for various barrier coating configurations with Coating A according to Example 5.

FIG. 22 is a graph showing the thermal conductivity k-value (y-axis) as a function of time (x-axis) for various barrier coating configurations with Coating B according to Example 5.

FIG. 23 is a graph showing the thermal conductivity k-value (y-axis) as a function of time (x-axis) for various samples according to Example 6.

FIG. 24 is a graph showing the thermal conductivity k-value (y-axis) as a function of time (x-axis) for various samples according to Example 7.

### DETAILED DESCRIPTION

Unless defined otherwise, all technical and scientific terms used herein have the same meaning as commonly understood by one of ordinary skill in the art to which the embodiments belong. Although any methods and materials similar or equivalent to those described herein can be used in the practice or testing of the various embodiments, some preferred methods and materials are described herein. In the drawings, the thickness of the lines, layers, and regions can be exaggerated for clarity. It is to be noted that like numbers found throughout the figures denote like elements.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that can vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, can be used in any embodiment disclosed herein, regardless of whether the element, property, feature, or combination of elements, properties, and features was explicitly disclosed in the embodiment. It will be readily understood that features described in relation to any particular aspect described herein can be applicable to other aspects described herein provided the features are compatible with that aspect.

Every numerical range given throughout this specification and claims will include every narrower numerical range that falls within such broader numerical range, as if such narrower numerical ranges were all expressly written herein.

The term “R-value” is the unit used to measure the effectiveness of thermal insulation and is the reciprocal of thermal conductivity, which for foam board materials having substantially parallel faces, is defined as the rate of flow of thermal energy (BTU/hr. or Watt) per unit area (square foot (ft²) or square meter (m²)) per degree of temperature difference (Fahrenheit or Kelvin) across the thickness of the slab material (inches or meters). The thermal performance of a polymeric insulation product is based on the R-value of the insulation product, which is a measure of the product's resistance to heat flow. The R-value is defined by Equation (1):

$$R = T / k$$

where “T” is the thickness of the insulation product expressed in inches, “k” is the thermal conductivity of the insulation product expressed in BTU·in/h·ft²·° F., and “R” is the R-value of the insulation expressed in h·ft²·° F./BTU.

As used herein, an insulation product's thickness (T) can be determined in accordance with ASTM C167-18 and both k-value and area weight (in lb/ft²) can be determined in accordance with ASTM C518-21 or ASTM C177-19.

As used herein, the term “blowing agent” is understood to include physical (e.g., dissolved gaseous agents) or chemical blowing agents (e.g., a gas generated by decomposition). A blowing agent is generally added to a molten polymer (e.g., in an extruder) and under the proper conditions, to initiate foaming to produce a foamed product. The blowing agent expands the resin and forms cells (e.g., open or closed pores). As the resin hardens or cures, foam is produced with either the blowing agent trapped in the cells or ambient air displaces the blowing agent in the cells. The blowing agents discussed herein preferably consist of or comprise environmentally acceptable blowing agents (i.e., “low GWP” blowing agents) as would be recognized by one of ordinary skill in the art. Such low GWP blowing agents have a GWP value of no greater than 500, such as GWP values of no greater than 250, no greater than 200, no greater than 150, no greater than 125, no greater than 100, no greater than 75, no greater than 50, no greater than 25, no greater than 20, no greater than 15, no greater than 10, no greater than 8, no greater than 5, and no greater than 3.

As used herein, unless specified otherwise, the values of the constituents or components of the blowing agent or other compositions are expressed in weight percent or % by weight of each ingredient in the composition.

As it pertains to the present disclosure, “closed cell” refers to a foam having a plurality of cells, at least 95% of which are closed. However, in the present application, cells can be “open cells,” closed cells, or a mixture thereof (i.e., certain embodiments disclosed herein can exhibit an “open cell” foam structure or a blend of open cells and closed cells). The present disclosure relates in part to a foam and foam insulation layers, such as extruded or expanded polymer foams, formed from a composition that contains a foamable material, a blowing agent composition, and a barrier coating or barrier additive that stops or slows the diffusion rate of the blowing agent composition, thereby enabling the production of foam insulation products with improved insulation values and maintenance of such insulations values over time. Accordingly, such foam insulation layers can provide sheathing systems with improved insulation values and maintenance of such insulations values over time.

The following describes select aspects relating to a sheathing system for use in constructing a building structure (e.g., a residential home, a commercial building, an industrial building). The disclosed sheathing system can comprise panels capable of being attached to a frame of a building structure, thereby forming a sheath that envelops at least a portion of the building structure. The sheath formed by the disclosed sheathing system can correspond to a wall portion (e.g., vertical surface) or a roofing portion of the building structure, by way of example.

The multi-material sheathing system disclosed herein provides for various improvements over conventional sheathing systems. The unique collection of individual layers (also referenced herein as “components”) utilized in the production of the disclosed sheathing system provide for a stronger, thinner, and lighter sheathing panel having a higher R-value per inch of total thickness, which offers several advantages over conventional sheathing systems.

The materials used in the novel sheathing system herein provide a thinner structural layer that maintains or exceeds the structural performance of conventional systems. As one of ordinary skill in the art can appreciate, thinner materials generally take up less space within the building envelope, allowing for more efficient utilization of interior space. This can be especially crucial in applications where maximizing usable area is essential, such as in residential homes or commercial buildings. Thinner materials are also generally lighter in weight, which can simplify handling, transportation, and installation. Additionally, the utilization of alternative materials for sheathing systems, as will be described, greatly reduces weight. Reduced weight can also have positive implications for the structural load on the building's foundation and framing. Thin materials provide architects and builders with greater flexibility in designing and implementing various architectural elements, such as curves, angles, and intricate details. This can also lead to faster construction times due to easier handling and installation. The thin materials can subsequently result in reduced labor costs and faster project completion.

The materials utilized and described herein provide an insulated sheathing system with a high R-value. The higher the R-value, the more effective insulative characteristics are attributed to the sheathing system. More specifically, a sheathing system with a high R-value generally indicates that the sheathing system is effective at reducing heat flow through walls, roofs, and floors. This translates to lower energy consumption for heating and cooling, lower utility bills and a smaller carbon footprint. High R-value sheathing systems also help maintain more consistent indoor temperatures by reducing drafts, cold spots, and heat loss, further providing occupants with a more comfortable living or working environment year-round. As is generally known in the building industry, minimum insulation R-values on external sheathing of a building structure may be required by code. In this regard, conventional sheathing systems may require a builder add insulation after a sheathing panel is affixed to the building structure in order to obtain the adequate R-value, further complicating the construction process and leading to additional resource expenditures.

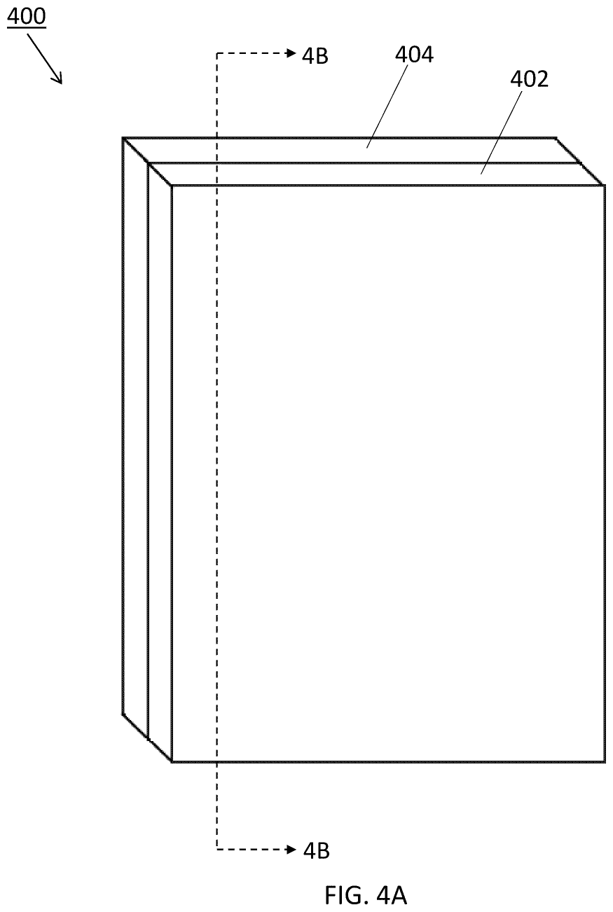

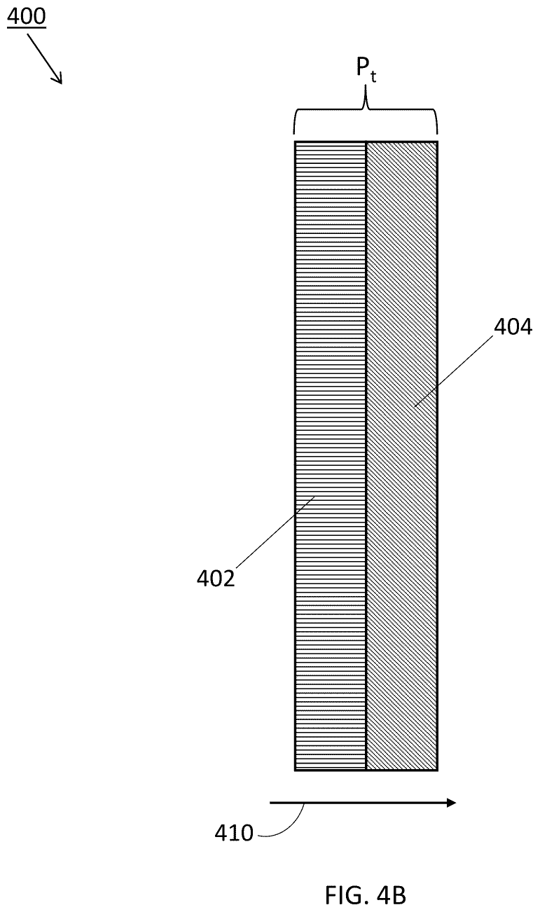

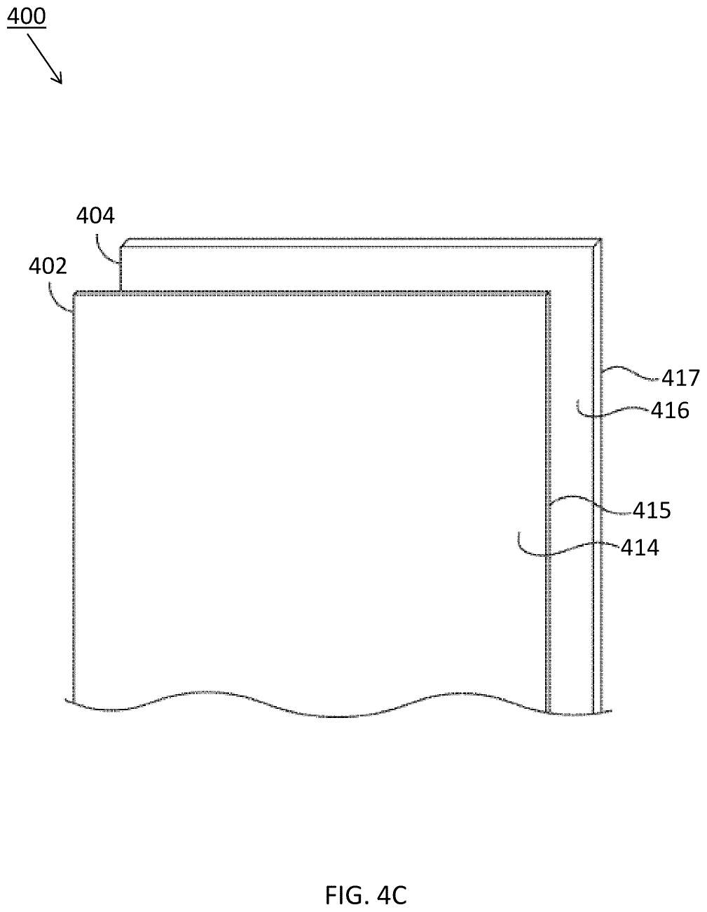

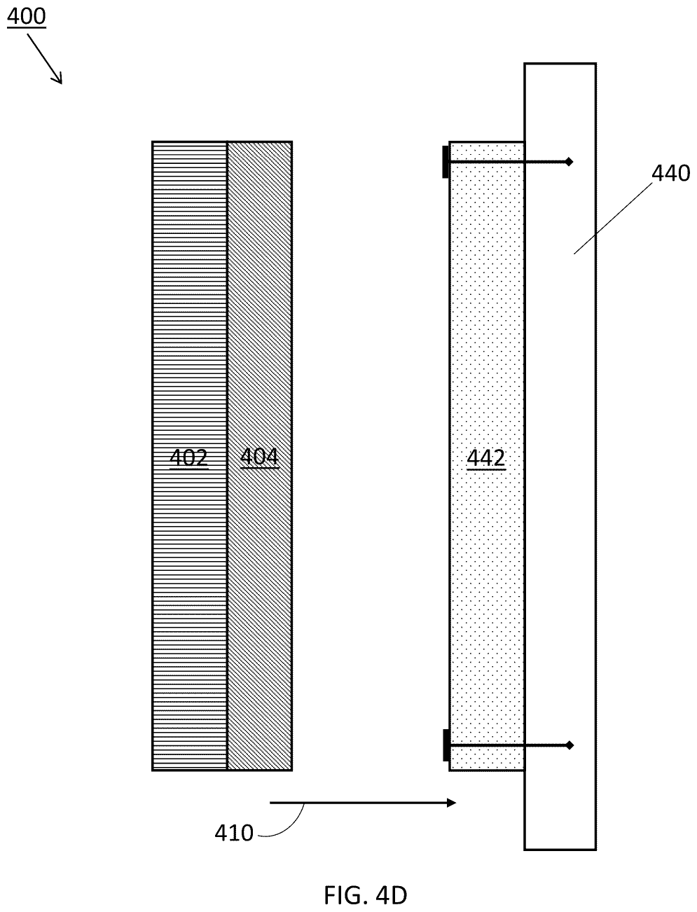

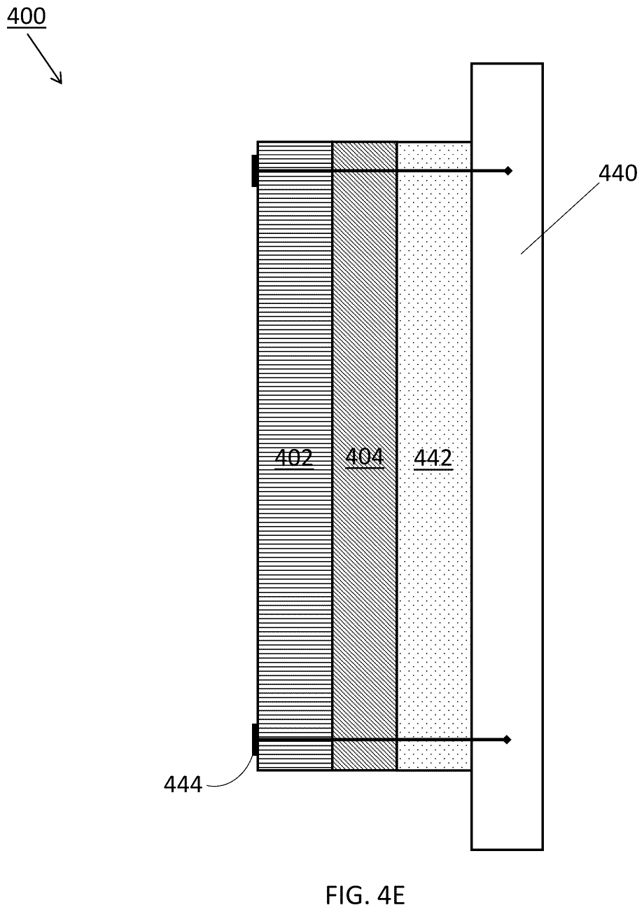

Turning to FIGS. 4A-4E, a sheathing system for externally enveloping at least a portion of a building structure, according to an exemplary embodiment, is disclosed. The sheathing system includes a panel 400 that comprises two distinct layers and is formed by coupling a structural layer 402 and an insulation layer 404 (i.e., a “2-layer system”). The arrow 410 in FIG. 4B shows the panel 400 oriented in an installation direction (i.e., facing a frame of a building structure, such as a wall or roof).

As shown in FIG. 4C, the structural layer 402 comprises a first surface 414 and a second surface 415 opposite the first surface 414. The structural layer 402 can have a thickness measured as a distance from the first surface 414 to the second surface 415 opposite the first surface 414. The insulation layer 404 comprises a third surface 416 and a fourth surface 417 opposite the third surface 416. A thickness of the insulation layer 404 can be measured as a distance from the third surface 416 to the fourth surface 417.

The panel 400 is formed by coupling the second surface 415 of the structural layer 402 to the third surface 416 of the insulation layer 404, wherein the panel 400 has an overall thickness of a distance measured from the first surface 414 to the fourth surface 417. More specifically, the structural layer 402 can be coupled to the insulation layer 404 by bonding, adhering, applying, or mechanically fastening one layer to the other. By way of example, the panel 400 can be formed by applying a glue layer to the second surface 415 of the structural layer 402 or the third surface 416 of the insulation layer 404 and adhering one surface to the other. In some embodiments, the glue layer can have a weight range from about 4.885 gm/cm2 (1 lbs./MSF) to about 244.5 gm/cm2 (50 lbs./MSF). The glue layer can comprise any variety of adhesive, such as a pressure sensitive adhesive (PSA), a resin (e.g., phenol-formaldehyde, polyvinyl acetate), hot-melt, isocyanate-based adhesive, tar, or other adhesives, by way of non-limiting examples. As another example, the panel 400 can be formed without use of any glue. In this case, the second surface 415 of the structural layer 402 and the third surface 416 of the insulation layer 404 are joined together with no layer of glue therebetween.

Continuing with FIGS. 4D-4E, one arrangement for coupling the panel 400 of the sheathing system to a building frame structure 440 is illustrated. In particular, the 2-layer system is intended to be installed on the building frame structure 440 that already includes a sheathing material 442 (e.g., OSB) installed thereon. Alternatively, the 2-layer system could be installed on the building frame structure 440 at the same time that the sheathing material 442 is installed on the building frame structure 440. In other words, the panel 400 could be aligned with a sheet of OSB so that the layers 402, 404, and 442 are installed simultaneously.

The configuration shown in FIGS. 4D-4E contemplates that the panel 400 has the insulation layer 404 adjacent the building frame structure 440 (i.e., adjacent the OSB material 442). In some embodiments, the panel 400 has the structural layer 402 adjacent the building frame structure 440, which merely involves flipping the panel over prior to installing it to the frame structure 440. The panel 400 can be installed on or otherwise secured to the building frame structure 440 by use of a suitable number of fasteners 444. The fastener 444 can comprise any variety of fastener, such as a nail, screw, bolt, adhesive, anchor, rail molding, cleat, magnet, pegboard, suction, hook and loop, or any other suitable fastener generally known in the art. Typically, the fasteners 444 extend through the structural layer 402, the insulation layer 404, the OSB layer 442, and into the frame structure 440 (e.g., wall studs), as shown in FIG. 4E. Of course, this would not be the case for non-penetrating fasteners, such as an adhesive. In some embodiments, one type of fastener (or fastening means) joins the layers 402, 404 together to form the unitary panel 400, while another type of fastener (or fastening means) joins the panel to the sheathing material 442 and/or the building frame structure 440.

The fastener 444 can be used to secure the panel 400 to the sheathing material 442 attached to the building frame structure 440. It is preferable that the panel 400 provides resistance such that the fastener 444 is prevented from being withdrawn from the panel 400. Indeed, the nail retention of the sheathing material 442 (e.g., OSB) installed on the building frame structure 440 is enhanced by installation of the panel 400 thereon.

The sheathing system comprises a unique layered panel system with specific materials chosen for each layer. The materials chosen for each layer leads to the sheathing system meeting or exceeding current industry standard sheathing systems with respect to nail withdrawal force. The 2-layer system is comprised of a non-lignocellulosic structural layer 402 and an insulation layer 404 comprising extruded polystyrene (XPS). For example, in an exemplary embodiment, the structural layer 402 of the panel 400 is comprised of polycarbonate material. The structural layer 402 has a thickness in the range of 1/32 inch (about 0.0313 inches) to 1/16 inch (about 0.0625 inches). The 2-layer system shown in FIG. 4A has a thickness in the range of 17/32 inch (about 0.5313 inches) to 2 1/16 inches (about 2.0625 inches) and a nail withdrawal force in the range of 30-90 lbs. measured in accordance with ASTM D1761 (see also ASTM D1037) standards. In comparison, an industry standard wall sheathing comprised of oriented strand board (OSB) at a thickness of 7/16 inch (about 0.4375 inches) has a nail withdrawal force of less than 60 lbs. or 137 lbs. per inch.

Typically, many of the panels 400 are installed around an exterior framing of a structure to form the building's sheathing or a substantial portion thereof. Any joint formed between adjacent panels can be effectively “closed” by use of sealant, tape, or the like.

Continuing with FIGS. 4A-4B, different thicknesses of the panel 400 are described and can vary based on its intended use. In implementations where better insulating properties are desirable, the overall thickness of the panel 400 can be greater. For example, the panel 400 can have an R-value of 10 when the overall thickness of the panel 400 is 2 inches. In implementations where lower insulative properties are acceptable, the panel 400 can have an overall thickness of 1 inch or less while still preserving an R-value of at least 3.5. In implementations where higher insulative properties are required, the panel 400 can have an overall thickness of 4 inches or more to obtain an R-value much higher than 3.5. One skilled in the art will appreciate that many other thicknesses can be used (e.g., the panel 400 can have an R-value of 7 when the overall thickness is 1.5 inches), though the overall thickness of the panel 400 is preferably in the range of 0.5 inch to 2 inches. It is contemplated that values beyond that range for the overall thickness can be used depending on the particular needs of a project. As with conventional sheathing solutions, the R-value of the panel 400 increases with its overall thickness. Accordingly, the panel 400 can be designed to have an R-value ranging at least from 3.5 to 10. In various embodiments, the total R-value of the sheathing system can vary depending on the proportion of the insulation layer 404 to the structural layer 402 in the panel 400.

As noted above, the proportion of the thickness of structural layer 402 to the thickness of insulation layer 404 can vary based on the particular needs of a project. For example, when greater structural strength is desired in areas prone to high winds or seismic forces, one may want to increase the relative structural thickness. Alternatively, when greater insulation is desired and strength can be sacrificed, such as in less temperate climates, one may want to increase the relative thickness of the insulation layer. In a preferred arrangement, the ratio of insulation layer 404 thickness to structural layer 402 thickness is about 3:1. As an example, a sheathing system employing panels 400 with a 3:1 ratio and an overall thickness of 1 inch would have a ¼ inch thick structural layer 402 and a ¾ inch thick insulation layer 404. In other exemplary embodiments, the ratio of insulation layer 404 thickness to structural layer 402 thickness can be 6:1, 5:1, 4:1, 2:1, 1.5:1, or 1:1, by way of non-limiting examples. Additional ratios not disclosed herein are considered within the purview of the present disclosure.

The structural layer 402 can have a variety of thicknesses based on structural needs of the building. By way of example, the structural layer 402 can have a thickness of ⅛ inch. Additionally, the structural layer can have a thickness in the range of 1/64 inch to 1 inch. To accommodate the differing insulation needs described above, the insulation layer 404 can have a thickness in the range of ¼ inch to 1½ inches. As such, the combined thickness of the structural layer 402 and the insulation layer 404 can be in the range of ½ inch to 2 inches. In an exemplary configuration, the thickness of the structural layer 402 and the insulation layer 404 is equal to or less than 1 inch, having an R-value of 3.5 or greater. In another exemplary configuration, the thickness of the structural layer 402 and the insulation layer 404 is equal to or less than 1 inch, having an R-value of 5 or greater. Furthermore, alternative embodiments have an R-value-to-thickness ratio of at least 5, such as resulting from a 2-inch system with an R-value of 10.

While the purpose of the insulation layer 404 is to provide enhanced thermal resistance, the structural layer 402 provides rigidity and structural support to the envelope of the building structure. Accordingly, the structural layer 402 can be comprised of any one or more materials that resist kinetic forces, such as polycarbonate or certain composites. Additional materials that can provide the rigidity and structural support that the structural layer 402 requires can be one or more of materials such as polypropylene, high density polyethylene (HDPE), or a wood composite. However, as described herein, wood composites alone may be undesirable due to properties such as weight, moisture absorption, etc. Consequently, a structural layer formed of a water-resistant material such as polycarbonate can obviate the need for a separate moisture barrier, wrap, or the like.

Structural layer 402 can comprise a polymer, polycarbonate (PC), stainless steel, glass, polyester, polypropylene (PP), polyethylene (PE), acrylic, acrylonitrile styrene acrylate (ASA), cyclic olefin copolymer (COC), polycyclohexylenedimethylene terephtalate (PCT), polyether ketone, polyaryletherketones, polyetherimide, polyethersulfone, polymethyl methacrylate (PMMA), polyvinyl chloride (PVC), polyphthalmide, polyphenylene oxide (PPO), polyphenylene sulfide (PPS), recycled high-density polyethylene (HDPE), any recycled plastic or polymer, polysulfone, or syndiotactic polystyrene. The polymer can comprise one or more of polyvinyl styrene, plexiglass, high-density polypropylene (HDPP), hard plastic, soft plastic, polyethylene terephthalate (PET), polyethylene terephthalate glycol (PETG), polyamide 6 (PA6), polyadmide 66 (PA66), polystyrene (PS), acrylonitrile butadiene styrene (ABS), polyurethane, thermoplastic, thermosets, elastomer, hemp, shellac, amber, wool, silk, natural rubber, cellulose, silicone, polybutylene terephthalate (PBT), styrene-butadiene rubber, or other polymers or co-polymers, such as PC/ABS, PC/PBT, PC/PET, PVC-acrylic, and fiber/filler reinforced polymer or copolymers thereof. In a further example, recycled materials, including recycled polycarbonate, can be used for the structural layer 402. Additionally, other recycled materials can also be considered for the structural layer 402, such as recycled plastics or composite materials made from reclaimed wood fibers and plastic.

In other aspects, the structural layer 402 can comprise a polymer composite formed from a polymer and at least one filler material. The addition of a filler material can add desired physical properties to the structural layer 402, such as texture, color, strength, reduced weight, or other physical properties. The polymer composite can comprise a filler material that is added to the polymer in a ratio of between 1% and 90% by weight filler material to polymer. In further aspects, the filler material can comprise any amount of a powder, talc, calcium carbonate, calcium carbonate pellets, cellulose, sand, silica, magnesium oxide, aluminum oxide, clay, inorganic powder, a colorant, ground tire rubber, rubber, calcium sulfate, calcium silicate, barium sulfate, mica, kaolin, silicone dioxide, diatomaceous earth, minerals, fibrous glass, carbon fibers, glass, polymer beads, magnesium hydroxide, fly ash, polymer foam beads, masonry filler, wollastonite, short glass fibers, long glass fibers, glass beads, coal, dolomite, carbon black, silica, magnetite, hematite, halloysite, zinc oxide, titanium dioxide, Al(OH)₃, Mg(OH)₂, concrete filler, gravel, stone, sand, steel, aluminum, or any other material that can be added to the polymer of the structural layer 402. In alternative embodiments, organic filler, rice hulls, nut flour, wood flour, vegetable fibers, cotton fiber, starch, synthetic organic filler, rubber particles, chalk, quartz, granite, alumino-silicates, vermiculite, nepheline-senite, barium ferrite, barium titanate, molybdenum disulphide, potassium titanate, metal oxides, metal hydrates, metal powder, zinc, beryllium oxide, blowing agent, PBT, ceramics, or other materials that can be added to the polymer, can be used as the filler material. In another embodiment, glass fibers, carbon fibers, mineral fillers (e.g., calcium carbonate, talc, or mica), aramid fibers, glass beads, nanoclays, metal particles, natural fibers (e.g., hemp, jute, or flax), graphene, rubber particles, ceramic fillers (e.g., alumina or silica), recycled materials (e.g., plastic or rubber materials), wood fibers/flour, conductive fillers (e.g., carbon black or metal powders), flame retardant fillers (e.g., phosphorus-based compounds or halogenated additives) can be contemplated for use as the filler material.

In some embodiments, the filler material can have a size of up to 1 mm. The polymer composite can have filler material comprised of substances with sizes ranging from 1 micron to 1,000 microns, 1 micron to 1 centimeter, or 10 mesh to 100 mesh, by way of non-limiting examples. In an embodiment, the filler material can be added to the polymer in a ratio of 1% by weight up to 90% by weight of the polymer. In another embodiment, a ratio of between 30% by weight and 60% by weight of the polymer can be used for the filler material.

The panel 400 of the sheathing system can be milled or shaped into any desirable shape or size. Generally formed as a planar sheet in any one or more standard sizes (e.g., 1.319 m×2.438 m (4 ft×8 ft), 1.319 m×3.048 m (4 ft×10 ft), or 1.319 m×3.658 m (4 ft×12 ft)), the panel 400 can be shaped or cut according to specific dimensions and/or design requirements (e.g., different geometric shapes). Using cutting or shaping tools available on a worksite (e.g., a circular saw) or precision tooling (e.g., a Computer Numerical Control (CNC) machine), each layer of the sheathing system 400 can be cut or milled accordingly.

The structural layer 402 can be resistant to bulk water but permeable to water vapor. The structural layer 402 can be characterized by water vapor permeance in the range of about 0.1 U.S. perms to about 1.0 U.S. perms, and have a water vapor transmission rate from about 0.07 to about 7 g/m²/24 hr. (at 73° F.-50% RH via ASTM E96 procedure A). Additional embodiments of the structural layer 402 have a water vapor permeance from about 0.1 to about 12 U.S. perms (at 73° F. . . . 50% RH via ASTM E96 procedure B), and a liquid water transmission rate from about 1 to about 28 grams/100 in²/24 hr., via Cobb ring per ASTM D5795.

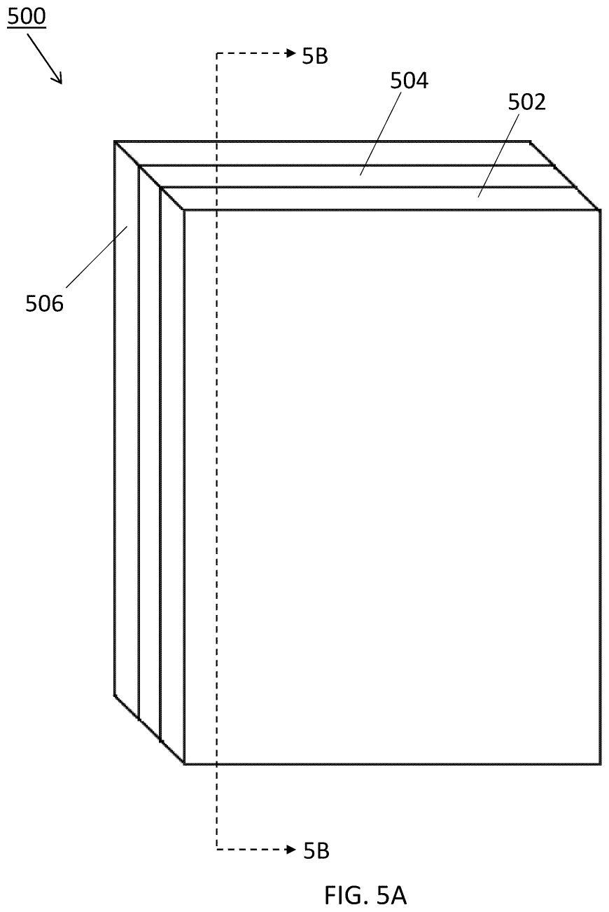

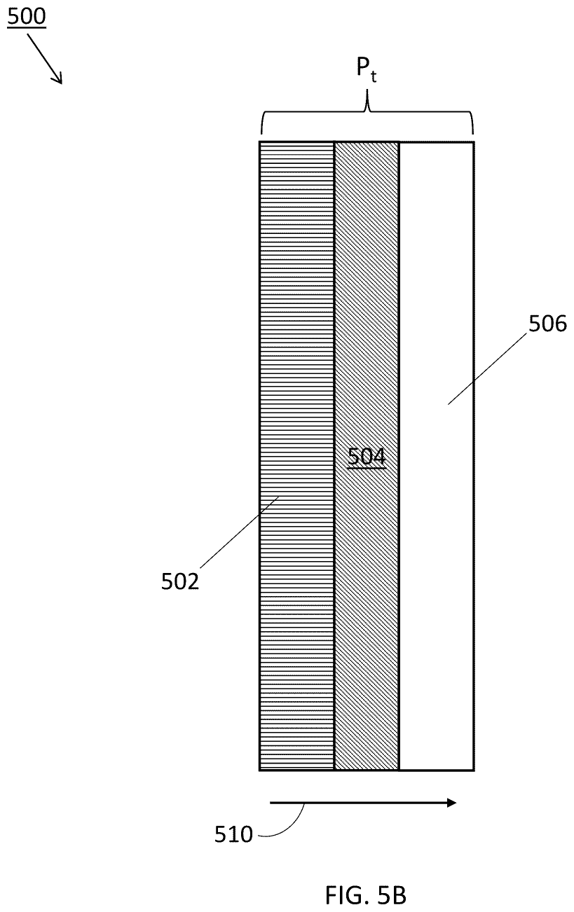

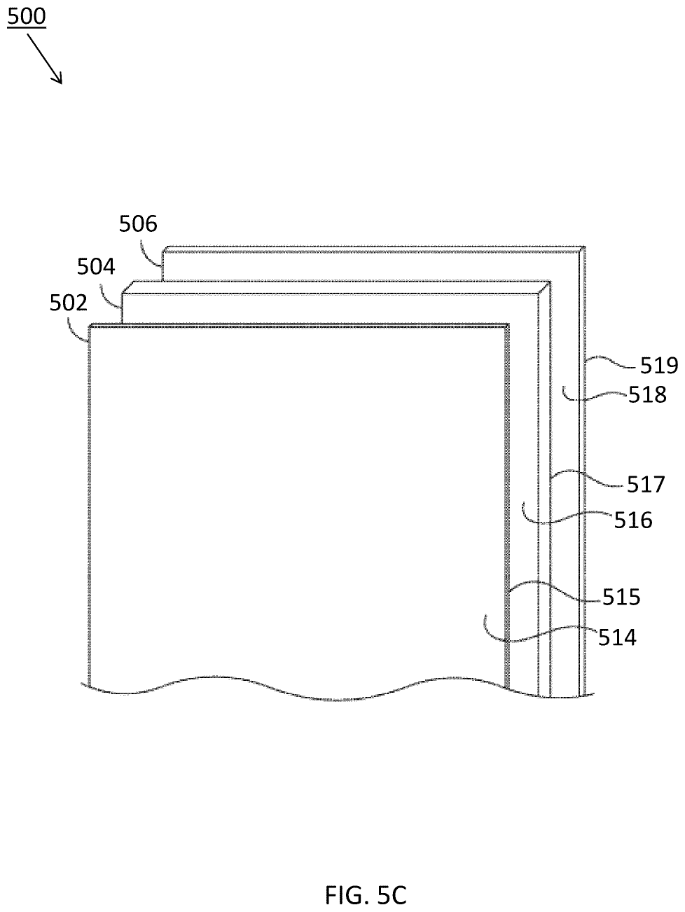

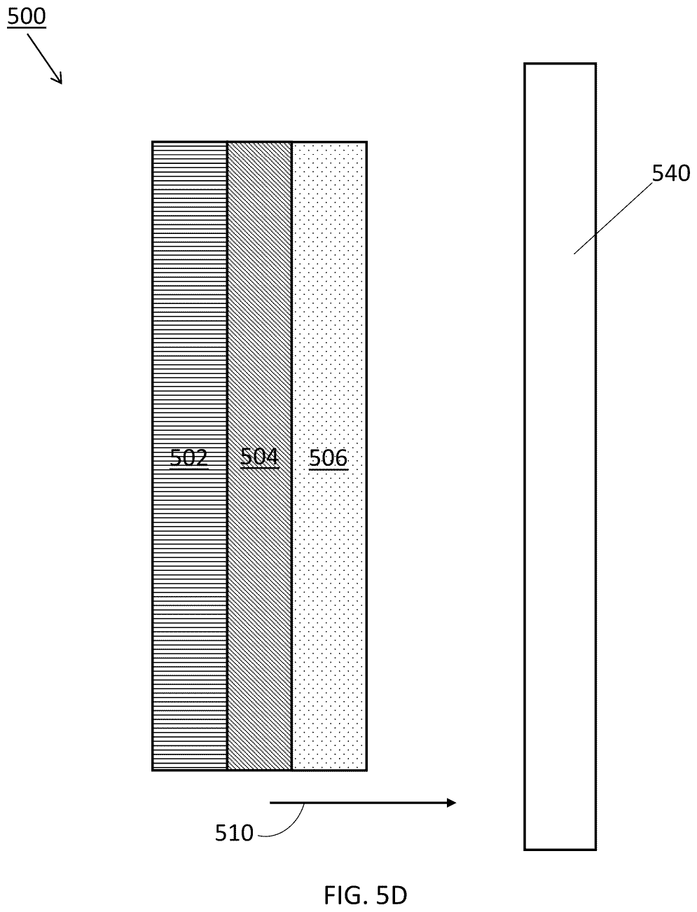

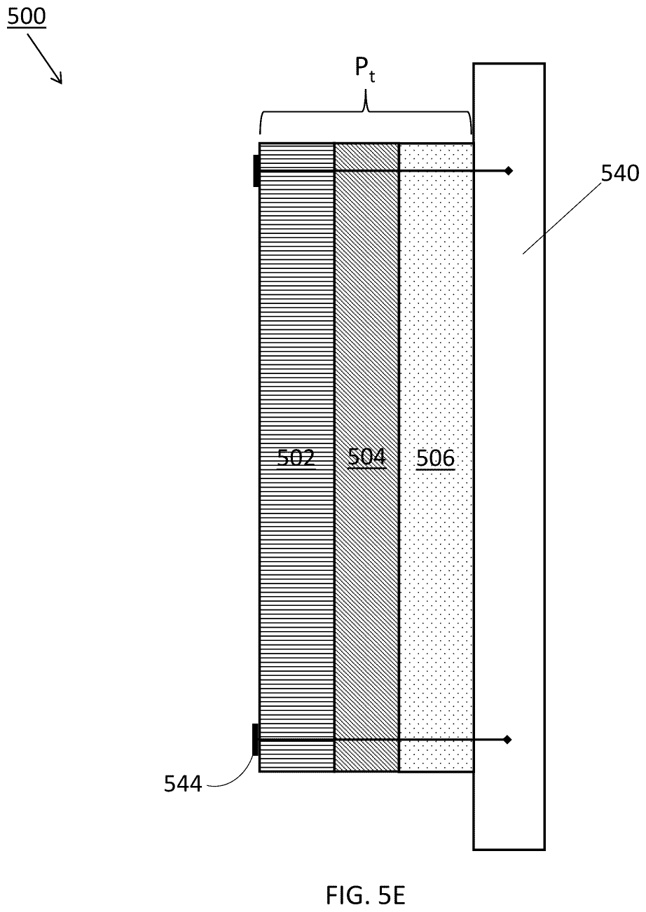

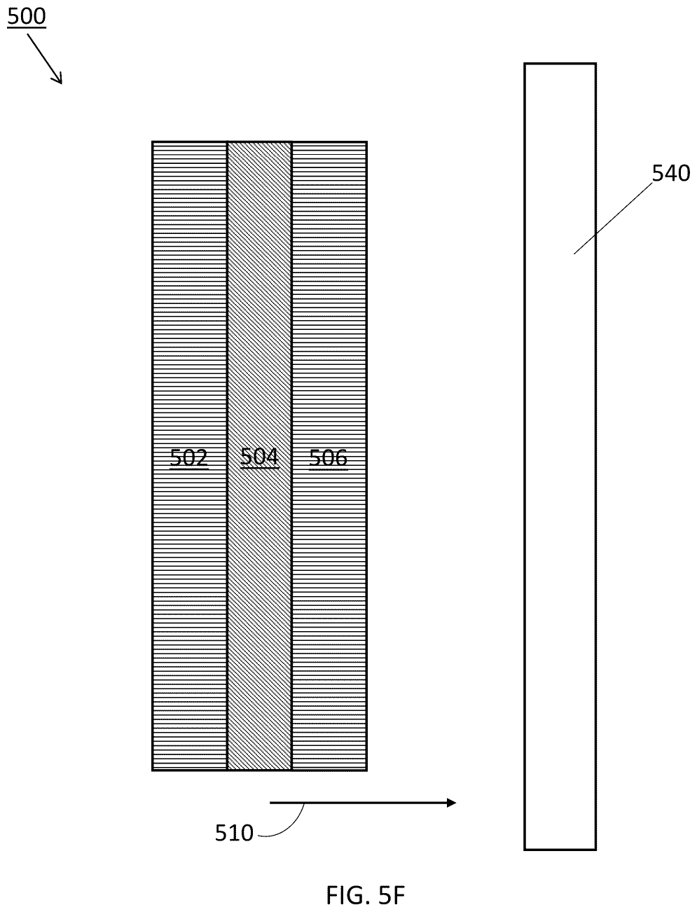

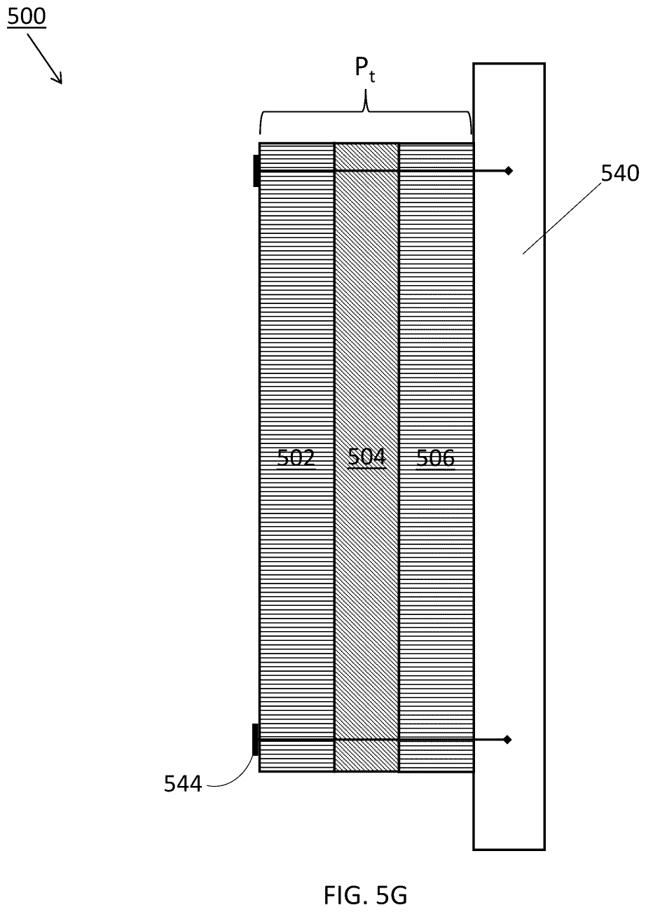

Turning now to FIGS. 5A-5G, a sheathing system for externally enveloping at least a portion of a building structure, according to another exemplary embodiment, is disclosed. The sheathing system is a panel 500 that comprises at least three distinct layers. At a high level, the panel 500 comprises the panel 400 of FIGS. 4A-4E with the addition of a second structural layer 506. Thus, the panel 500 comprises a first structural layer 502, an insulation layer 504, and a second structural layer 506 (i.e., a “3-layer sheathing system”). Accordingly, the panel 500 and each of the first structural layer 502 and the insulation layer 504 can have any one or more characteristics of the panel 400, the structural layer 402, and the insulation layer 404, respectively, as described in relation to FIGS. 4A-4E. Additionally, the second structural layer 506 can have any one or more characteristics of the structural layer 402, as described in relation to FIGS. 4A-4E (see FIGS. 5F-5G). Alternatively, the second structural layer 506 can have any one or more characteristics of the sheathing material layer 442, as described in relation to FIGS. 4A-4E (see FIGS. 5D-5E). The arrow 510 in FIG. 5B shows the panel 500 oriented in an installation direction (i.e., facing a frame of a building structure, such as a wall or roof).

The inclusion of both a first structural layer 502 and a second structural layer 506 can be advantageous as it provides weather resistance to both sides of the insulation layer 504. Additionally, the first structural layer 502 and the second structural layer 506 can provide improved racking resistance over a single structural layer. Other design and structural requirements for a particular intended use can make it advantageous to have a second structural layer rather than a single structural layer.

As shown in FIG. 5C, the first structural layer 502 comprises a second surface 515 and a first surface 514 opposite the second surface 515. A thickness of the first structural layer 502 can be measured as a distance from the first surface 514 to the second surface 515. The insulation layer 504 comprises a fourth surface 517 and a third surface 516 opposite the fourth surface 517. A thickness of the insulation layer 504 can be measured as a distance from the third surface 516 to the fourth surface 517. The second structural layer 506 comprises a sixth surface 519 and a fifth surface 518 opposite the sixth surface 519. A thickness of the second structural layer 506 can be measured as a distance from the fifth surface 518 to the sixth surface 519.

The panel 500 is formed by coupling the second surface 515 of the first structural layer 502 to the third surface 516 of the insulation layer 504. Additionally, the fourth surface 517 of the insulation layer 504 is coupled to the fifth surface 518 of the second structural layer 506. More specifically, the first structural layer 502 can be coupled to the insulation layer 504 by bonding, adhering, applying, or mechanically fastening one layer to the other. Additionally, the second structural layer 506 can be coupled to the insulation layer 504 by bonding, adhering, applying, or mechanically fastening one of the layers to the other. By way of example, the panel 500 can be formed by applying a glue layer or adhesive to the second surface 515 of the first structural layer 502 or the third surface 516 of the insulation layer 504 and adhering one surface to the other. By way of further example, the panel 500 can be formed by applying a glue layer or adhesive to the fourth surface 517 of the insulation layer 504 or the fifth surface 518 of the second structural layer 506 and adhering one surface to the other.

Continuing with FIGS. 5D-5G, one arrangement for coupling the panel 500 of the sheathing system to a building frame structure 540 is illustrated. In particular, the 3-layer system is intended to be installed directly on the building frame structure 540 (e.g., studs).

The configuration shown in FIGS. 5D-5G contemplates that the panel 500 has the second structural layer 506 adjacent the building frame structure 540 (i.e., to be placed in direct contact with the frame 540). In some embodiments, the panel 500 has the first structural layer 502 adjacent the building frame structure 540, which merely involves flipping the panel over prior to installing it to the frame structure 540. The panel 500 can be installed on or otherwise secured to the building frame structure 540 by use of a suitable number of fasteners 544. The fastener 544 can comprise any variety of fastener, such as a nail, screw, bolt, adhesive, anchor, rail molding, cleat, magnet, pegboard, suction, hook and loop, or any other suitable fastener generally known in the art. In general, the fasteners 544 extend through the first structural layer 502, the insulation layer 504, the second structural layer 506, and into the frame structure 540 (e.g., wall studs), as shown in FIGS. 5E and 5G. As described herein, it is preferable that the panel 500 provides resistance to withdrawal of the fastener 544 from the panel 500.

In one embodiment, the distance from an exterior-facing or outer surface of the first structural layer 502 to an inner-facing or inner surface of the second structural layer 506 that is adjacent the frame structure 540 (i.e., the thickness Pₜ of panel 500) is 1 inch or less, with the panel 500 having an R-value of 5 or greater. In another embodiment, the thickness Pₜ of the panel 500 is 1.5 inches or less, with the panel 500 having an R-value of 7.5 or greater. In yet another embodiment, the thickness Pₜ of the panel 500 is no greater than 2 inches.

As discussed in regard to other aspects described herein, the ratio of thickness of the first structural layer 502 and the second structural layer 506 relative to the thickness of insulation layer 504 can vary based on an intended use of the disclosed sheathing system. For example, when greater structural strength is desired, such as in areas prone to high winds or seismic forces, the combined thickness of the first structural layer 502 and the second structural layer 506 can increase as a proportion of the overall thickness of the panel 500, or the thickness as measured from the first surface 514 to the sixth surface 519. In a further example, when greater insulation is desired and strength can be sacrificed, such as in less temperate climates, the insulation layer 504 can be a greater proportion of the overall thickness. In a preferred arrangement, the ratio of insulation layer 504 thickness relative to the combined thickness of the first structural layer 502 and the second structural layer 506 can be about 3:1. In an embodiment, the panel 500 can have a ratio of insulation layer 504 thickness relative to a combined thickness of the first structural layer 502 and the second structural layer 506 of about 3:1 and an overall thickness of 1 inch. This embodiment would have a combined thickness of the first structural layer 502 and the second structural layer 506 of ¼ inch and a thickness of the insulation layer 504 of ¾ inch. In some other embodiments, the ratio of insulation layer 504 thickness relative to a combined thickness of the first structural layer 502 and the second structural layer 506 can be 6:1, 5:1, 4:1, 2:1, 1.5:1, or 1:1, by way of non-limiting examples. Additional ratios can be contemplated.

The purpose of the first structural layer 502 and the second structural layer 506 is to provide rigidity and structural support to the envelope of a building structure. Additionally, the material used for the first structural layer 502 and the second structural layer 506 can provide for other physical properties based on the intended use. For example, according to one or more design constraints, the panel 500 can be spaced to have a particular external texture, weight, or other physical property. For example, in one embodiment, the sheathing system employing the panel 500 can require superior racking resistance due to high seismic activity. Additionally, the panel 500 can require a particular texture, nail withdrawal force, or other physical properties to aid in the building envelope. Accordingly, the first structural layer 502 and the second structural layer 506 can be comprised of any one or more materials that resist racking forces, are lightweight, have one or more textures, resist nail withdrawal, or provide other desired physical properties. In one embodiment, both the first structural layer 502 and the second structural layer 506 can comprise the same material, as illustrated in FIGS. 5F-5G. In an alternative embodiment, if different physical properties are desired for the first structural layer 502 and the second structural layer 506, they can each be formed from different materials, as illustrated in FIGS. 5D-5E.

In the exemplary embodiment shown in FIGS. 5D-5E, the first structural layer 502 is formed of polycarbonate and the second structural layer 506 is a layer of OSB or similar wood composite material. In the exemplary embodiment shown in FIGS. 5F-5G, the first structural layer 502 and the second structural layer 506 are both formed of polycarbonate.

As described above, the first structural layer 502 and the second structural layer 506 can have differing physical requirements and thus can have differing thicknesses. In one example, the first structural layer 502 can be exposed to external impact forces and can require a thicker material to resist such an impact. Alternatively, the second structural layer 506 may not require such impact resistance and can thus be thinner than the first structural layer 502. As such, the first structural layer 502 can have a thickness in the range of 1/64 inch to 1 inch. The second structural layer 506 can have a thickness in the range of 1/64 inch to 1 inch. The insulation layer 504 can have a thickness in the range of ¼ inch to 1½ inches. The combined thickness of the first structural layer 502, the insulation layer 504, and the second structural layer 506 can be in the range of about ½ inch to about 2½ inches. In an exemplary configuration, the thickness of the first structural layer 502, the insulation layer 504, and the second structural layer 506 is equal to or less than 1 inch, having an R-value of 5 or greater. Furthermore, alternative embodiments have an R-value-to-thickness ratio of at least 5, such as resulting from a 2-inch system with an R-value of 10.

The exemplary embodiments of the 2-layer sheathing systems and the 3-layer sheathing systems described herein are generally summarized in Table 1.

TABLE 1

| # | First Layer (FL) | FL Thickness | Second Layer (SL) | SL Thickness | Third Layer (TL) | TL Thickness |
|---|---|---|---|---|---|---|
| 1 | Polycarbonate | 1/32 in.-⅛ in. | XPS Foam | ½ in.-2 in. | None | None |
| 2 | Polycarbonate | 1/32 in.-⅛ in. | XPS Foam | ½ in.-2 in. | OSB | ¼ in.-1⅛ in. |
| 3 | Polycarbonate | 1/32 in.-⅛ in. | XPS Foam | ½ in.-2 in. | Polycarbonate | 1/32 in.-⅛ in. |

The ASTM E72 ultimate shear strength (plf) values for these exemplary embodiments are summarized in Table 2.

TABLE 2

| # | Ultimate Shear Strength (pounds per linear foot) |
|---|---|
| 1 | N/A |
| 2 | >500 |
| 3 | 500-1,000 |

The ASTM E72 ultimate shear deflection (in) values for these exemplary embodiments are summarized in Table 3.

TABLE 3

| # | Ultimate Shear Deflection (inches) |
|---|---|
| 1 | N/A |
| 2 | <4 |
| 3 | <4 |

The ASTM D1761 nail retention (lbf) values for these exemplary embodiments are summarized in Table 4.

TABLE 4

| # | Nail Retention (pound of force) |
|---|---|
| 1 | 30-200 |
| 2 | 30-200 |
| 3 | 30-400 |

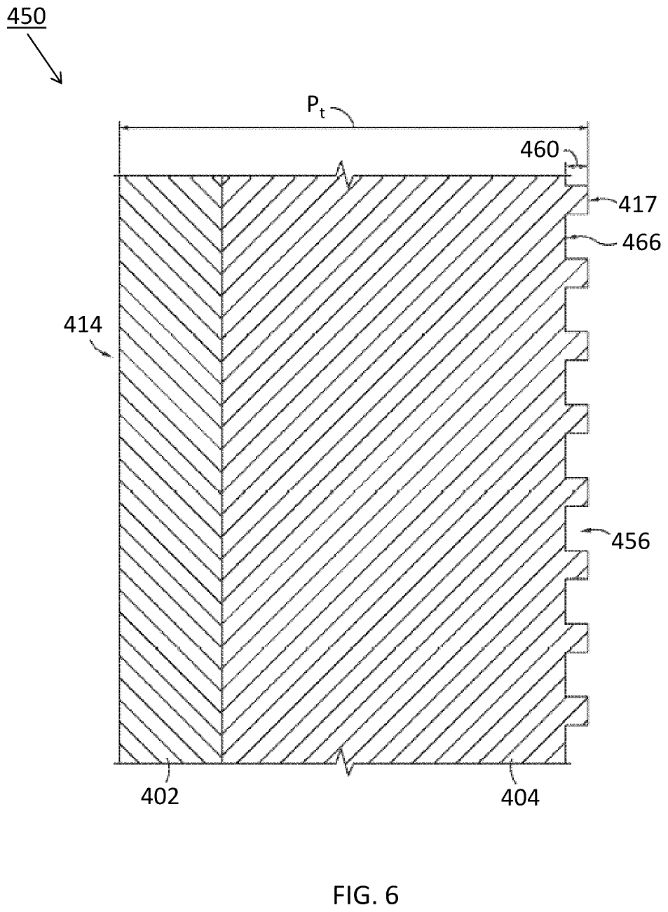

An alternative embodiment of the panel 400 (of the 2-layer system shown in FIGS. 4A-4E) is illustrated in FIG. 6. As shown in the top-down view of FIG. 6, the modified panel 450 includes a plurality of drainage channels or grooves formed in the insulation layer 404 to prevent moisture buildup. The plurality of drainage grooves 456 can be recessed within (or extend from) the insulation layer 404. The offset or recess distance formed by the drainage grooves 456 is depicted by a distance 460 that extends from a recess surface 466 to the outer surface 417 of the insulation layer 404. The distance 460 being in the range of 0.01 inch to 0.1 inch. In this exemplary embodiment, a thickness Pₜ of the panel 450, as measured from the outer structural surface 414 to the outer insulation surface 417, is in the range of about 1 inch to about 2 inches.

The drainage grooves 456 are designed on the surface of the panel 450 such that gravity allows for the drainage of water from the sheathing system. The drainage grooves 456 create pathways that guide water away from the panel 450 and away from the building envelope. The panel 450 can comprise a series of drainage grooves 456 arranged vertically such that as water or moisture encounters the drainage grooves 456, gravity pulls the water down and away from the building envelope. In one embodiment, drainage grooves 456 can take the form of a square groove as depicted in FIG. 6. In other embodiments, drainage grooves 456 are V-shaped grooves, rectangular grooves, or curved grooves. Additional shapes can be contemplated for use as the drainage grooves 456.

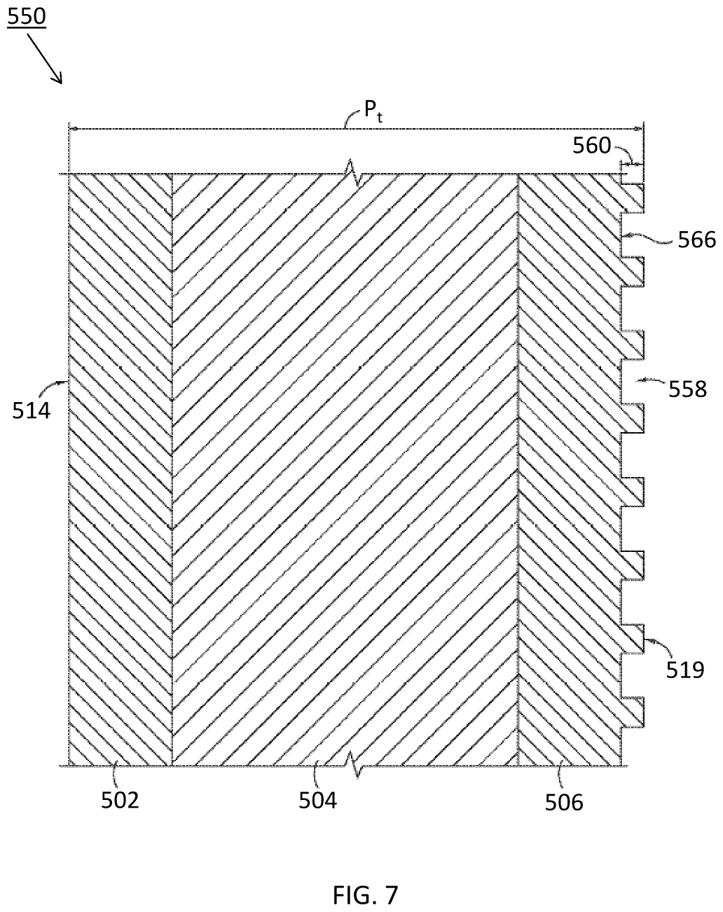

Similarly, an alternative embodiment of the panel 500 (of the 3-layer system shown in FIGS. 5A-5G) is illustrated in FIG. 7. As shown in the top-down view of FIG. 7, the modified panel 550 includes a plurality of drainage channels or grooves formed in the second structural layer 506 to prevent moisture buildup. The plurality of drainage grooves 558 can be recessed within (or extend from) the second structural layer 506. The offset or recess distance formed by the drainage grooves 558 is depicted by a distance 560 that extends from a recess surface 566 to the outer surface 519 of the second structural layer 506. The distance 560 being in the range of 0.01 inch to 0.1 inch. In some embodiments, a thickness Pₜ of the panel 550, as measured from the first outer structural surface 514 to the second outer structural surface 519, is in the range of about 1 inch to about 2 inches. In one exemplary embodiment, the thickness Pₜ of the panel 550 is 1 inch or less. In some embodiments, the number of drainage grooves 558 per foot of the panel 550 can be in the range of 1 drainage groove per foot to 12 drainage grooves per foot.

The drainage grooves 558 are designed on the surface of the panel 550 such that gravity allows for the drainage of water from the sheathing system. The drainage grooves 558 create pathways that guide water away from the panel 550 and away from the building envelope. The panel 550 can comprise a series of drainage grooves 558 arranged vertically such that as water or moisture encounters the drainage grooves 558, gravity pulls the water down and away from the building envelope. In one embodiment, drainage grooves 558 can take the form of a square groove as depicted in FIG. 7. In other embodiments, drainage grooves 558 are V-shaped grooves, rectangular grooves, or curved grooves. Additional shapes can be contemplated for use as the drainage grooves 558.

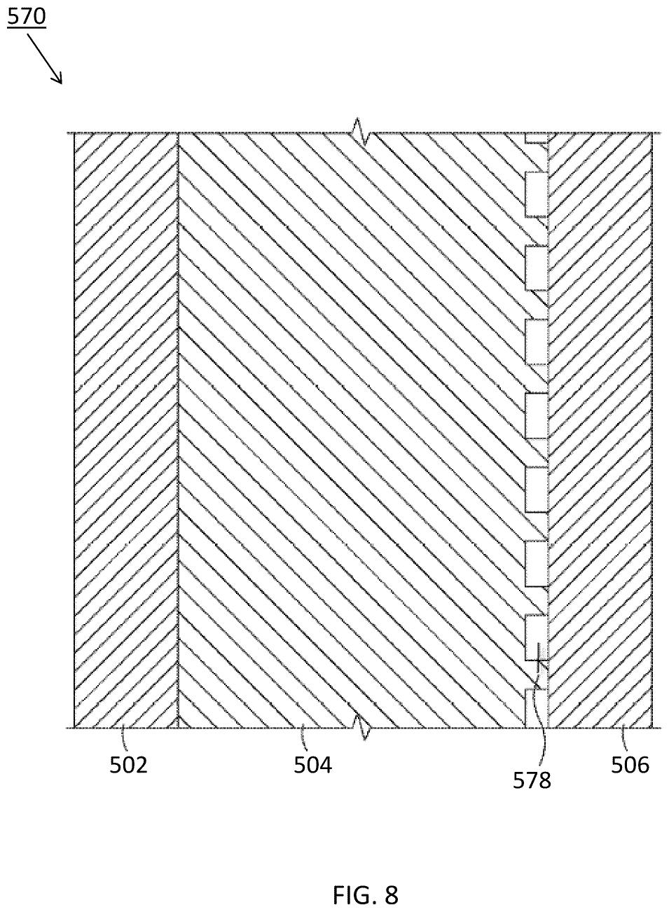

Another alternative embodiment of the panel 500 (of the 3-layer system shown in FIGS. 5A-5G) is illustrated in FIG. 8. As shown in the top-down view of FIG. 8, the modified panel 570 comprises the first structural layer 502, the insulation layer 504, and the second structural layer 506, wherein a plurality of drainage channels or grooves are formed in the insulation layer 504 to prevent moisture buildup. The drainage grooves 578 allow moisture to flow between the second structural layer 506 and the insulation layer 504.

The drainage grooves 578 extend through the panel 570 such that gravity allows for the drainage of water from the sheathing system. The drainage grooves 578 create pathways that guide water through and away from the panel 570 and away from the building envelope. In one embodiment, drainage grooves 578 can take the form of a square groove as depicted in FIG. 8. In other embodiments, drainage grooves 578 are V-shaped grooves, rectangular grooves, or curved grooves. Additional shapes can be contemplated for use as the drainage grooves 578.

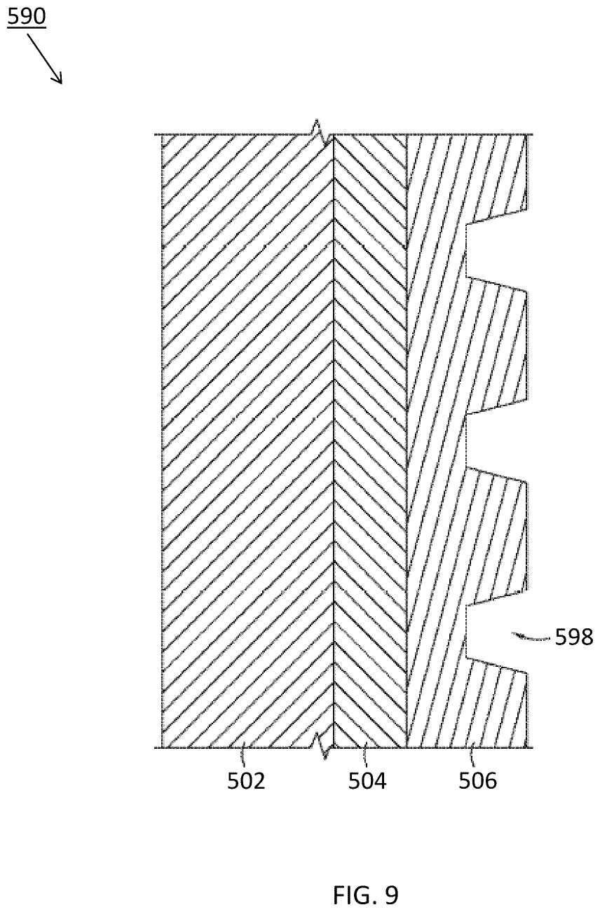

Another alternative embodiment of the panel 500 (of the 3-layer system shown in FIGS. 5A-5G) is illustrated in FIG. 9. As shown in the top-down view of FIG. 9, the modified panel 590 comprises the first structural layer 502, the insulation layer 504, and the second structural layer 506, wherein a plurality of drainage channels or grooves are formed in the outer surface of the second structural layer 506 to prevent moisture buildup.

The drainage grooves 598 provide a varied cross section with non-perpendicular surfaces. The pattern of the drainage grooves 598 are designed to improve flow of moisture next to the panel 590 for eventual extraction from the sheathing system altogether. As part of the sheathing system, the drainage grooves 598 allow gravity to cause the drainage of water from the sheathing system. The drainage grooves 598 create pathways that guide water away from the panel 590 and away from the building envelope.

As shown in FIGS. 6-9, the drainage grooves 456, 558, 578, 598 can be vertical in orientation such that water flows directly down. Alternatively, the drainage grooves 456, 558, 578, 598 may be oriented in a horizontal arrangement or parallel to the ground when the sheathing system (e.g., panels 450, 550, 570, 590) is installed. In other embodiments, the drainage grooves 456, 558, 578, 598 can be oriented in a diagonal arrangement, a radial arrangement, or a serpentine arrangement.

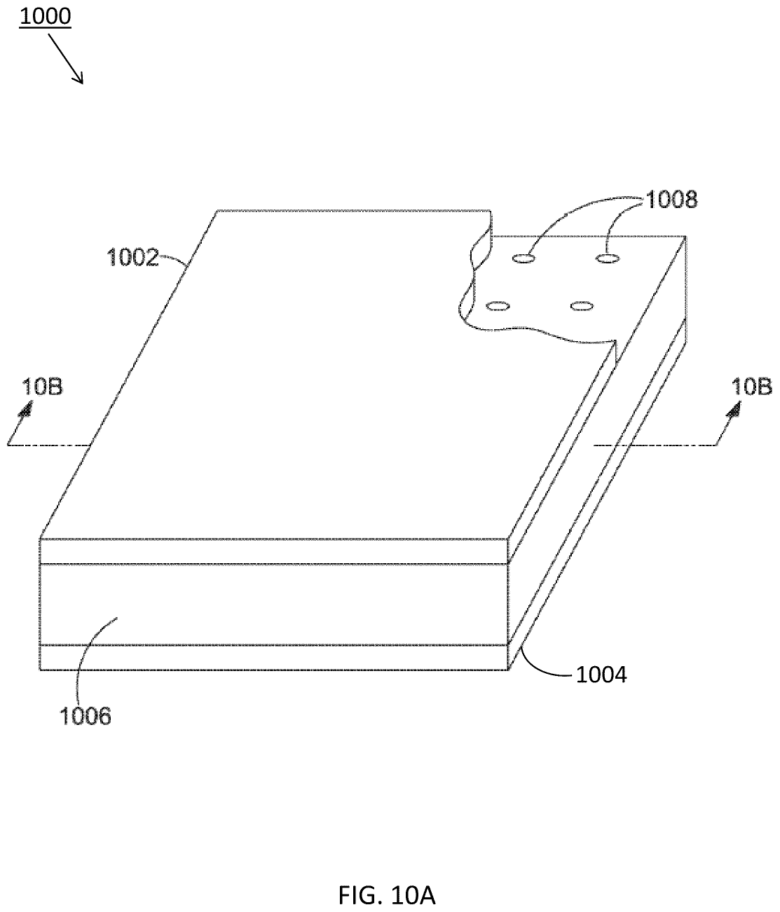

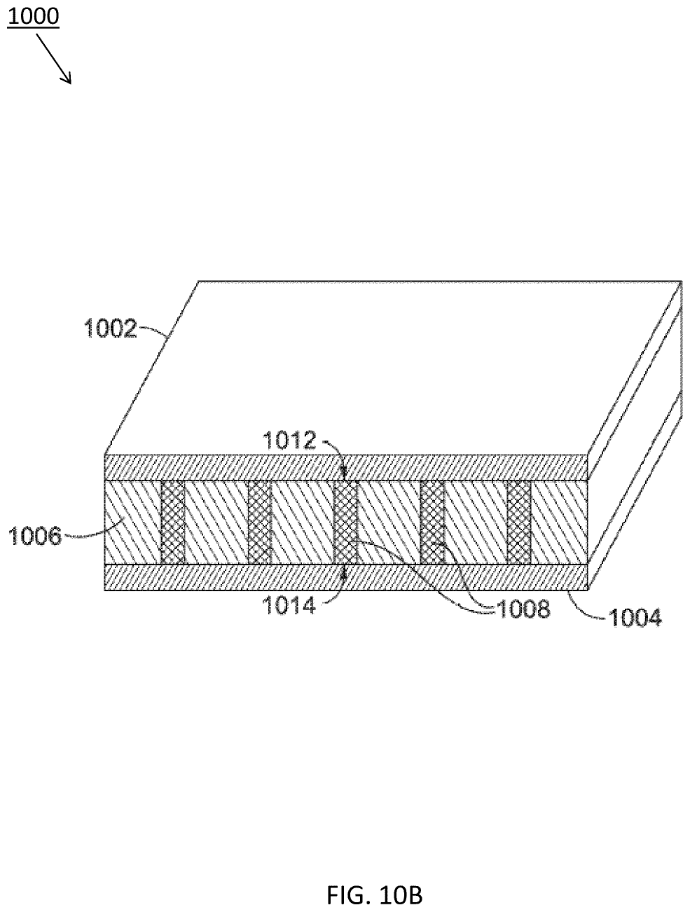

Alternative embodiments for coupling a first structural layer 1002, an insulation layer 1006, and a second structural layer 1004 are depicted in FIGS. 10A-10B. With specific reference to FIG. 10A, a perspective view of a sheathing system panel 1000 is shown, which comprises the first structural layer 1002, the second structural layer 1004, the insulation layer 1006, and one or more rods 1008. The illustration of FIG. 10A has a cutout portion of the first structural layer 1002 exposing the rods 1008 for purposes of illustration only. In one embodiment, the rods 1008 extend from the first structural layer 1002 through the insulation layer 1006 to the second structural layer 1004. In some aspects, the rods 1008 can take the form of a cylinder, a plane, a prism, a bar, or other shape that can connect the first structural layer 1002 and the second structural layer 1004 together.

Turning now to FIG. 10B, FIG. 10B depicts a cross section of the panel 1000 that incorporates the rods 1008 to connect the first structural layer 1002 and the second structural layer 1004. The rods 1008 in the panel 1000 can be made of high-strength and heat-resistant polymers. Various polymer materials can be utilized for the rods, depending on the specific requirements of the sheathing system panel 1000. For instance, engineering thermoplastics, such as nylon (e.g., nylon 6 or nylon 6/6), polypropylene, polycarbonate, or polyethylene terephthalate (PET) can be suitable options for the rods 1008.

In an additional embodiment, to fuse the panel 1000 together, a melting process can be used to secure the rods 1008 to the first structural layer 1002 and the second structural layer 1004. Additionally, the rods 1008 can comprise thermoplastic materials, wherein rods 1008 can be softened and fused during the assembly process. The melting process or a fusing process can involve the application of heat to the rods 1008, causing them to soften and melt slightly. The rods 1008 can penetrate the first structural layer 1002, the second structural layer 1004, and the insulation layer 1006, filling any gaps or voids between them. As the molten rods 1008 cool and solidify, they create a strong bond and form a fused connection, permanently securing the first structural layer 1002 and the second structural layer 1004 together at ends 1012 and 1014.

In some embodiments, a melting process can be achieved through various methods. One approach is to use heated metal plates or heated molds that are pressed against the first structural layer 1002 and the second structural layer 1004. The heat from the plates or molds transfers to the rods 1008 at ends 1012 and 1014, causing them to melt and fuse with the first structural layer 1002 and the second structural layer 1004. Alternatively, localized heat sources, such as hot air or infrared heating, can be directed at specific areas where the rods 1008 are inserted, enabling selective melting and fusion.

In other embodiments, the sheathing system panel 1000 can comprise rods 1008 made of metal, which provide a robust and durable solution for connecting the first structural layer 1002, the second structural layer 1004, and the insulation layer 1006. Metal rods offer high strength, rigidity, and resistance to various environmental conditions. Metals utilized for this purpose include stainless steel, aluminum, or steel alloys.

In some other embodiments, the rods 1008 can have various diameters and lengths to accommodate different panel sizes and design requirements. The ends 1012 and 1014 of the rods 1008 can be threaded, allowing them to be easily inserted and securely fastened to the structural layers. Alternatively, the rods 1008 can be designed with enlarged heads or flanges that mechanically lock into the outer surfaces of the layers, providing a secure connection without the need for additional fasteners.

In an additional embodiment, the rods 1008 can have a flanged or enlarged portion on the ends 1014 such that the rods 1008 hold the insulation layer 1006 to the second structural layer 1004. The rods 1008 can then be connected to the first structural layer 1002 and the second structural layer 1004 by means of melting, fusing, or other means.

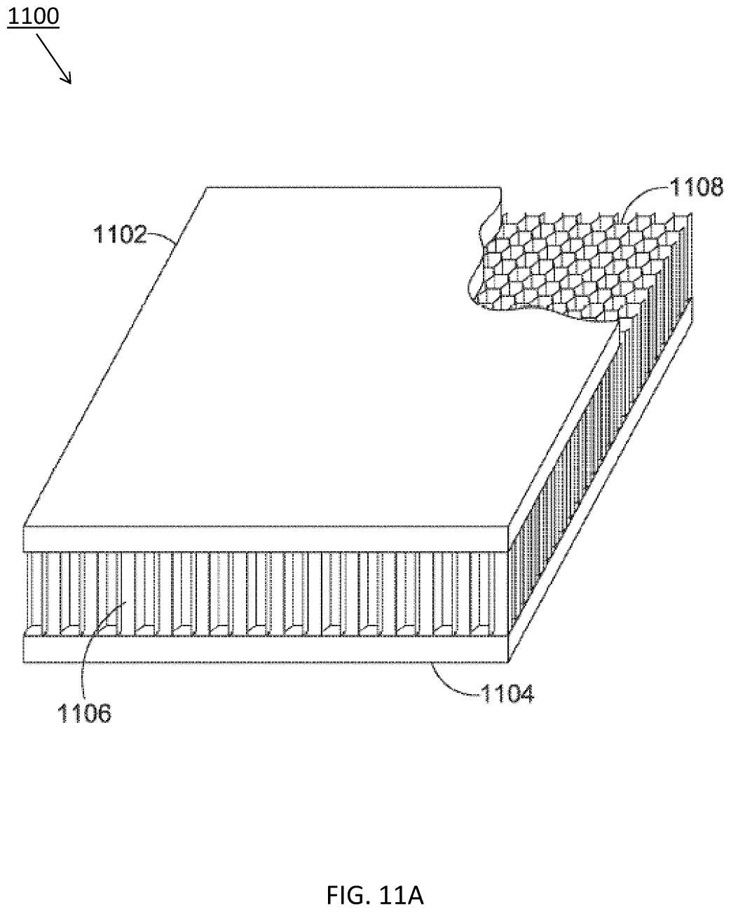

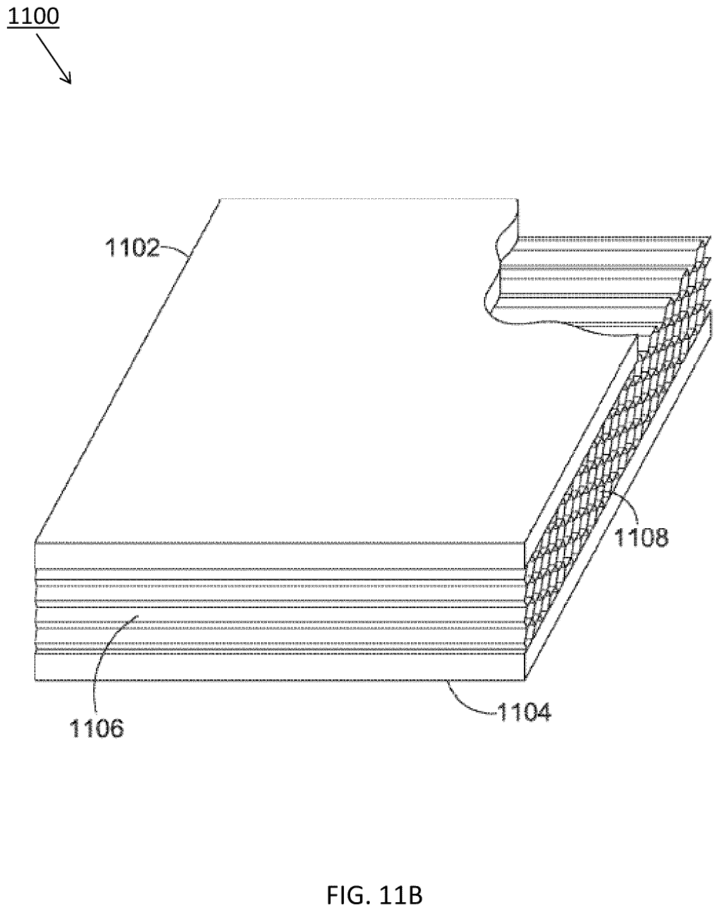

Another alternative construction for a sheathing system panel 1100 is shown in FIGS. 11A-11B. The panel 1100 comprises a first structural layer 1102, a second structural layer 1104, and a support layer 1106. The first structural layer 1102 and the second structural layer 1104 may have any of the characteristics of the structural layers described herein for other sheathing system panel embodiments. Accordingly, for the sake of brevity, a detailed description of the first structural layer 1102 and the second structural layer 1104 will not be repeated with respect to the sheathing system panel 1100 illustrated in FIGS. 11A-11B.

Between the first structural layer 1102 and the second structural layer 1104 is support layer 1106. The support layer 1106 comprises a series of walls or structures that separate the first structural layer 1102 and the second structural layer 1104. As shown in FIG. 11A, the support layer 1106 can have a series of walls that extend perpendicular from the first structural layer 1102 to the second structural layer 1104. The support layer 1106 creates elongated hexagonal spaces or void portions that extend from the first structural layer 1102 to the second structural layer 1104, such as insulation void portion 1108. As an example, the support layer 1106 comprises walls that extend from the first structural layer 1102 to the second structural layer 1104 creating insulation void portion 1108. The insulation void portion 1108, as shown in FIG. 11A can be oriented such as to extend from the first structural layer 1102 and the second structural layer 1104. In another embodiment, as shown in FIG. 11B, the support layer 1106 can have a series of structures that extend from the first structural layer 1102 to the second structural layer 1104. The support layer 1106 creates elongated hexagonal spaces or void portions that are parallel with the first structural layer 1102 and the second structural layer 1104, such as insulation void portion 1108. The insulation void portion 1108, as shown in FIG. 11B can be oriented parallel to the first structural layer 1102 and the second structural layer 1104.

The support layer 1106 can be comprised of any material that may be used or formed into a wall or support structure. For example, the support layer 1106 can be comprised of polycarbonate, polyurethane, metal, wood, or any other structurally supportive material, as required by the intended use of the support layer 1106.

The insulation void portion 1108 refers to the space or cavity created by the support layer 1106 of the panel 1100. The insulation void portion 1108 can be filled with insulation material to ensure that the insulation material is properly contained within the panel. In some embodiments, the insulation material can comprise various insulating substances such as foam, fiberglass, or polymer-based insulation. The insulation void portion 1108 can be filled using spray foam, polyisocyanurate, EPS, recycled XPS, XPS, or other insulation materials. These materials can be sprayed, poured, or stuffed into the insulation void portion 1108. As can be seen in FIG. 11A, with the insulation void portion 1108 perpendicular to the first structural layer 1102 and the second structural layer 1104, the insulation void portion 1108 can be filled when one or more of the structural layers is not secured to the sheathing system 1100. However, as can be seen in FIG. 11B, having the insulation void portion 1108 parallel to the first structural layer 1102 and the second structural layer 1104, the insulation void portion 1108 can be filled when the sheathing system panel 1100 is completely assembled.

In some embodiments, the support layer 1106 in the panel 1100 can be designed with a honeycomb pattern, creating a series of interconnected, hexagonal-shaped cells or chambers that form a regular and uniform structure throughout the support layer. A plurality of hexagonal cells or chambers created by the support layer 1106 produces a network of interconnected walls that distribute applied loads and stresses evenly across the panel 1100, improving its structural integrity. As shown in FIG. 11A, the hexagonal cells or insulation void portion 1108 can be oriented such that the openings of the insulation void portion 1108 are adjacent to or facing the first structural layer 1102 and the second structural layer 1104. Additionally, as shown in FIG. 11B, the hexagonal cells or insulation void portion 1108 can be oriented such that the openings of the insulation void portion 1108 are parallel to the first structural layer 1102 and the second structural layer 1104.

In addition to the honeycomb pattern, in is contemplated that various other patterns can be employed in the support layer 1106 of the sheathing system panel 1100. These patterns offer different structural characteristics and can be selected based on specific design requirements and desired performance attributes. Other patterns can include, for instance: a square grid pattern with a series of interconnected square cells that form a grid-like structure; a triangular truss pattern that consists of interconnected triangular cells that create a truss-like framework; a diamond pattern that features interconnected diamond-shaped cells that form a repeating pattern; or a hexagonal grid pattern that, similar to the honeycomb pattern, consists of interconnected hexagonal cells. However, unlike the honeycomb pattern, the hexagonal grid does not form a continuous network of cells but rather a grid-like arrangement. In another embodiment, the support layer 1106 may include a random pattern that is a non-repetitive arrangement of cells or voids. The support layer can be designed with varying sizes and shapes of voids, providing flexibility in material distribution and load-bearing capabilities.

The use of polycarbonate as at least one structural layer in an insulated sheathing system panel gives the panel an ability to resist nail withdrawal at a reduced thickness and/or weight, without sacrificing thermal or structural performance.

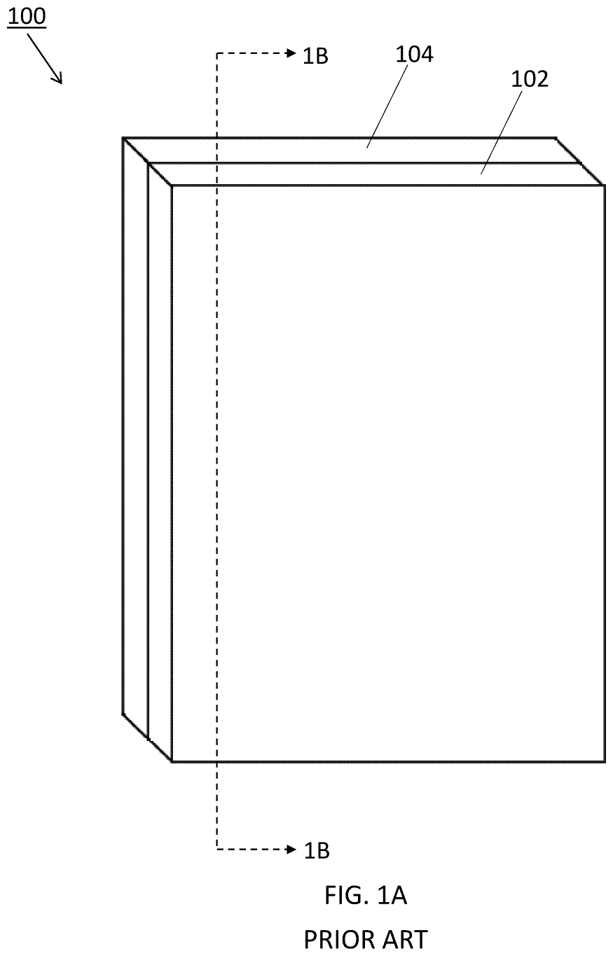

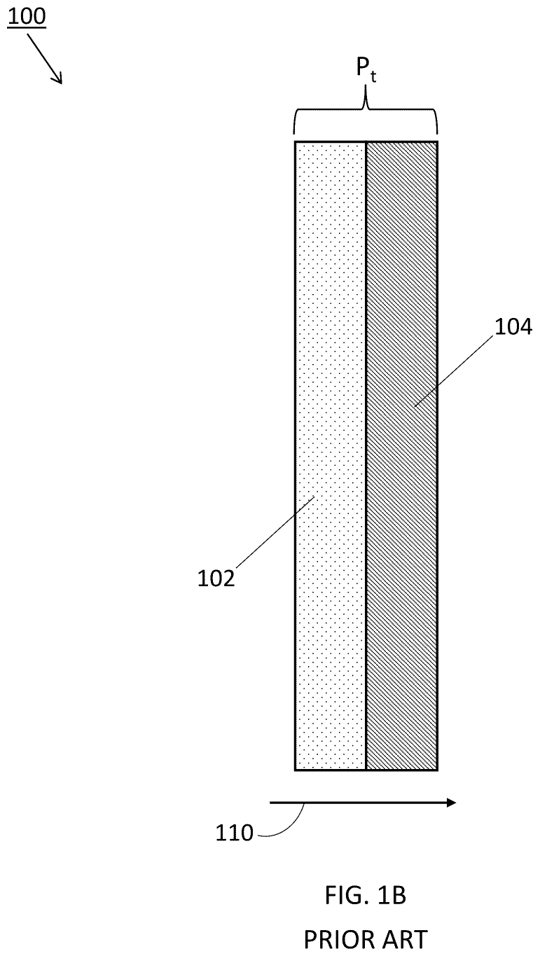

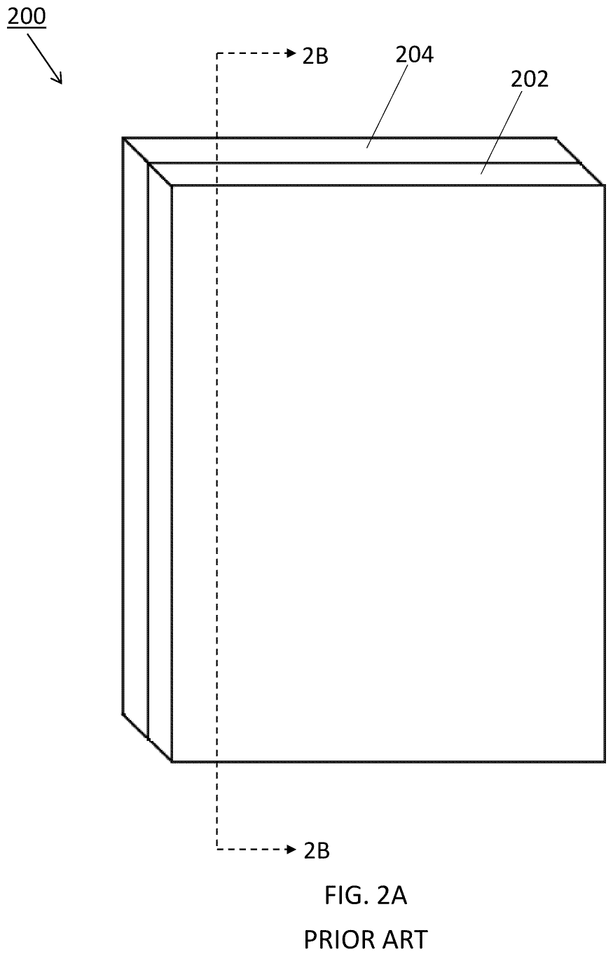

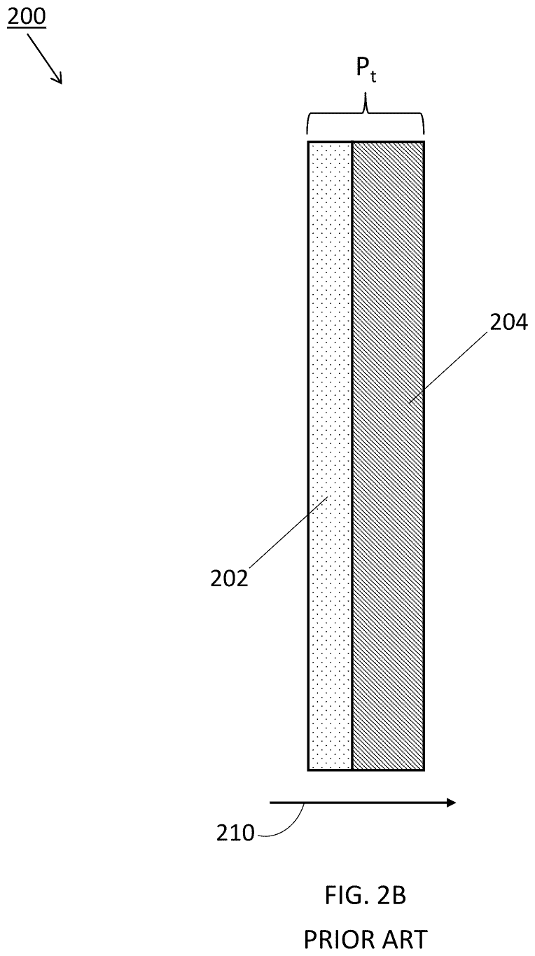

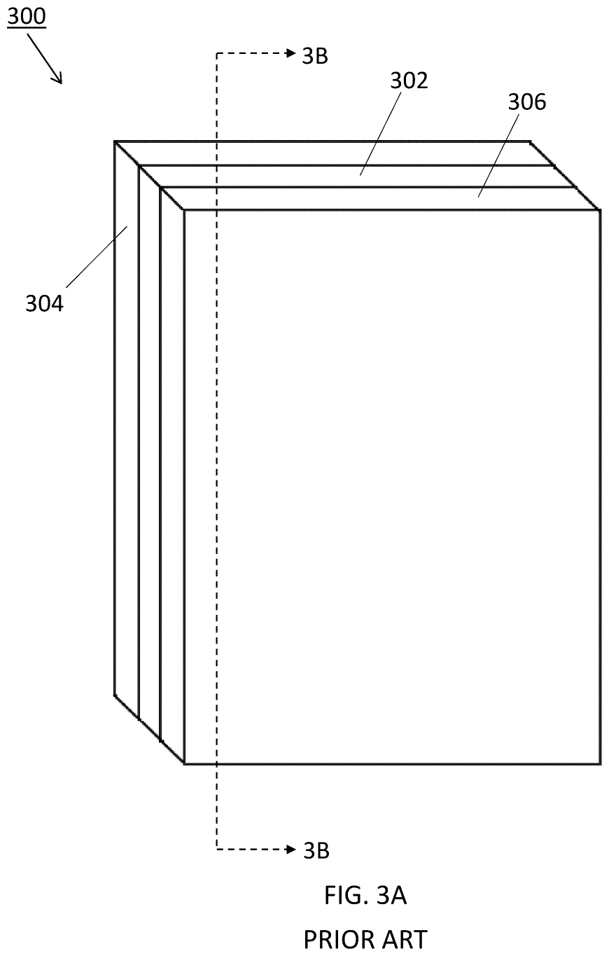

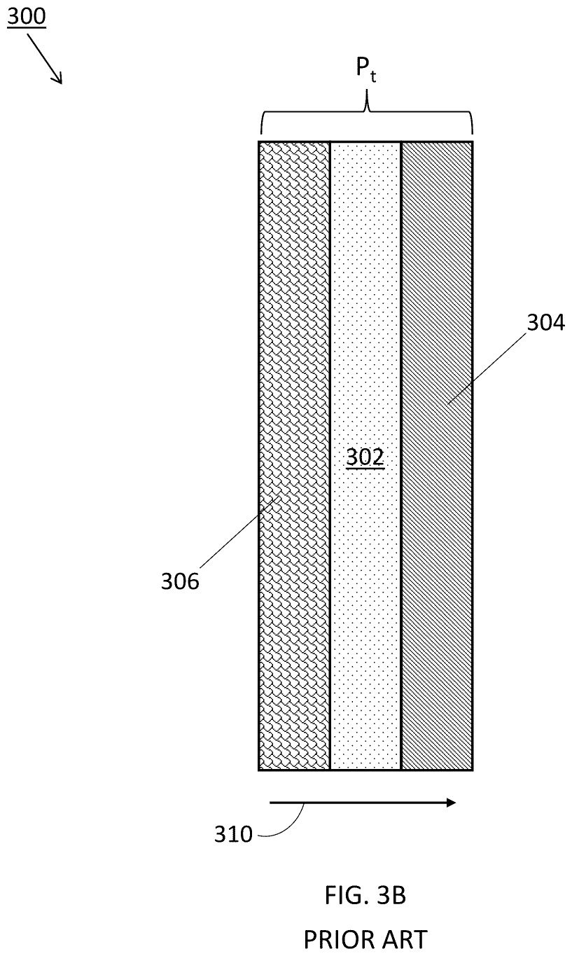

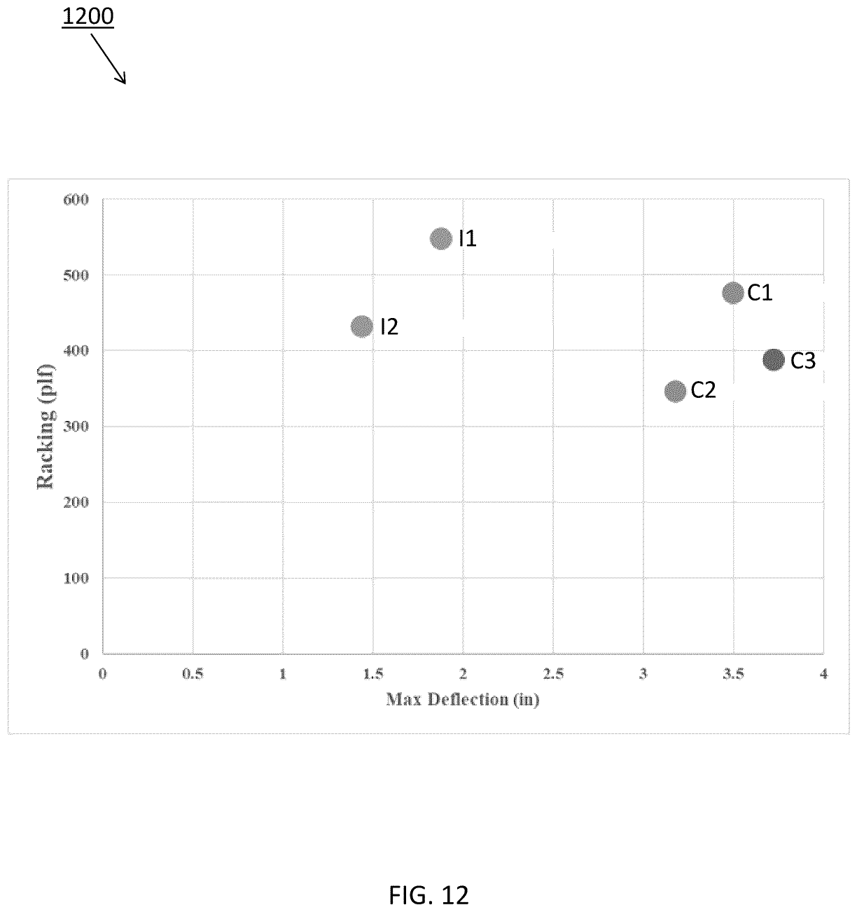

For example, as shown in the graph 1200 of FIG. 12, two inventive panels (I1, I2) were compared to three conventional control panels (C1, C2, C3). I1 is a 3-layer sheathing panel comprising a first structural layer of ¼ inch thick OSB, an insulation layer of ¾ inch thick XPS, and a second structural layer of 1/16 inch thick polycarbonate. I2 is a 3-layer sheathing panel comprising a first structural layer of ¼ inch thick OSB, an insulation layer of ¾ inch thick XPS, and a second structural layer of 1/32 inch thick polycarbonate. C1 is a 2-layer sheathing panel comprising a structural layer of 7/16 inch thick OSB and an insulation layer of ¾ inch thick XPS (see FIGS. 1A-1B). C2 is a 2-layer sheathing panel comprising a non-structural layer of ¼ inch thick OSB and an insulation layer of ¾ inch thick XPS (see FIGS. 2A-2B). C3 is a 3-layer sheathing panel comprising a structural layer of 7/16 inch thick OSB, an insulation layer of 1 inch thick polyiso, and a non-structural, paper-thin (i.e., much less than 1/16 inch thick) layer of material that is bulk water resistant and water vapor permeable (see FIGS. 3A-3B). I1, I2, C1, and C3 are considered structural panels, while C2 is not considered a structural panel (i.e., since ¼ inch OSB is not rated as a structural sheathing material by the American Plywood Association (APA) because it does not provide enough racking shear resistance per the IRC 2021 recommendation).

The weight and thickness of each of the evaluated panels is presented in Table 5.

TABLE 5

| # | Weight (lbs) | Thickness (in) |
|---|---|---|
| I1 | 42 | 1.06 |
| I2 | 38 | 1.03 |
| C1 | 56 | 1.2 |
| C2 | 30 | 1 |
| C3 | 60 | 1.5 |

As can be seen in Table 5, amongst the structural panels (I1, I2, C1, and C3), the inventive panels I1 and I2 have the lowest weights and thicknesses.

Furthermore, as shown in the graph 1200, the inventive panels I1 and I2 have better resistance to deflection than the conventional panels C1, C2, and C3. Additionally, the inventive panel I1 has better racking strength than the conventional panels C1, C2, and C3, while the inventive panel I2 has better racking strength than the conventional panels C2 and C3.

In addition to the racking strength and the maximum deflection, the nail retention (i.e., the amount of force necessary to overcome the panel resistance to nail removal and the amount of force necessary to hold siding securely if fasteners are not nailed on the studs) was measured for each of the panels. The measurements of the panels are summarized in Table 6.

TABLE 6

| # | Racking (plf) | Max Deflection (in) | Nail Retention (lb) |
|---|---|---|---|
| I1 | 547 | 1.8752 | 120 |
| I2 | 432 | 1.4397 | 60 |
| C1 | 477 | 3.4945 | 60 |
| C2 | 347 | 3.1739 | 20 |
| C3 | 388 | 3.7245 | 60 |

Racking strength, maximum deflection, and nail retention provide a metric for assessing short-term performance of a sheathing system panel. Here, the inventive panel I1 exhibited significantly improved nail retention performance compared to the conventional panels C1, C2, and C3. The inventive panel I2 demonstrated comparable nail retention performance to the conventional structural panels C1 and C3, notwithstanding that it was the thinnest and lightest of the structural panels (i.e., I1, I2, C1, and C3).

To assess long term performance of the sheathing system panels, nailing torque force (lb) was measured. The nailing torque force is the force applied vertically on the plane of the panel that is perpendicular to the nail. The force is measured by applying a compressive force that is perpendicular to the nail. The force is measured when the displacement of the panel reaches ½ inch. This proprietary test is based on ASTM D1037, section 13. The measurements of the panels are summarized in Table 7.

TABLE 7

| # | Nailing Torque Force (lb) |
|---|---|
| I1 | 334.3 |
| I2 | 270.9 |
| C1 | 277.5 |
| C2 | 206.3 |
| C3 | 240.5 |

Again, the inventive panel I1 exhibited significantly improved nailing torque force performance compared to the conventional panels C1, C2, and C3. The inventive panel I2 demonstrated comparable nailing torque force performance to the conventional structural panels C1 and C3, notwithstanding that it was the thinnest and lightest of the structural panels (i.e., I1, I2, C1, and C3).

As another indicator of long term performance, the panels (i.e., 11, 12, C1, C2, and C3) were assessed for long term sagging properties. This test involved taking 4 ft×4 ft samples of the panels and affixing them to a mock wooden frame (i.e., SPF No. 2 type stud) using 16d 2.5 inch nails. Three samples were measured for each panel. A linear actuator was used to apply a force to each sample necessary to achieve 0.5 inch displacement of the sample. A larger displacement was avoided, as it would begin to overlap with the sample's nail retention property. The applied force is intended to simulate the sagging force needed to deform the panel. The measurements of the panels are summarized in Table 8.

TABLE 8

| # | Nailing Torque Force (lb) |
|---|---|
| I1 | ~334 |
| I2 | ~271 |
| C1 | ~278 |
| C2 | ~206 |
| C3 | ~241 |

Again, the inventive panel I1 exhibited improved sagging resistance performance compared to the conventional panels C1 and C2. The inventive panel I2 demonstrated sagging resistance performance comparable to the C1 panel and better than the C2 panel, notwithstanding that it was the thinnest and lightest of the panels (i.e., I1, I2, C1, and C2).

In addition to establishing that inclusion of a polycarbonate layer in a multi-layer sheathing panel can result in a lighter and/or thinner sheathing system that has improved or at least comparable performance to conventional sheathing systems, the impact of the location of the polycarbonate layer in the panel was also explored.

In particular, in the context of an extended plate and beam (EP&B) wall system, two different embodiments of an inventive 3-layer sheathing panel were evaluated against a conventional (control) 2-layer sheathing panel sheathing panel. The assessed panels are summarized in Table 9.

TABLE 9

| | Inner | Middle | Outer | Racking | Deflection |
|---|---|---|---|---|---|
| # | Layer | Layer | Layer | (plf) | (in) |
| EP&B-1 | 1/16″ | 2″ | 7/16″ | 600-800 | 1.8-3 |
| | polycarbonate | foam | OSB | (662) | (2.5) |
| EP&B-2 | 2″ | 1/16″ | 7/16″ | 500-700 | 1.8-3 |
| | foam | polycarbonate | OSB | (585) | (2.7) |
| EP&B- | 2″ | N/A | 7/16″ | 300-500 | 1.3-2 |
| Control | foam | | OSB | (310) | (1.6) |

From Table 9, it can be seen that all three panels include the same 2-inch foam insulation layer and the same 7/16-inch OSB structural layer. However, the EP&B-Control panel does not include any polycarbonate layer. The EP&B-Control panel is similar to the panel I00 shown in FIGS. 1A-1B. Both the EP&B-1 and EP&B-2 panels include a 1/16-inch polycarbonate structural layer, although the polycarbonate layer is the innermost layer in the EP&B-1 panel and the polycarbonate layer is the middle layer in the EP&B-2 panel.

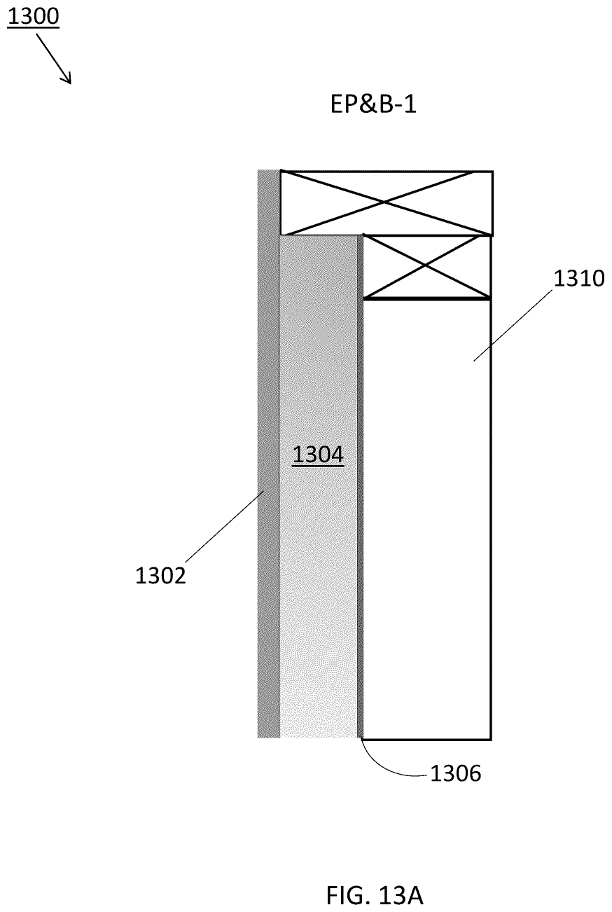

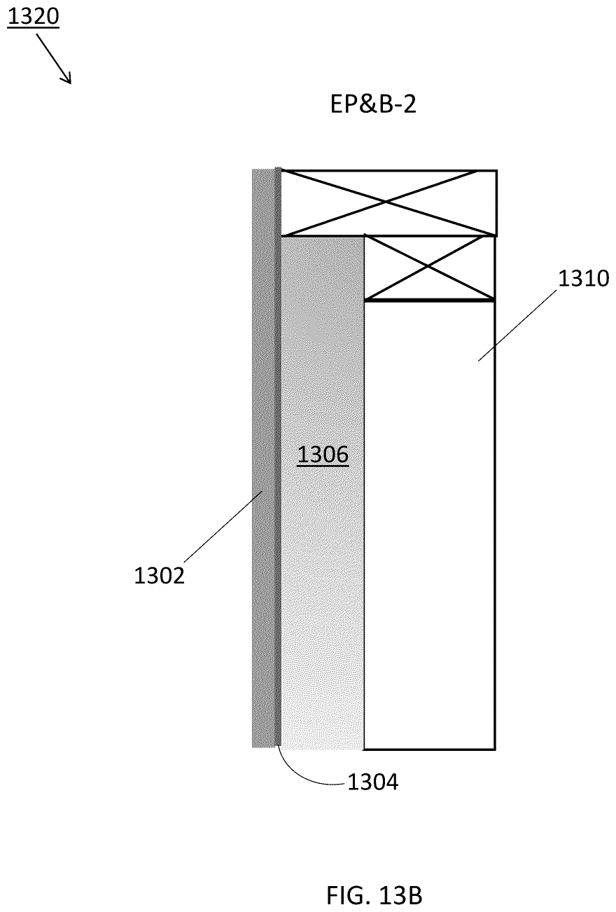

In particular, as shown in FIG. 13A, the EP&B-1 panel 1300 includes an outer layer 1302 of OSB, a middle layer 1304 of foam insulation, and an inner layer 1306 of polycarbonate. As shown in FIG. 13B, the EP&B-2 panel 1320 includes an outer layer 1302 of OSB, a middle layer 1304 of polycarbonate, and an inner layer 1306 of foam insulation. In FIGS. 13A-13B, both panels 1300, 1320 are shown installed on the frame 1310 of an EP&B wall system.

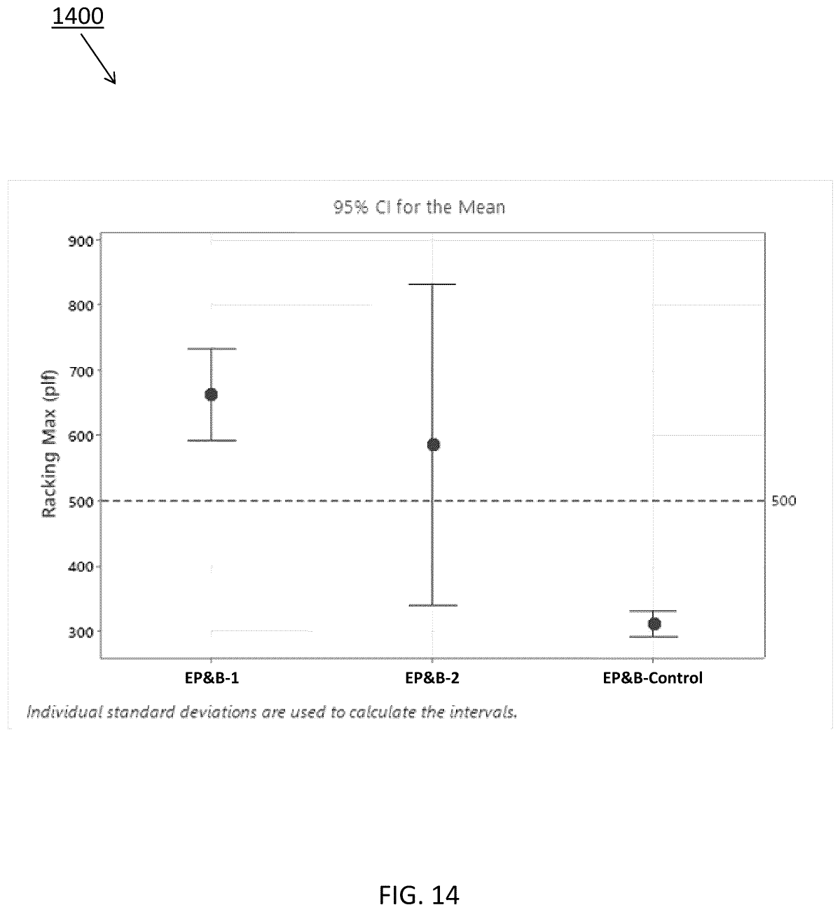

Table 9 also includes the expected ranges of values for the racking strength and the maximum deflection of the panels. The actual measured values of the panels are plotted in the graph 1400 of FIG. 14. As shown in the graph 1400, for a minimum recommended racking strength of 500 plf, the 2-layer panel (EP&B-Control) lacking any polycarbonate layer failed to reach the recommended racking strength, while both the inventive panels (EP&B-1 and EP&B-2) containing a layer of polycarbonate exceeded the recommended racking strength. In other words, it was surprisingly found that inclusion of a relatively thin (e.g., about 1/16 inch) layer of polycarbonate could substantially improve the racking performance of an otherwise identical 2-layer panel.

As described herein, the purpose of the insulation layer (e.g., insulation layers 404, 504) in the sheathing system panels is to provide enhanced thermal resistance. The insulation layer can comprise materials selected to have a high R-value or, in the instance of a polymer foam insulation layer, coated with a barrier coating composition that reduces blowing agent diffusion and increase the foam's thermal performance or R-values (e.g., a 180-day R/in value of at least 4.8). In one exemplary embodiment, the insulation layer comprises extruded polystyrene (XPS). It is contemplated that insulation layer can comprise any insulating material, including but not limited to fiberglass, wood, foam, polymers, wood composite materials, expanded polystyrene (EPS), foamed polyurethane, polyisocyanurate board, fiber-reinforced polymer, thermoplastic, polymer-based materials, mineral wool, closed cell thermoplastic, thermoplastic polystyrene, polyethylene terephthalate, polyester resin, phenolic foam, aerogel blanket, aerogel board, cellulosic insulation, rock wool insulation, or any combination thereof. Polymer-based insulation materials, which can also or alternatively be utilized in insulation layer, can include polyurethane, phenolic foam, TPO, thermoplastic polyolefin (TPO), and ethylene propylene diene monomer (EPDM), among other things.

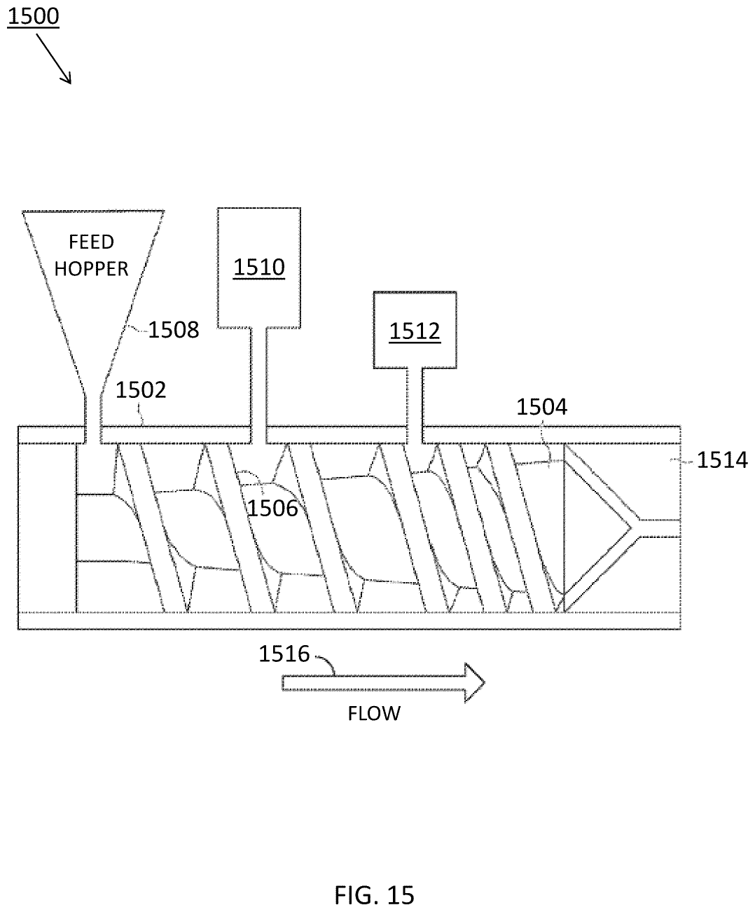

An exemplary embodiment of an extrusion apparatus 1500 that could be used for the production of polymer insulation (e.g., XPS) layers is shown in FIG. 15. The extrusion apparatus 1500 can comprise a single 1504 or double (not shown) screw on which a spiral flight 1506 is provided. The screw 1504 is surrounded by a barrel 1502. The spiral flight 1506 is configured to compress, and thereby heat, material introduced into the screw extruder 1500. As illustrated in FIG. 15, the polymer composition can be conveyed into the screw extruder as a flowable solid. By way of non-limiting example, a flowable solid can be conveyed into the screw extruder 1500 in the form of beads, granules, or pellets, or conveyed into the screw extruder as a liquid or semi-liquid melt from one 1508 or more (not shown) feed hoppers.

As the basic polymer composition advances in a flow direction 1516 through the screw extruder 1500, the decreasing spacing of the flight 1506 defines a successively smaller space through which the polymer composition is forced by the rotation of the screw 1504. This decreasing volume acts to increase the temperature of the polymer composition to obtain a polymer melt (if solid starting material was used) and/or to increase the temperature of the polymer melt.

As the polymer composition advances through the extrusion apparatus 1500, one or more ports (e.g., port 1510, port 1512) can be provided through the barrel 1502 for injecting one or more blowing agents and optional additives into the polymer composition. In some embodiments, a barrier coating composition can be added through one or more of the ports 1510, 1512, as will be described in greater detail below. Once the blowing agent(s) have been introduced into the polymer composition, the resulting mixture is subjected to additional blending sufficient to distribute each of the blowing agents or optional additives generally uniformly throughout the polymer composition to obtain a polymer foamable composition.

The polymer foamable composition is then forced through an extrusion die 1514 and exits the die into a region of reduced pressure (which can be below atmospheric pressure), thereby allowing the blowing agent to expand and produce a polymer foam material. This pressure reduction can be achieved gradually as the extruded polymer foamable composition advances through successively larger openings of the die or through some suitable apparatus (not shown) provided downstream of the extrusion die. The polymer foam material can also be subjected to additional processing, such as calendaring, water immersion, cooling sprays or other operations to control the thickness and other properties of the resulting foam insulation layer (referred to herein interchangeably as “foam product” and/or “foam insulation product”).

In any of the exemplary embodiments, a barrier coating composition can be applied to one or more surfaces of a foam insulation layer, wherein the barrier coating can reduce blowing agent diffusion and increase the foam's thermal insulation performance. The barrier coating composition can be applied, for example, to one or more surfaces of the insulation layer using any one of a variety of coating methods. For example, the barrier coating composition can be applied via a roller, brush, spray coating method, dip coating, spin coating, flow coating, curtain coating, and the like. Other coating methods known and used in the art can be employed, and are contemplated within the subject disclosure.

In some embodiments, the barrier coating composition is preferably applied to a foam insulation layer post-production (i.e., post extrusion, expansion, or other foam production method). The barrier coating composition can be applied to the insulation layer shortly following production, such as within 12 hours, 6 hours, 3 hours, 2 hours, 1 hour, or 30 minutes of production. Following application, the coating is dried to form a barrier coating on at least one surface of the insulation layer. Although described as being applied to one or more of the third surface of the insulation layer and the fourth surface of the insulation layer, it should be appreciated that the barrier coating composition can additionally, or alternatively, be applied to each surface of the insulation layer. For example, the barrier coating composition can be applied to one or more edges of the insulation layer. In some embodiments, the barrier coating can be applied such that it forms a continuous coating on the one or more surfaces of the insulation layer. In other embodiments, the barrier coating can form only a partial, discontinuous coating on one or more surfaces of the insulation layer.

In any of the exemplary embodiments, the barrier coating composition can be applied directly to the surface of the insulation layer with no intervening layers between the insulation layer surface and the barrier coating composition. Additional coating layers, including additional layers of the barrier coating composition, can optionally be applied on a first barrier coating composition layer. However, it is contemplated that, in some instances, one or more optional primer layers can be applied between the barrier coating composition and the surface of the insulation layer such that the barrier coating composition is applied indirectly to the surface of the insulation layer.

Further, it is contemplated that, in any of the exemplary embodiments, the barrier coating composition described herein may be incorporated into the foamable composition. For example, instead of applying the barrier coating composition as a coating on at least one surface of the insulation product, (or in addition to) the barrier coating composition can be injected into the screw extruder. In embodiments in which the polymer of the barrier coating composition is a resin, the polymer may be introduced into the feed hopper in pellet form. It should be appreciated that, when injected into the extruder, certain properties of the barrier coating composition may differ from those of a barrier coating composition intended for coating on a surface of the polymer insulation product, including, but not limited to, the viscosity of the coating composition and the solids loading of the barrier coating.

The barrier coating composition can comprise a dispersion, solution, or emulsion comprising one or more polymers. The polymers can comprise one or more barrier polymers, such as poly(vinylidene chloride) (PVdC) and PVdC-based copolymers, polyvinyl alcohol (PVOH), poly(ethylene-co-vinyl alcohol) (EVOH), poly(vinylidene fluoride) (PVdF), polyurethane, styrene butadiene (SBR), polyvinyl chloride (PVC), poly(acrylates) and copolymers, polyamides (e.g., Nylon-6), polyesters (e.g., PET), polystyrene (PS), polyglycolic acid (PGA), poly(ethylene 2,5-furandicarboxylate) (PEF), poly(butylene succinate) (PBS), bio-based ethylene (Bio-PE), wax, such a natural wax (carnauba and montan wax), petroleum-based wax (paraffins, microcrystalline wax), or synthetic wax, derived from petroleum distillates or residues (polyethylene, polypropylene, Fischer-Tropsch wax), and combinations or copolymers thereof. Other polymers can be incorporated, provided they are capable of imparting gas barrier properties to the coating.

In any of the exemplary embodiments, the barrier polymer can be a homopolymer or a copolymer comprising one or more co-monomers, such as vinyl chloride, vinyl alcohols, vinyl esters, for example, vinyl acetate, vinyl ethers, acrylic acids, acrylic esters, acrylamides, methacrylic acids, methacrylic esters, methacrylamides, acrylonitrile, N-vinylpyrrolidone, methacrylonitrile, styrene, styrene derivatives, butadiene, olefins, ethylene and propylene, itaconic acid, and maleic anhydride, by way of non-limiting example. Co-monomers can also include copolymerizable surfactants, such as sodium salt of an allyl ether sulfonate (e.g., odium 1-allyloxy-2-hydroxypropyl sulfonate), 2-acrylamido-2-methylpropanesulphonic acid (AMPS) or one of its salts, 2-sulphoethylmethacrylic acid (2-SEM) or one of its salts, the phosphate ester of methacrylate-terminated polypropylene glycol or one of its salts, poly(ethylene oxide) methyl ether acrylate (PEOA), or poly(ethylene oxide) methyl ether methacrylate (PEOMA), by way of non-limiting example.

In any of the exemplary embodiments, the barrier polymer is at least a semi-crystalline polymer, with a minimum degree of crystallinity of 5%. Particularly, a barrier polymer having a degree of crystallinity of at least 10%, or at least 15%, or at least 20%, or at least 25%, or at least 30%, can provide a barrier coating composition with sufficient barrier properties. In any of the exemplary embodiments, the barrier polymer can comprise a degree of crystallinity of at least 20%, such as at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, by way of example.

The barrier polymer can be added in solid (e.g., resin) form, or in melted (e.g., liquid) form as a dispersion, solution, or emulsion (the “barrier polymer material”). When the barrier polymer is added in the form of a dispersion, the dispersion can be an aqueous dispersion (e.g., the polymer is dispersed in water), or a solvent-based dispersion.

When provided in the form of a dispersion, the barrier polymer can be present in a solids content of about 20 wt. % to about 100 wt. % based on the weight of the dispersion, including, for example, a solids contents from about 25 wt. % to about 85 wt. %, from about 30 wt. % to about 75 wt. %, from about 35 wt. % to about 65 wt. %, from about 40 wt. % to about 60 wt. %, from about 45 wt. % to about 56 wt. %, or any other endpoints or subrange included therein.

The polymer can also be characterized by the amount of barrier polymer present in the barrier coating composition, based on the total amount of solids present in the barrier coating composition. For example, the polymer can be included in an amount from about 40 wt. % to about 100 wt. %, based on the total amount of solids present in the barrier coating composition. The barrier coating composition including, for example, from about 50 wt. % to about 98 wt. %, from about 60 wt. % to about 96 wt. %, from about 70 wt. % to about 93 wt. %, and from about 75 wt. % to about 91 wt. %, including any other endpoints or subrange included therein.

The barrier coating composition can comprise one or more additives, whether added as part of the barrier polymer material or directly to the composition. Additives can include, for instance, processing aids, surfactants (wetting agents), rheology modifiers, flame retardants, defoaming agents (e.g. emulsions and/or dispersions of mineral, paraffin, or vegetable oils), silicone, dispersions of polydimethylsiloxane (PDMS) fluids, pH adjusters, UV stabilizers, and silica that has been hydrophobized with polydimethylsiloxane or other materials.

Exemplary rheology modifiers can include, for example, glycerol, 1,2,4-butanetriol, 1,4-butanediol, 1,2-propanediol, 1,3-propanediol, poly(ethylene glycol), clays, fumed silica, cellulose and derivatives thereof, polysaccharides, alkali-swellable polymers (ASE, HASE), hydrophobically modified urethane associative polymers (HEUR) (e.g., Rheobyke® 7600, available from BYK), alkali-acrylic emulsions, polyurea, polyamides and calcium sulfonates, and combinations thereof.

The viscosity of the barrier coating composition is important for ensuring the coating can be applied in the particular method intended, such as spraying, painting, dip coating, etc. Thus, a rheology modifier can be included in such a concentration to achieve a coating viscosity of less than about 400 cP at 30% solids or less, including less than about 300 cP at 30% solids or less, and less than about 200 cP at 30% solids or less. In any of the exemplary embodiments, the viscosity of the barrier coating composition can be no greater than 250 cP at 30% solids or less, such as between 50 cP to 225 cP, 75 cP to 200 cP, 90 cP to 175 cP, or 95 cP to 150 cP, including all subranges and endpoints there between. Such viscosity is particularly important to achieve a sprayable coating composition.

Thus, in various aspects of the present disclosure, the rheology modifier is included in the barrier coating composition in an amount between 0 to 20 wt. % based on the weight of the total solids content of the barrier coating composition, including between 0.1 wt. % to 18 wt. %, 0.2 wt. % to 15 wt. %, 0.5 wt. % to 12 wt. %, 1 wt. % to 10 wt. %, 1.5 wt. % to 8 wt. %, 2 wt. % to 6 wt. %, or 2.5 wt. % to 5 wt. %, including all subranges and endpoints there between.

As mentioned above, the barrier coating composition can include a pH adjuster in an amount sufficient to adjust the pH to a desired level. For example, organic and/or inorganic bases, can be included to increase the pH of the barrier coating composition. In some exemplary embodiments, the bases can be a volatile or non-volatile base. Exemplary volatile bases can include, for example, ammonia and alkyl-substituted amines, such as methyl amine, ethyl amine or 1-aminopropane, dimethyl amine, and ethyl methyl amine. Exemplary non-volatile bases can include, for example, sodium hydroxide, potassium hydroxide, sodium carbonate, and t-butylammonium hydroxide.

The pH of the barrier coating composition preferably has a pH between about 2 to about 10. For instance, the pH of the barrier coating composition can have values between 3 to 8, or 4 to 7, by way of non-limiting example. In any of the embodiments disclosed herein, the barrier coating composition can have a neutral pH between 6 to 7.

In various aspects of the present inventive concepts, the pH adjuster is included in the barrier coating composition in an amount between 0 and 15 wt. %, based on the weight of the total solids content of the barrier coating composition, including between 0.05 wt. % and 12 wt. %, between 0.1 wt. % and 10 wt. %, between 0.25 wt. % and 8 wt. %, between 0.4 wt. % and 6 wt. %, between 0.5 wt. % and 4 wt. %, between 0.75 wt. % and 2.5 wt. %, and between 0.9 wt. % and 2 wt. %, including all subranges and endpoints therebetween.

As the barrier coating composition can be applied to one or more surfaces of a foam insulation layer, it is important that the coating is able to sufficiently wet and spread over the foam surface to achieve a uniform, consistent coating. To achieve sufficient wetting, the surface tension of the barrier coating composition needs to be tailored to the surface energy of the foam product. Namely, the barrier coating composition is particularly formulated to possess a surface tension no greater than 20 N/m above the surface energy of the foam product. By way of non-limiting example, the surface tension of the barrier coating composition can be no greater than 15 N/m, 10 N/m, 8 N/m, 5 N/m, 2.5 N/m, or 1 N/m above the surface energy of the foam product. In any of the exemplary embodiments, the barrier coating composition has a surface tension approximately (+/−5%) equal to the surface energy of the foam product. In any of the exemplary embodiments, the barrier coating has a surface tension that is equal to or less than the surface energy of the foam product.

The insulation layer can have a surface energy of approximately 35 mN/m to 55 mN/m. By way of non-limiting example, the surface energy of insulation layer can be approximately 37 mN/m to 53 mN/m, 39 mN/m to 51 mN/m, or 40 mN/m to 50 mN, including all endpoints and subranges therebetween.

In various aspects of the present disclosure, the barrier coating composition can have a surface tension that is equal to or less than the surface energy of the insulation layer. The surface tension of the barrier coating composition can be approximately 30 mN/m to 55 mN/m, including approximately 34 mN/m to 50 mN/m, 36 mN/m to 48 mN/m, and 38 mN/m to 46 mN, including all endpoints and subranges therebetween. In this or other aspects, the barrier coating composition can have a surface tension of no greater than 50 mN/m, no greater than 48 mN/m, no greater than 47 mN/m, and no greater than 46 mN/m.

In order to tailor the surface tension of the barrier coating composition, the coating can include one or more wetting agents, such as surfactants, oils, and the like. The surfactant(s) can include any one or more of ionic surfactants, non-ionic surfactants, cationic surfactants, amphoteric surfactants, and mixtures thereof. The term “amphoteric” surfactant is often used interchangeably with the term “zwitterionic” surfactant, i.e. each term has the identical meaning of surfactants having both cationic and anionic centers attached to the same molecule.

In accordance with the present disclosure, the one or more surfactants can comprise, or consist of, one or more anionic surfactants. Exemplary anionic surfactants include sulfates (e.g., alkyl sulfates, ammonium lauryl sulfate, sodium lauryl sulfate (SLS), alkyl ether sulfates, sodium laureth sulfate, and sodium myreth sulfate); sulfonates (e.g., dioctyl sodium sulfosuccinate, perfluorooctanesulfonate, perfluorobutanesulfonate, alkyl sulfonates, and alkyl benzene sulfonates); carboxylates (e.g., alkyl carboxylates, fatty acid salts (soaps)), sodium lauroyl sarcosinate, carboxylate fluorosurfactants, perfluoronanoate, and perfluorooctanoate); phosphates (e.g., alkyl aryl ether phosphate, alkyl ether phosphate, mono- and di-phosphate esters of nonyl phenol ethoxylate, phosphate esters of tridecyl alcohol ethoxylate, phosphate esters of isodecyl ethoxylate, and other phosphate esters of aromatic ethoxylates and aliphatic ethoxylates, phosphate esters of C10-C16 alkyl ethoxylates/propoxylates); salts of fluorinated fatty acids; silicones; stearates; and the like and mixtures thereof.

In accordance with the present disclosure, the one or more surfactants can comprise, or consist of, one or more cationic surfactants. Exemplary cationic surfactants include alkylamine salts such as laurylamine acetate; permanently charged quaternary ammonium cations (e.g., alkyltrimethylammonium salts, cetyl trimethylammonium bromide, cetyl trimethylammonium chloride, cetylpyridinium chloride, and benzethonium chloride); and quaternary ammonium salts (e.g., lauryl trimethyl ammonium chloride and alkyl benzyl dimethylammonium chloride), polyoxyethylenealkylamines, and the like and mixtures thereof.

In accordance with the present disclosure, the one or more surfactants comprise, or consist of, one or more amphoteric surfactants. Exemplary amphoteric surfactants include alkyl betaines, such as lauryl-betaine; alkylamidopropylbetaine (APB); cocamidopropyl betaine; alkylamidopropylamine N-oxide (APAO); alkyldimethylamine N-oxide (AO), cocoamphoacetate; cocoamphodiacetate; and the like and mixtures thereof.

In accordance with the present disclosure, the one or more surfactants comprise, or consist of, one or more nonionic surfactants. Suitable nonionic surfactants can include block copolymers based on polyethylene glycol and polypropylene glycol; polyethers (e.g., ethylene oxide and propylene oxide condensates, which include straight and branched chain alkyl and alkaryl polyethylene glycol and polypropylene glycol ethers and thioethers); alkyl polyglucosides (e.g., glycerol fatty acid esters, polyoxyethylene glycerol fatty acid esters, polyoxyethylene sorbitan fatty acid esters, polyethylene glycol fatty acid esters and polyoxyethylene polyoxypropylene block copolymers with terminal hydroxyl groups and combinations thereof); alkylphenoxypoly(ethyleneoxy) ethanols having alkyl groups containing from about 7 to about 18 carbon atoms and having from about 4 to about 240 ethyleneoxy units (e.g., heptylphenoxypoly(ethyleneoxy) ethanols, and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers.

Exemplary surfactants can include one or more of Dynol 607, which is a 2,5,8,11-tetramethyl-6-dodecyne-5,8-diol, SURFONYL® 420, SURFONYL® 440, and SURFONYL® 465, which are ethoxylated 2,4,7,9-tetramethyl-5-decyn-4,7-diol surfactants (commercially available from Evonik Corporation (Allentown, Pa.)), Stanfax (a sodium lauryl sulfate), Surfynol 465 (an ethoxylated 2,4,7,9-tetramethyl 5 decyn-4,7-diol), Triton™ GR-PG70 (1,4-bis(2-ethylhexyl) sodium sulfosuccinate), Triton™ CF-10 (poly(oxy-1,2-ethanediyl), alpha-(phenylmethyl)-omega-(1,1,3,3-tetramethylbutyl) phenoxy), Hydropalat® WE 3135, which is a Difunctional block copolymer surfactant terminating in primary hydroxyl groups, and Hydropalat® WE 3694, a nonionic wetting agent.

The wetting agent(s) can be present in the barrier coating composition in an amount from 0 to about 15% by weight, such as, for example, from about 0.001% to about 8% by weight, from about 0.005% by weight to about 7.5% by weight, from about 0.01% by weight to about 7% by weight, from about 0.05% by weight to about 6.5% by weight, from about 0.075% by weight to about 6% by weight, from about 0.09% by weight to about 5.5% by weight, from about 0.1% by weight to about 5% by weight, from about 0.15% to about 4% by weight, or from about 0.2% to 2.5% by weight, based on the total solids content in the barrier polymer material, including all subranges and endpoints therebetween.

Optionally, the barrier coating composition further comprises one or more film-forming additives. Film-forming additives can include, by way of example and not limitation, graphene, nanoclays, or inorganic layered particles. Suitable film-forming additives can include, by way of example and not limitation, cellulose nanocrystals (CNC), organosilane, perfluoroalkyl ethyl methacrylate (PPFEMA), ormocers, biowaxes/waxes, nanoclays/clays, silicon oxide (SiOₓ), aluminum oxide films (Al₂O₃), graphene/graphene oxide, molymbenum disulfide (MoS₂), tungsten disulfide (WS₂), niobium selenide (NbSe₂), hexagonal boron nitride (hBN), and combinations thereof. The film-forming additives aid the barrier coating composition in forming a continuous film on the surface of the insulation layer and can contribute to the barrier properties of the barrier coating. When included, the film-forming additives can be included in the barrier coating composition in an amount of from 0.1 wt. % to 50 wt. %, including from 0.5 wt. % to 25 wt. %, from 1 wt. % to 20 wt. %, or from 5 wt. % to 15 wt. % of the barrier coating composition based on a total amount of solids present in the composition.

Optionally, the barrier coating composition can include one or more fillers, such as platelet-type additives, such as graphene, nanoclay, inorganic layered particles, including mica, talc, and aluminum flake, or combinations thereof. In some exemplary embodiments, the one or more fillers can be included in at least 0.25 wt. % of the barrier coating composition, based on a total amount of solids present in the composition. The one or more fillers can be included in about 0.5 wt. % to about 50 wt. %, including about 1 wt. % to about 35 wt. %, about 5 wt. % to about 30 wt. % and about 10 wt. % to about 25 wt. % of the barrier coating composition based on a total amount of solids present in the composition, including any endpoints and subranges therebetween.

The barrier coating composition can optionally further comprise one or more other additives, such as UV absorbers/stabilizers, fire retardants, defoamers, pigments, oils, matting agents, etc. Exemplary UV absorbers/stabilizers may include, for example, benzotriazoles, polypropylene, antioxidants, hindered amine light stabilizers (HALS), and the like (e.g. BASF Tinuvin® 479-DW ECO, which is an aqueous preparation of a triazine-based UV absorber from BASF™, 2-[3(2H-benzotriazol-2-yl)-4-hydroxy phenyl]ethyl methacrylate from Sigma Aldrich®, Lowilite™ 26, which is a benzotriazole UV light absorber from SI Group™, liquid hydroxyphenyl-triazine (HPT), such as Omnistab® UV400, available from Partner in Chemicals; a HALS stabilizer based on amino ether functionality, such as Omnistab® LS123, available from Partner in Chemicals, and benzotriazole UV absorbers, such as Eversorb® 81 and Eversorb® 95, available from Everlight™ USA, Inc.). Exemplary fire retardants, can include, for example, halogenated materials, inorganic materials, nitrogen-based materials, intumescent materials, phosphorous materials, and the like (e.g., Tris(2-chloroethyl) phosphate, available from Sigma Aldrich®.) Exemplary defoamers may include, for example, silicone-based defoamers (including silicone emulsions, polysiloxane, and the like), paraffin-based defoamers, diols, oils, etc. (e.g., Foamstar® ST2410, which is a defoamer based on block copolymer, Foamstar® ED 2522 NC, which is an ultra-low SVOC silicone emulsion defoamer, Foamstar® ST 2210 NC, which is a specially modified alcohol and polysiloxane adduct (Old name: Dehydran® 1620), available from BASF™; BYK-035 9, which is a VOC-free mixture of paraffin based mineral oils and hydrophobic components, containing silicone, available from BYK; Surfadol® DF-75, 100% active nonionic defoaming agent based on acetylenic diols, Surfadol® 560 (silicone-containing defoamer), and Surfadol® 532 (acetylenic diol molecular defoamer), available from ACME Tech), and the like. Exemplary matting agents include, for example, silica-based materials and amorphous silica (such an amorphous micronized silica, Gasil® 23F, available from PQ Corporation). Other additives are contemplated and possible. The amounts of any such additives can vary depending on the particular embodiment and, in general, can be (collectively or individually) from 0 wt. % to 30 wt. %, including from 0.01 wt. % to 25 wt. %, from 0.02 wt. % to 22 wt. %, from 0.05 wt. % to 20 wt. %, from 0.1 wt. % to 18 wt. %, from 0.5 wt. % to 15 wt. %, from 1 wt. % to 12 wt. %, from 1.5 wt. % to 10 wt. %, from 2 wt. % to 8 wt. %, from 2.5 wt. % to 6 wt. %, or from 3 wt. % to 5 wt. %, based on the total solids content of the barrier coating composition, including any endpoints and subranges therebetween.

Table 10 provides exemplary barrier coating compositions. It should be appreciated that any compositional range from Exemplary Range A may be combined with one or more of the compositional ranges from Exemplary Range B and vice versa. The compositional ranges below are intended to encompass and include any and all endpoints and subranges within the disclosed range.

TABLE 10

| | Exemplary Range A | Exemplary Range B |
|---|---|---|
| | (in wt. % solids of total | (in wt. % solids of total |
| | barrier coating | barrier coating |
| | composition) | composition) |
| Barrier Polymer | 40-99.9 | 70-93 |
| Rheology Modifier | 0-20 | 0.5-12 |
| Wetting Agent | 0-15 | 0.01-7 |
| pH adjuster | 0-15 | 0.25-8 |
| Defoamer | 0-5 | 0.01-2 |
| Matting Agent | 0-5 | 0.01-2 |
| UV Stabilizer | 0-12 | 0.5-5 |
| Flame Retardant | 0-5 | 0.1-2 |

The barrier polymer, along with any additives, can be dispersed in water and/or solvent and blended to form the barrier coating composition. As described above, the barrier coating composition is applied to at least one major surface of the insulation layer and is dried to form a barrier coating on the surface. In some exemplary embodiments, the barrier coating is applied directly to a surface of the insulation layer, without the use of adhesives, primers, or other layers between the barrier coating and the surface of the insulation layer. Thus, in any of the embodiments disclosed herein, the insulation layer is free of any polyamide primer coating that is applied to the insulation layer prior to the barrier coating composition.

The barrier coating composition has a particular crystallinity, based on the crystallinity of the polymer used in the composition, although this crystallinity is impacted by the various additives included in the composition, such as wetting agents, rheology modifiers, and the like. Accordingly, a particular balance must be struck between achieving a coating composition with desirable viscosity and surface tension properties, while also ensuing the coating maintains sufficient crystallinity to provide a barrier functionality to keep the blowing agent from diffusing out of the foam product, or insulation layer.

Although not intending to be bound by theory, it is believed that the precise balance struck between the coating's overall crystallinity and its rheology and surface tension properties enables the application of the coating in a relatively low coat weight. Particularly, the barrier coating composition is applied at a coat weight of less than 250 g/m², including coat weights of no greater than 225 g/m², no greater than 200 g/m², no greater than 175 g/m², no greater than 150 g/m², no greater than 125 g/m², no greater than 100 g/m², no greater than 85 g/m², no greater than 60 g/m², no greater than 45 g/m², and no greater than 30 g/m². In an of the exemplary embodiments, the barrier coating composition can be applied to one or more surfaces of the polymer foam board in a coat weight between 3 g/m² and 225 g/m², including between 5 g/m² and 200 g/m², between 10 g/m² and 185 g/m², between 15 g/m² and 150 g/m², between 18 g/m² and 130 g/m², between 20 g/m² and 115 g/m², between 25 g/m² and 100 g/m², between 30 g/m² and 90 g/m², between 35 g/m² and 85 g/m², and between 40 g/m² and 80 g/m², including all endpoints and subranges therebetween.

Optionally, multiple coatings can be applied on one or more surface of the polymer insulation layer. Such additional coatings can be added, for example, to enhance the properties of the barrier coating or to protect the barrier coating. In some embodiments, the one or more additional coatings can impart hydrophobicity or water resistance to the coated insulation layer. It should be appreciated that the at least one additional coating can be formed by applying a coating composition to the surface and allowing the coating composition to dry, thereby forming the at least one additional coating. The coating composition can be, for example, a dispersion (e.g., aqueous or solvent-based), liquid, or the like.

As described above, the one or more additional coatings can be applied on top of the barrier coating, such that the barrier coating is positioned between the one or more additional coatings and the insulation layer. In other embodiments, the one or more additional coatings can be applied between the barrier coating and the surface of the polymer insulation layer. The one or more additional coatings are not particularly limited and can be the same as or different from the barrier coating. In some embodiments, the barrier coating is a first layer of a coating and the at least one additional coating is a second layer of the same coating. In some embodiments, the barrier coating comprises a first polymer comprising polyvinylidene dichloride (PVDC), polyvinyl alcohol, polyvinylidene fluoride (PVDF), polyvinyl chloride (PVC), ethylene vinyl alcohol, polyurethane, styrene butadiene (SBR), and combinations or copolymers thereof and the at least one additional coating comprises a different polymer comprising polyvinylidene dichloride (PVDC), polyvinyl alcohol, polyvinylidene fluoride (PVDF), polyvinyl chloride (PVC), ethylene vinyl alcohol, polyurethane, styrene butadiene (SBR), and combinations or copolymers thereof. In some embodiments, the at least one additional coating comprises one or more polyurethanes, epoxies, acrylics, or combinations thereof.

In such embodiments an additional coating layer is applied over the barrier coated insulation layer, the additional coating preferably has a surface tension that is particularly tailored to the surface energy of the barrier coated insulation layer. Accordingly, the one or more additional coatings are particularly formulated to possess a surface tension no greater than 20 mN/m above the surface energy of the barrier coated insulation layer, including no greater than 15 mN/m, no greater than 10 mN/m, no greater than 8 mN/m, no greater than 5 mN/m, no greater than 2.5 mN/m, and no greater that 1 mN/m above the surface energy of the barrier coated insulation layer. Similarly, if a coating layer is applied between the foam product and the barrier coating composition, the surface tension of barrier coating composition would need to be particularly formulated so as to be no greater than 20 mN/m, no greater than 15 mN/m, or no greater than 10 mN/m above the surface energy of the coated foam product.

Alternatively or additionally to the coating layer described herein, the barrier coating composition can be injected into the extruder, such as through a port, and incorporated directly into the foamable composition.

In any of the exemplary embodiments disclosed herein, the foamable composition can comprise any material capable of being foamed (“matrix material”), such as a foamable polymer (referred to herein as the “matrix polymer”), cellular glass, and the like. The matrix polymer can be thermoplastic or thermoset. The particular polymer composition can be selected to provide sufficient mechanical strength and/or to the process utilized to form final foamed polymer products. In addition, the matrix polymer is preferably chemically stable, that is, generally non-reactive, within the expected temperature range during formation and subsequent use in a polymer foam.

As used herein, the term “polymer” is generic to the terms “homopolymer,” “copolymer,” “terpolymer,” and combinations of homopolymers, copolymers, and/or terpolymers. Non-limiting examples of suitable foamable polymers for use as the matrix polymer herein include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyphenylene sulfide, acetal resins, polyamides, polyaramides, polyimides, polyacrylic acid esters, copolymers of ethylene and propylene, copolymers of styrene and butadiene, copolymers of vinyl acetate and ethylene, rubber modified polymers, thermoplastic polymer blends, and combinations thereof.

In some exemplary embodiments, the foamable matrix polymer is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material can include minor proportions of non-alkenyl aromatic polymers. The alkenyl aromatic polymer material can be formed of one or more alkenyl aromatic homopolymers, one or more alkenyl aromatic copolymers, a blend of one or more of each of alkenyl aromatic homopolymers and copolymers or blends thereof with a non-alkenyl aromatic polymer.

Examples of alkenyl aromatic polymers include, but are not limited to, those alkenyl aromatic polymers derived from alkenyl aromatic compounds such as styrene, alpha-methylstyrene, ethylstyrene, vinyl benzene, vinyl toluene, chlorostyrene, and bromostyrene. In at least one embodiment, the alkenyl aromatic polymer is polystyrene.

In some embodiments, minor amounts of monoethylenically unsaturated monomers such as C₂ to C₆ alkyl acids and esters, ionomeric derivatives, and C₂ to C₆ dienes can be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

In some embodiments, the matrix polymer can be formed substantially of (e.g., greater than 95% percent), and in certain exemplary embodiments, formed entirely of polystyrene. The matrix polymer can be present in the foamable polymer composition in an amount from about 60% to about 99% by weight, in an amount from about 60% to about 96% by weight, in an amount from about 70% to about 95% by weight, or in an amount from about 85% to about 94% by weight. In some embodiments, the matrix polymer can be present in an amount from about 90% to about 99% by weight. As used herein, the terms “% by weight” and “wt. %” are used interchangeably and are meant to indicate a percentage based on 100% of the total weight of the dry components.

As indicated above, the foam insulation layer is formed from a composition that contains a blowing agent composition. According to one aspect of the present invention, the blowing agent composition comprises one or more of: CO₂, fluorinated blowing agents, such as hydrofluorocarbons (HFCs), hydrochlorofluorocarbons, hydrofluoroethers, hydrofluoroolefins (HFOs), hydrochlorofluoroolefins (HCFOs), hydrobromofluoroolefins, hydrofluoroketones, hydrochloroolefins, and fluoroiodocarbons, alkyl esters, such as methyl formate, ethanol, water, hydrocarbons, or mixtures thereof. In other exemplary embodiments, the blowing agent comprises one or more of CO₂, ethanol, HFOs, HCFOs, HFCs, and mixtures thereof.

In any of the exemplary embodiments, the blowing agent composition can comprise a material having a low global warming potential (“GWP”), such as a fluorinated alkene, including, for example, hydrofluoroolefins (HFOs) and hydrochlorofluoroolefins (HCFOs). The hydrofluoroolefin blowing agent in the blowing agent composition of the present invention can include, for example, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluoro-1-butene; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336mzz); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-1-butene; 3,3-difluoro-1-butene; 3,4,4-trifluoro-1-butene; 2,3,3-trifluoro-1-butene; 1, 1,3,3-tetrafluoro-1-butene; 1,4,4,4-tetrafluoro-1-butene; 3,3,4,4-tetrafluoro-1-butene; 4,4-difluoro-1-butene; 1,1,1-trifluoro-2-butene; 2,4,4,4-tetrafluoro-1-butene; 1,1,1,2-tetrafluoro-2 butene; 1,1,4,4,4-pentafluoro-1-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. It should be appreciated that any of the above molecules may be present as the cis isomer, trans isomer, or a blend thereof. In some exemplary embodiments, the blowing agent or co-blowing agents include cis and/or trans HFO-1234ze and/or cis and/or trans HFO-1336mzz.

In some exemplary embodiments, the fluorinated alkene blowing agent includes, for example, 1,1,1,4,4,4-hexafluoro-2-butene (HFO-1336mzz) (including cis (HFO-1336mzz-Z) and/or trans (HFO-1336mzz-E) isomers thereof); and (cis and/or trans)-1,3,3,3-tetrafluoropropene (HFO-1234ze), particularly the trans isomer. HFO-1336mzz-Z has a GWP of 2 and an ozone depletion potential (ODP) of zero. HFO-1336mzz-Z is commercially available under the tradename Opteon™ 1100. Similarly, HFO-1234ze has a GWP of less than 1 and an ODP of zero. In some exemplary embodiments, the low GWP fluorinated alkene has a GWP of less than 50, such as less than 30, less than 25, less than 15, less than 10, less than 5, less than 2.5, or less than 1. In any of the exemplary embodiments, the blowing agent can comprise HFO-1336mzz-Z and is substantially free of additional fluorinated alkenes. In other embodiments, the blowing agent can comprise a blend of HFO-1336mzz and HFO-1234ze.

When present, the fluorinated alkene(s) can be present in the blowing agent composition in at least 0.5 wt. %, including at least 1 wt. %, at least 2 wt. %, at least 3 wt. %, 5 wt. %, at least 7 wt. %, at least 10 wt. %, at least 12 wt. %, at least 15 wt. %, at least 18 wt. %, at least 20 wt. %, at least 23 wt. %, at least 25 wt. %, at least 27 wt. %, and at least 30 wt. %, based on the weight of the blowing agent composition. In any of the exemplary embodiments, the fluorinated alkene is present in the blowing agent composition in an amount no greater than 98%, including amounts no greater than 95 wt. %, no greater than 90 wt. %, no greater than 85 wt. %, no greater than 80 wt. %, no greater than 75 wt. %, no greater than 70 wt. %, no greater than 65 wt. %, no greater than 60 wt. %, no greater than 55 wt. %, no greater than 52 wt. %, no greater than 50 wt. %, no greater than 47 wt. %, no greater than 45 wt. %, no greater than 42 wt. %, no greater than 40 wt. %, no greater than 37 wt. %, no greater than 35 wt. %, no greater than 32 wt. %, no greater than 30 wt. %, and no greater than 25 wt. %. In any of the exemplary embodiments, the fluorinated alkene can be present in the blowing agent composition in an amount between 0.5 wt. % and 98 wt. %, including, for example, between 2 wt. % and 85 wt. %, between 3 wt. % and 75 wt. %, between 5 wt. % and 55 wt. %, between 10 wt. % and 50 wt. %, between 12 wt. % and 45 wt. %, and between 15 wt. % and 40 wt. %, including all endpoints and subranges therebetween.

The amount of fluorinated alkene can alternatively be characterized by the amount present in the foamable polymer composition. Thus, when characterized in this way, the fluorinated alkene can be present in the foamable polymer composition in at least 0.1 wt. %, including at least 0.2 wt. %, at least 0.5 wt. %, at least 0.7 wt. %, at least 1.0 wt. %, at least 1.2 wt. %, at least 1.5 wt. %, at least 2.0 wt. %, at least 2.3 wt. %, at least 2.5 wt. %, at least 2.7 wt. %, at least 3.0 wt. %, at least 3.5 wt. %, at least 3.7 wt. %, at least 3.9 wt. %, and at least 4.0 wt. %. In any of the exemplary embodiments, the fluorinated alkene can be present in the foamable polymer composition in an amount no greater than 10.0 wt. %, including amounts no greater than 8.0 wt. %, no greater than 6.0 wt. %, no greater than 4.5 wt. %, no greater than 4.0 wt. %, no greater than 3.8 wt. %, no greater than 3.5 wt. %, no greater than 3 wt. %, no greater than 2.5 wt. %, no greater than 2.3 wt. %, no greater than 2 wt. %, no greater than 1.8 wt. %, no greater than 1.5 wt. %, no greater than 1.2 wt. %, no greater than 1.0 wt. %, no greater than 0.8 wt. %, and no greater than 0.6 wt. %. In any of the aspects disclosed herein, the fluorinated alkene may be present in the foamable polymer composition in an amount between 0.5 wt. % and 7 wt. %, including, for example, between 0.8 wt. % and 6 wt. %, between 1 wt. % and 4.8 wt. %, between 1.2 wt. % and 4.5 wt. %, between 1.4 wt. % and 4.2 wt. %, between 1.8 wt. % and 4 wt. %, and between 2 wt. % and 3.8 wt. % including all endpoints and subranges therebetween.

According to any aspect of the disclosure, the fluorinated alkene may be present as a blend of two or more fluorinated alkenes. For instance, the fluorinated alkene may comprise a blend of a first fluorinated alkene and a second fluorinated alkene, with the weight ratio of first alkene to second alkene being from 1:99 to 99:1, including, for example, from 5:95 to 95:5, from 8:92 to 92:8, from 10:90 to 90:10, from 15:85 to 85:15, from 20:80 to 80:20, from 25:75 to 75:25, from 35:65 to 65:35, from 40:60 to 60:40, and from 45:55 to 55:45. According to any aspect, the first fluorinate alkene may be present in the blowing agent composition in an amount between 5 and 60 wt. %, including, for example, between 8 and 55 wt. %, between 10 and 50 wt. %, between 12 and 45 wt. %, between 15 wt. % and 40 wt. %, between 18 wt. % and 38 wt. %, and between 20 wt. % and 35 wt. %, including all endpoints and subranges therebetween. In these or other aspects, the second fluorinated alkene may be present in the blowing agent composition in an amount between 0.5 and 50 wt. %, including, for example, between 1 and 45 wt. %, between 3 and 40 wt. %, between 5 and 35 wt. %, between 5.5 wt. % and 30 wt. %, between 8 wt. % and 28 wt. %, and between 10 wt. % and 25 wt. %, including all endpoints and subranges therebetween. The first fluorinated alkene can comprise a C4-C6 fluorinated alkene having a molecular weight of at least 150 g/mol. An exemplary first fluorinated alkene includes 1,1,1,4,4,4-hexafluoro-2-butene (HFO-1336mzz) (including cis (HFO-1336mzz-Z) and/or trans (HFO-1336mzz-E) isomers thereof). The second fluorinated alkene can comprise a C2-C3 fluorinated alkene having a molecular weight less than 150 g/mol. An exemplary second fluorinated alkene includes 1,3,3,3-tetrafluoropropene (HFO-1234ze) (including cis (HFO-1234ze-Z) and/or trans (HFO-1234ze-E) isomers thereof).

The amount of fluorinated alkene can alternatively be characterized by the molar amount per 100 grams of the of the matrix polymer. Thus, when characterized in this way the fluorinated alkene can be present in the foamable polymer composition in an amount less than 0.1 moles per 100 grams of the of the matrix polymer, including no greater than 0.05 moles, no greater than 0.03 moles, no greater than 0.02 moles, no greater than 0.018 moles, and no greater than 0.01 moles. In any of the exemplary embodiments, the fluorinated alkene can be present in foamable polymer composition in an amount between 0.0005 moles and less than 0.1 moles per 100 grams of the of the matrix polymer, including between 0.001 moles and 0.025 moles, between 0.005 moles and 0.02 moles, and between 0.01 moles and 0.015 moles per 100 grams of the of the matrix polymer, including all endpoints and subranges therebetween. It has been surprisingly discovered that by including a ratio of first alkene to second alkene of at least 50:50, a reduced amount of total fluoroalkene moles in the matrix polymer may be achieved, while still producing an insulation foam with sufficient mechanical and thermal performance. In such aspects, the total amount of fluoroalkene moles is less than 0.027 moles, or less than 0.025 moles, or less than 0.02 moles per 100 grams of the matrix polymer.

The blowing agent composition can optionally include one or more blowing agents or co-blowing agents, such as hydrocarbons, hydrofluorocarbons (“HFC”), hydrochlorofluorocarbons (“HCFO”), carbon dioxide, methyl formate, methylal, and water. When present, the co-blowing agents can be included in the blowing agent composition in at least 0.5 wt. %, including at least 1 wt. %, at least 2 wt. %, at least 3 wt. %, 5 wt. %, at least 7 wt. %, at least 10 wt. %, at least 12 wt. %, at least 15 wt. %, at least 18 wt. %, at least 20 wt. %, at least 23 wt. %, at least 25 wt. %, at least 27 wt. %, and at least 30 wt. %. In any of the exemplary embodiments, the fluorinated alkene is present in the blowing agent composition in an amount no greater than 98%, including amounts no greater than 95 wt. %, no greater than 90 wt. %, no greater than 85 wt. %, no greater than 80 wt. %, no greater than 75 wt. %, no greater than 70 wt. %, no greater than 65 wt. %, no greater than 60 wt. %, no greater than 55 wt. %, no greater than 52 wt. %, no greater than 50 wt. %, no greater than 47 wt. %, no greater than 45 wt. %, no greater than 42 wt. %, no greater than 40 wt. %, no greater than 37 wt. %, no greater than 35 wt. %, no greater than 32 wt. %, no greater than 30 wt. %, and no greater than 25 wt. %. In any of the exemplary embodiments, the co-blowing agent(s) can be present in the blowing agent composition in an amount between 5 wt. % and 98 wt. %, including, for example, between 5 wt. % and 85 wt. %, between 10 wt. % and 80 wt. %, between 15 wt. % and 75 wt. %, between 20 wt. % and 55 wt. %, between 10 wt. % and 50 wt. %, between 12 wt. % and 45 wt. %, between 15 wt. % and 40 wt. %, between 30 wt. % and 68 wt. %, and between 35 wt. % and 65 wt. %, including all endpoints and subranges therebetween.

As mentioned above, the blowing agent can comprise one or more hydrocarbons. Suitable hydrocarbons include, but are not limited to, C1 to C6 aliphatic hydrocarbons, such as methane, ethane, propane, n-butane, isobutane, and neopentane, and C1 to C3 aliphatic alcohols, such as methanol, ethanol, n-propanol, and isopropanol.

The blowing agent can optionally comprise one or more hydrofluorocarbons. The specific hydrofluorocarbon utilized is not particularly limited. A non-exhaustive list of examples of suitable blowing HFC blowing agents include 1,1-difluoroethane (HFC-152a), 1,1,1,2-tetrafluoroethane (HFC-134a), 1,1,2,2-tetrafluoroethane (HFC-134), 1,1,1-trifluoroethane (HFC-143a), difluoromethane (HFC-32), 1,3,3,3-pentafluoropropane (HFC-1234ze), pentafluoro-ethane (HFC-125), fluoroethane (HFC-161), 1,1,2,2,3,3-hexafluoropropane (HFC-236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof. In some exemplary embodiments, the blowing agent comprises HFC-152a. Exemplary HFC blowing agents or blends thereof are commercially available under the tradename FORMACEL™, including but not limited to FORMACEL™ B and FORMACEL™ 76.

Exemplary blowing agent compositions comprise 15 wt. % to 60 wt. % of a fluorinated alkene selected from HFO-1336mzz, HFO-1234ze, or mixtures thereof, 40 wt. % to 85 wt. % of HFC-152a, and optionally a balance of carbon dioxide, based on the total weight of the blowing agent composition, including all endpoints and subranges therebetween. Stated differently, the exemplary blowing agent compositions can comprise 2.0 wt. % to 5.0 wt. % HFO-1336mzz and/or HFO-1234ze, 2.5 wt. % to 6.0 wt. % HFC-152a, and optionally a balance of carbon dioxide, based on the total weight of the foamable polymer composition, including compositions comprising 2.5 wt. % to 4.8 wt. % HFO-1336mzz and/or HFO-1234ze, 3.0 wt. % to 5.5 wt. % HFC-152a, and optionally carbon dioxide, based on the total weight of the foamable polymer composition. Further exemplary blowing agent compositions can comprise 3.0 wt. % to 4.5 wt. % HFO-1234ze and/or HFO-1336mzz, 2.8 wt. % to 5.0 wt. % HFC-152a, and optionally carbon dioxide, based on the total weight of the foamable polymer composition, including compositions comprising 3.2 wt. % to 4.2 wt. % HFO-1234ze and/or HFO-1336mzz, 3.0 wt. % to 4.8 wt. % HFC-152a, and optionally carbon dioxide, based on the total weight of the foamable polymer composition.

The blowing agent can also comprise one or more hydrochlorofluoroolefins (HCFO), such as HCFO-1233; 1-chloro-1,2,2,2-tetrafluoroethane (HCFC-124); 1,1-dichloro-1-fluoroethane (HCFC-141b); 1, 1, 1, 2-tetrafluoroethane (HFC-134a); 1,1,2,2-tetrafluoroethane (HFC-134); 1-chloro-1,1-difluoroethane (HCFC-142b); 1,1,1,3,3-pentafluorobutane (HFC-365mfc); 1,1,1,2,3,3,3-heptafluoropropane (HFC-227ea); tnchlorofluoromethane (CFC-11); dichlorodifluoromethane (CFC-12); and dichlorofluoromethane (HCFC-22).

The term “HCFO-1233” is used herein to refer to all trifluoromonochloropropenes. Among the trifluoromonochloropropenes are included both cis- and trans-1,1,1-trifluo-3,chlororopropene (HCFO-1233zd or 1233zd). The term “HCFO-1233zd” or “1233zd” is used herein generically to refer to 1,1,1-trifluo-3-chloro-propene, independent of whether it is the cis- or trans-form. The terms “cis HCFO-1233zd” and “trans HCFO-1233zd” are used herein to describe the cis- and trans-forms or trans-isomer of 1,1,1-trifluo,3-chlororopropene, respectively.

In some exemplary embodiments, the blowing agent composition includes two or more blowing agents, such as a hydrocarbon and carbon dioxide. In other exemplary embodiments, the blowing agent formulation can be free of carbon dioxide and/or water. In various exemplary embodiments, the blowing agent composition is free of a hydrofluorocarbon.

In any of the exemplary embodiments, the blowing agent can comprise or consist of CO₂. Optionally, the CO₂ blowing agent can include one or more co-blowing agents (e.g., a hydrocarbon, an HFO, and/or HFC) and, optionally, one or more solubilizers (e.g., methyl formate, methylal, ethanol, isobutane, propylene carbonate, etc.). The CO₂ can be present in an amount of 25 wt. % or more, 50 wt. % or more, 55 wt. % or more, 60 wt. % or more, 65 wt. % or more, 70 wt. % or more, 75 wt. % or more, 80 wt. % or more, 85 wt. % or more, 90 wt. % or more, 92 wt. % or more, 95 wt. % or more, 96 wt. % or more, or even 98 wt. % or more based on a total weight of the blowing agent composition.

When present, solubilizers, such as methyl formate, methylal, ethanol, isobutane, propylene carbonate, etc., can be included in the foamable polymer composition in amounts up to 5 wt. %, based on the total weight of the foamable polymer composition, including in amounts between 0.1 wt. % and 4.5 wt. %, 0.25 wt. % and 4 wt. %, 0.5 wt. % and 3.5 wt. %, between 0.75 and 3.25 wt. %, 1 and 3 wt. %, 1.25 and 2.5 wt. %, and 1.3 and 2 wt. %, based on the total weight of the foamable polymer composition.

Exemplary blowing agent compositions comprise 0 to 80 wt. % of a fluorinated alkene selected from HFO-1336mzz, HFO-1234ze, or mixtures thereof, and 20 wt. % to 100 wt. % of carbon dioxide, based on the total weight of the blowing agent composition, including all endpoints and subranges therebetween. For example, the blowing agent composition may comprise 0 to 60 wt. % of a fluorinated alkene selected from HFO-1336mzz, HFO-1234ze, or mixtures thereof, and 40 wt. % to 100 wt. % of carbon dioxide, based on the total weight of the blowing agent composition, including all endpoints and subranges therebetween. Stated differently, the exemplary blowing agent compositions can comprise 0 to 4 wt. % of a fluorinated alkene and 2.5 wt. % to 7 wt. % carbon dioxide, based on the total weight of the foamable polymer composition, including compositions comprising no greater than 3 wt. % of a fluorinated alkene and at least 2 wt. % carbon dioxide, based on the total weight of the foamable polymer composition. Further exemplary blowing agent compositions can comprise 0.2 to 2 wt. % of a fluorinated alkene and 2.5 wt. % to 6 wt. % carbon dioxide, based on the total weight of the foamable polymer composition.

Exemplary blowing agent compositions can comprise 1 to 5 wt. % carbon dioxide and 0.2 to 3.5 wt. % of one or more solubilizer, such as methyl formate, methylal, ethanol, isobutane, propylene carbonate, etc., based on the total weight of the foamable polymer composition, including compositions comprising 1.8 to 4 wt. % carbon dioxide and 0.7 to 2.5 wt. % of one or more solubilizer, and compositions comprising 2 to 3.6 wt. % carbon dioxide and 0.9 to 2 wt. % of one or more solubilizer, based on the total weight of the foamable polymer composition. Further exemplary blowing agent compositions can comprise 2.5 to 3.5 wt. % of a carbon dioxide and 1 to 1.7 wt. % methyl formate (or other suitable solubilizer), based on the total weight of the foamable polymer composition. In these or other embodiments, the blowing agent compositions can include a limited amount of fluorinated alkene, such as no greater than 3 wt. %, based on the total weight of the foamable polymer composition, including amounts between 0 and 2.8 wt. %, between 0.2 and 2.6 wt. %, between 0.5 and 2.4 wt. %, between 0.8 and 2.1 wt. %, between 1 and 1.8 wt. %, between 1.2 and 1.6 wt. %, including all endpoints and subranges therebetween.

Further exemplary blowing agent compositions can include 50 wt. % to 100 wt. % CO₂ and 0 wt. % to 50 wt. % of one or more hydrocarbons, such as isobutane, 60 wt. % to 99 wt. % CO₂ and 1 wt. % to 40 wt. % of one or more hydrocarbons, 70 wt. % to 98 wt. % CO₂ and 2 wt. % to 30 wt. % of one or more hydrocarbons, and 80 wt. % to 96 wt. % CO₂ and 3 wt. % to 12 wt. % of one or more hydrocarbons, including all endpoints and subranges therebetween.

When characterizing the blowing agent by its weight percent present in the foamable polymer composition, the blowing agent composition is present in at least 2 wt. %, including at least 2.8 wt. %, at least 3 wt. %, at least 3.3 wt. %, at least 3.5 wt. %, at least 3.8 wt. %, at least 4 wt. %, at least 4.3 wt. %, at least 4.5 wt. %, at least 4.7 wt. %, at least 5 wt. %, at least 5.5 wt. %, at least 6 wt. %, at least 6.5 wt. %, and at least 7.0 wt. %. In any of the exemplary embodiments, the blowing agent can be present in the foamable polymer composition in an amount no greater than 10 wt. %, including amounts no greater than 9 wt. %, no greater than 8.5 wt. %, no greater than 8 wt. %, no greater than 7.8 wt. %, no greater than 7.5 wt. %, no greater than 7.2 wt. %, no greater than 7 wt. %, no greater than 6.9 wt. %, no greater than 6.8 wt. %, no greater than 6.65 wt. %, no greater than 6.5 wt. %, no greater than 6 wt. %, no greater than 5.8 wt. %, no greater than 5.5 wt. %, no greater than 5 wt. %, no greater than 4.9 wt. %, and no greater than 4.8 wt. %. In any of the aspects contemplated herein, the blowing agent composition can be present in the foamable composition in an amount between 2 wt. % and 8 wt. %, including between 2.5 wt. % and 7.0 wt. %, between 2.7 wt. % and 6.5 wt. %, between 2.9 wt. % and 6 wt. %, and between 3 wt. % and 5.5 wt. %.

The amount of blowing agent can alternatively be characterized by the molar amount of blowing agent composition per 100 grams of the of the polymer composition. Thus, when characterized in this way the blowing agent composition can be present in the foamable polymer composition in an amount between 0.001 moles and less than 0.1 moles per 100 grams of the of the polymer, including between 0.01 moles and 0.09 moles, between 0.03 moles and 0.08 moles, and between 0.04 moles and 0.075 moles per 100 grams of the of the polymer composition.

In some embodiments in which the barrier coating composition is injected into the screw feeder or otherwise incorporated into the foamable polymer mixture, it should be appreciated that water included in the barrier coating composition adds to the amount and, thus, the blowing power, of the blowing agent.

It has been surprisingly discovered that the use of a relatively low application weight of the barrier coating composition as described herein can yield an insulation product with better and more sustained thermal insulation performance, as compared to an otherwise identical foam product without the barrier coating. For instance, conventional polymer insulation products with low GWP blowing agents generally achieve thermal insulation R-values of no greater than 5 per inch.

Optional additives such as infrared attenuating agents, processing aids, nucleating agents, plasticizing agents, pigments, elastomers, extrusion aids, antioxidants, fillers, antistatic agents, biocides, termite-ocide, surfactants, colorants, oils, waxes, flame retardant synergists, and/or UV absorbers/stabilizers can be incorporated into the foamable composition. These optional additives can be included in amounts necessary to obtain desired characteristics of the foamable gel or resultant extruded foam products. The additives can be added to the foamable composition or they can be incorporated in the foamable composition before, during, or after the polymerization process used to make the polymer.

As mentioned above, the foamable composition can further contain at least one infrared attenuating agent (IAA) to increase the R-value of the resulting foam product. Non-limiting examples of suitable infrared attenuating agents for use in the present composition include graphite, including nanographite, carbon black, powdered amorphous carbon, asphalt, granulated asphalt, milled glass, talc, fiber glass strands, mica, black iron oxide, metal flakes (for example, aluminum flakes), carbon nanotube, nanographene platelets, carbon nanofiber, activated carbon, titanium dioxide, and combinations thereof. In some exemplary embodiments, the infrared attenuating agent is present in the foamable composition in an amount from 0 to 5.0% by weight of the total composition. In other embodiments, the infrared attenuating agent can be present in an amount from 0.05 to 3.0% by weight, from 0.08 to 2.0% by weight, or from 0.1 to 1.0% by weight. In some exemplary embodiments, the infrared attenuating agent is present in the composition in an amount less than or equal to 0.5% by weight.

In at least one exemplary embodiment, the infrared attenuating agent is nanographite. The nanographite can be multi-layered by furnace high temperature expansion from acid-treated natural graphite or microwave heating expansion from moisture saturated natural graphite. In addition, the nanographite can be a multi-layered nanographite which has at least one dimension with a thickness less than 100 nm. In some exemplary embodiments, the graphite can be mechanically treated such as by air jet milling to pulverize the nanographite particles. The pulverization of the particles ensures that the nanographite flake and other dimensions of the particles are less than 150 microns.

The nanographite may or may not be chemically or surface modified and can be compounded in a polyethylene methyl acrylate copolymer (EMA), which is used both as a medium and a carrier for the nanographite. Other possible carriers for the nanographite include polymer carriers such as, but not limited to, polymethyl methacrylate (PMMA), polystyrene, polyvinyl alcohol (PVOH), and polyvinyl acetate (PVA). In exemplary embodiments, the nanographite is substantially evenly distributed throughout the foam. As used herein, the phrase “substantially evenly distributed” is meant to indicate that the substance (for example, nanographite) is evenly distributed or nearly evenly distributed within the foam.

Although the infrared attenuating agent increases the R-value for foams that include HFO and/or HFC blowing agents, the addition of infrared attenuating agents also tends to decrease the cell size of the cells in the foam, which results in undesirable final foamed products. In particular, small cell sizes tend to increase board bulk density, increase product cost, and reduce the process window during the extrusion process. However, it has been surprisingly discovered that the amount of infrared attenuating agent included in the foamable composition can be reduced, or eliminated when barrier coating compositions are applied to or within the polymer foam. Accordingly, in any of the exemplary embodiments, the foamable polymer composition and resulting foam product include less than 0.25 wt. % of an infrared attenuating agent, such as graphite, including less than 0.2 wt. %, less than 0.15 wt. %, less than 0.10 wt. %, and less than 0.05 wt. %. In any of the exemplary embodiments, the foamable composition and resulting foam product are free of an infrared attenuating agent, such as graphite. It should be appreciated that such embodiments, a nucleator (e.g., inorganic substances such as talc, clay, and/or calcium carbonate) can be included in the foamable composition to control the size of the foam cells.

The foamable composition can further contain a fire retarding agent in an amount up to 5.0% or more by weight. For example, fire retardant chemicals can be added in the extruded foam manufacturing process to impart fire retardant characteristics to the extruded foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, halogenated polymer flame retardant such as brominated polymer flame retardant, phosphoric compounds, and combinations thereof.

Once the blowing agent composition, barrier coating composition, and optional additional additives have been introduced into the foamable polymer composition, the resulting mixture is subjected to some additional blending sufficient to distribute each of the additives generally uniformly throughout the polymer composition to obtain an extrusion or expandable composition.

The foamable polymer composition disclosed herein can produce a rigid, foamed polymer insulation layer via any manufacturing process, such as extrusion, expansion, reaction mixture, spray, bubbling, and the like. Such foam products have a cellular structure with cells defined by cell membranes and struts. Struts are formed at the intersection of the cell membranes, with the cell membranes covering interconnecting cellular windows between the struts.

In some exemplary embodiments, the polymer insulation layer has an average density of less than 10 pcf (pound per cubic foot), including less than 5 pcf, less than 3 pcf, and less than 2.5 pcf when produced at atmospheric conditions. However, the density can be less when the polymer insulation layer is produced under vacuum. In any of the exemplary embodiments, the polymer insulation layer has a density of 2.40 pcf or less, or 2.25 pcf or less, or 2.20 pcf or less, or 2.00 pcf or less, or 1.60 pcf or less. In any of the exemplary embodiments, the polymer insulation layer has an average density between 1.40 pcf and 2.40 pcf, including between 1.40 pcf and 2.25 pcf, between 1.40 pcf and 2.00 pcf, between 1.40 pcf and 1.60 pcf, between 1.45 pcf and 1.55 pcf, between 2.10 pcf and 2.30 pcf, and between 2.20 pcf and 2.28 pcf.

It is to be appreciated that the phrase “substantially closed cell” is meant to indicate that all or nearly all of the cells in the cellular structure of the insulation layer are closed. For example, “substantially closed cell” can be meant to indicate that not more than 30.0% of the cells are open cells, and particularly, not more than 10.0%, or more than 5.0% are open cells, or otherwise “non-closed” cells. The closed cell structure helps to increase the R-value of a formed, foamed insulation layer. It is to be appreciated, however, that it is within the purview of various embodiments to produce an open cell structure, although such an open cell structure is not an exemplary embodiment.

The average cell size of the polymer insulation layer can range from 0.005 mm (5 microns) to 0.6 mm (600 microns) and, in some exemplary embodiments, from 0.05 mm (50 microns) to 0.4 mm (400 microns), or from 0.1 mm (100 microns) to 0.2 mm (200 microns).

Once coated with the subject barrier coating composition, the coated insulation layer disclosed herein demonstrates insulation values (R-values) of greater than 5 per inch and maintains an R-value of at least 5 per inch after 180 days. In any of the exemplary embodiments, the coated insulation layer can have an R-value per inch after 180 days of at least 5.2, or at least 5.3 or at least 5.5, or at least 5.7, at least 6, or at least 6.5, or at least 7. In any of the exemplary embodiments, the R-value per inch can be at least 5, or at least 5.5, or at least 6, or at least 6.5, or at least 7, after 7 days, 25 days, 60 days, or after 180 days. Accordingly, in some embodiments, the insulation layer can comprise an R-value of 5 to greater than 7.0 or 8.0 per inch.

The foamable composition additionally can produce foam products that have a high compressive strength, which defines the capacity of a foam material to withstand axially directed pushing forces. In some exemplary embodiments, the foam have a compressive strength within the range of between about 6 and 120 psi. In some exemplary embodiments, the foam product has a compressive strength between 10 and 110 psi, including between 20 and 100 psi, between 30 and 80 psi, and between 35 and 60 psi. In various exemplary embodiments, the foam product has a compressive strength between 40 and 50 psi.

The insulation layer contemplated herein can be used to form a variety of products, such as a rigid insulation board, insulation foam, packaging product, building insulation (e.g., residential, commercial, industrial building(s)), underground insulation (for example, highway, airport runway, railway, and underground utility insulation), and the like. The insulation layer can further be utilized in multi-material sheathing systems. The sheathing system (e.g., sheathing system 400, 500) can include one or more panels capable of being attached to a frame of a structure to form a sheath that envelops at least a portion of a structure as a wall portion (e.g., vertical surface) and/or as a roofing portion. The panels can comprise any combination of one or more structural portion(s), one or more barrier layer(s), and one or more insulation panels. The structural portion can comprise a single-layer material or a multiple-layer construction. For example, the structural portion of the panel can comprise a variety of different materials, such as fiberglass, wood, wood composite materials (i.e., oriented strand board (“OSB”)), magnesium oxide board, a plywood layer, a foil poly structural layer, a high-density polyethylene (HDPE) layer, a polymer-based composite, or any other structural layer. In some embodiments, the structural portion is a structural barrier layer comprising fiberglass, polycarbonate, polypropylene, high-density polyethylene, or wood composite. The insulation layer can comprise or consist of the subject insulation foam product disclosed herein. In any of the exemplary embodiments, the sheathing system can comprise an insulation layer adhered to a structural portion, or a barrier layer adhered to a first surface of an insulation layer and a structural portion adhered to a second surface of the insulation layer.

### EXAMPLES

The inventive aspects of the present disclosure have been described above both generically and with regard to various exemplary embodiments. Although the general aspects have been set forth in what is believed to be exemplary illustrative embodiments, a wide variety of alternatives known to those of skill in the art can be selected within the disclosure. Additionally, the following data and examples related to embodiments described herein are meant to better illustrate the present invention and are not intended to limit the general aspects thereof.

### Example 1

Extruded polystyrene foam samples were prepared using a co-rotating twin screw extrusion foam line. Polystyrene was melted in the extruder and mixed with an injected blowing agent composition to form a homogeneous foamable composition. The foamable composition for Comparative Samples B-E and Samples A-D (excluding the blowing agent) included polystyrene and flame retardant masterbatch. The foamable composition for Comparative Samples A and F and Samples F and G (excluding the blowing agent) included 100 wt. % polystyrene, flame retardant masterbatch, and graphite masterbatch. A blowing agent blend was included at a constant total amount across all samples. The blowing agent blend included a 30-40 wt. % of a fluorinated alkene and 60-70 wt. % of a fluorinated alkane, with the remainder of the blowing agent blend being CO₂. As the amount of fluorinated alkene was reduced, the amount of CO₂ was increased to maintain a constant level of total blowing agent. The foamable compositions were then extruded to produce 1-inch XPS foam samples, each having a density of about 1.83 pcf.

For coated samples, a barrier coating composition comprising PVOH (an aqeuous dispersion of polyvinyl alcohol) was applied. Properties of each of the samples are provided in Table 11.

TABLE 11

| | Fluorinated | | | | | |
|---|---|---|---|---|---|---|
| Sample | Alkene | | Coating | Final Coat | 180-days k-value | 180-days |
| No. | (wt. %) | IAA | Composition | Weight (g) | (BTU · in/h · ft² · ° F.) | R/in |
| Comp. | 3.0 | Yes | None | — | 0.2009 | 4.98 |
| Ex. A | | | | | | |
| Comp. | 3.0 | No | None | — | 0.2111 | 4.79 |
| Ex. B | | | | | | |
| Comp. | 2.5 | No | None | — | 0.2175 | 4.67 |
| Ex. C | | | | | | |
| Comp. | 2.0 | No | None | — | 0.2210 | 4.56 |
| Ex. D | | | | | | |
| Comp. | 1.5 | No | None | — | 0.2262 | 4.45 |
| Ex. E | | | | | | |
| Ex. A | 3.0 | No | Yes | 15.50 | 0.1833 | 5.52 |
| | | | | (71.50 g/m²) | | |
| Ex. B | 2.5 | No | Yes | 14.49 | 0.1827 | 5.55 |
| | | | | (66.84 g/m²) | | |
| Ex. C | 2.0 | No | Yes | 14.24 | 0.1911 | 5.28 |
| | | | | (65.69 g/m²) | | |
| Ex. D | 1.5 | No | Yes | 13.90 | 0.2019 | 4.95 |
| | | | | (64.12 g/m²) | | |
| Comp. | 1.5 | Yes | No | — | 0.2163 | 4.67 |
| Ex. F | | | | | | |
| Ex. F | 3.0 | Yes | Yes | 11.79 | 0.1755 | 5.78 |
| | | | | (54.39 g/m²) | | |
| Ex. G | 1.5 | Yes | Yes | 13.74 | 0.1868 | 5.45 |
| | | | | (63.38 g/m²) | | |

As shown in Table 11, reducing the concentration of fluorinated alkene from 3 wt. % to 1.5 wt. % in uncoated foam samples increases the 180-day k-value from 0.2009 to 0.2247 BTU·in/h·ft²·° F., and decreases the sample's R-value to below 4.5. However, when the foam samples were coated with the barrier coating composition, the samples were able to achieve an insulation value of R-5 even as the concentration of fluorinated alkene dropped below 2 wt. %.

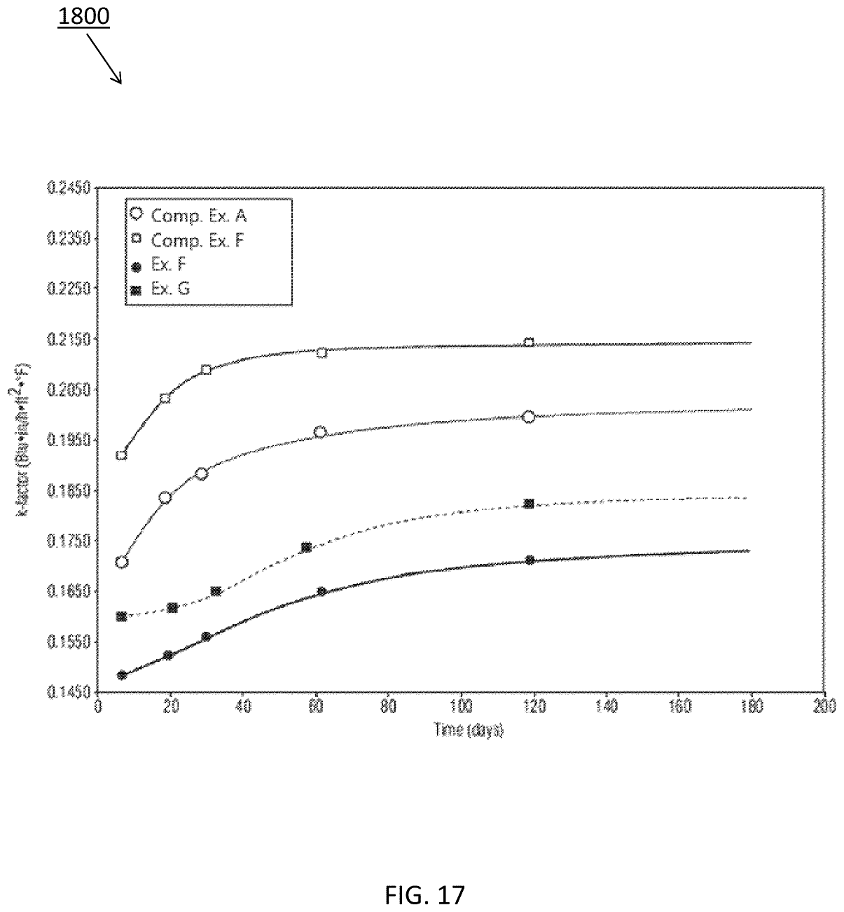

Additionally, the removal of graphite from the foam composition led to an increased k-factor (Comparative Examples B-E as compared to Comparative Example A), with an increased amount of fluorinated alkene blowing agent having less of an increase. However, the use of a PVOH-based barrier coating on the foam (Examples A-D) reduced the k-factor to an amount below the control (Comparative Sample A). As shown in the graph 1800 of FIG. 17, the PVOH coating also provides improved insulation properties for foams including an infrared attenuating agent (graphite) (Samples F and G).

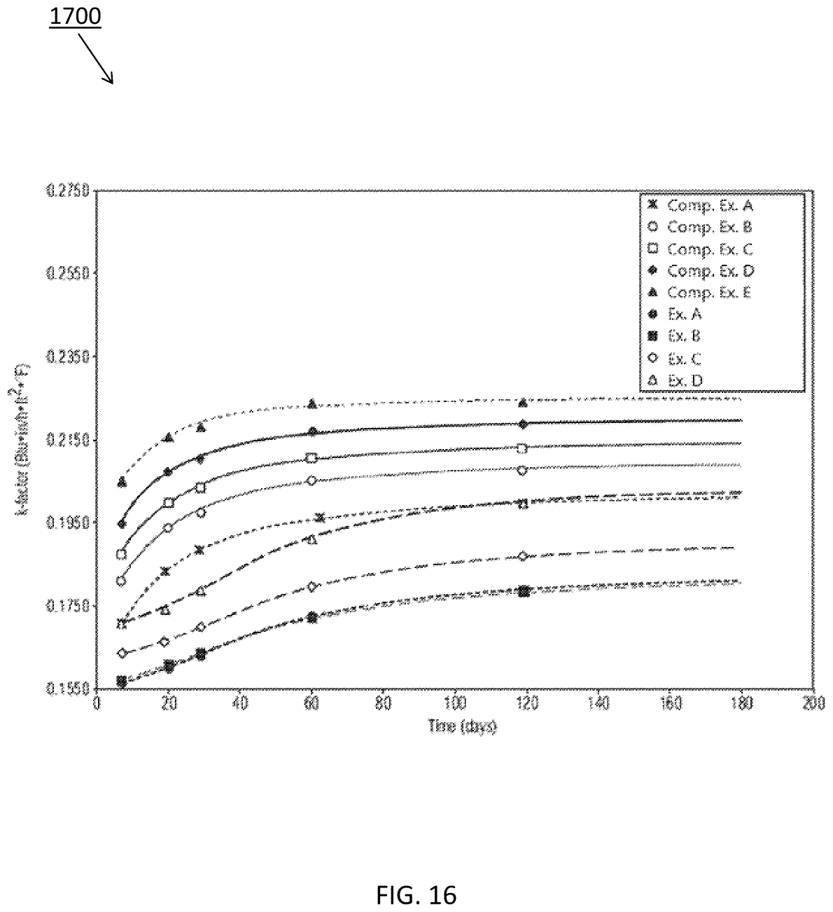

Notably, in the graphs 1700 and 1800 of FIGS. 16 and 17, respectively, a combination of a PVOH coating with increased levels of fluorinated alkene blowing agent yielded the greatest improvement in insulation properties. However, FIGS. 16-17 demonstrate that less blowing agent can be used to achieve the same or improved insulation properties.

### Example 2

A barrier coating composition comprising DIOFAN® A050 (a PVDC dispersion containing about 58 wt. % solids commercially available from Solvay) was applied with a brush to various surfaces of 1-inch XPS foam samples at various coat weights, as set forth in Table 12. The XPS foam was formed using a blowing agent composition comprising a blend of HFO-1336mzz-Z and HFC-152a.

TABLE 12

| | | | 180 days | |
|---|---|---|---|---|
| | | Final Coat | k-value | |
| Sample | | Weight | (BTU · in/ | 180 days |
| No. | Coating | (g) | h · ft² · ° F.) | R/in |
| Comp. Ex. G | No Coating | — | 0.2017 | 4.96 |
| Ex. H | PVDC-based | 2.32 | 0.1969 | 5.08 |
| | | (~10.7 g/m²) | | |
| Ex. I | PVDC-based | 4.71 | 0.1790 | 5.59 |
| | | ((~21.73 g/m²) | | |
| Ex. J | PVDC-based | 7.12 | 0.1538 | 6.50 |
| | | (~32.85 g/m²) | | |

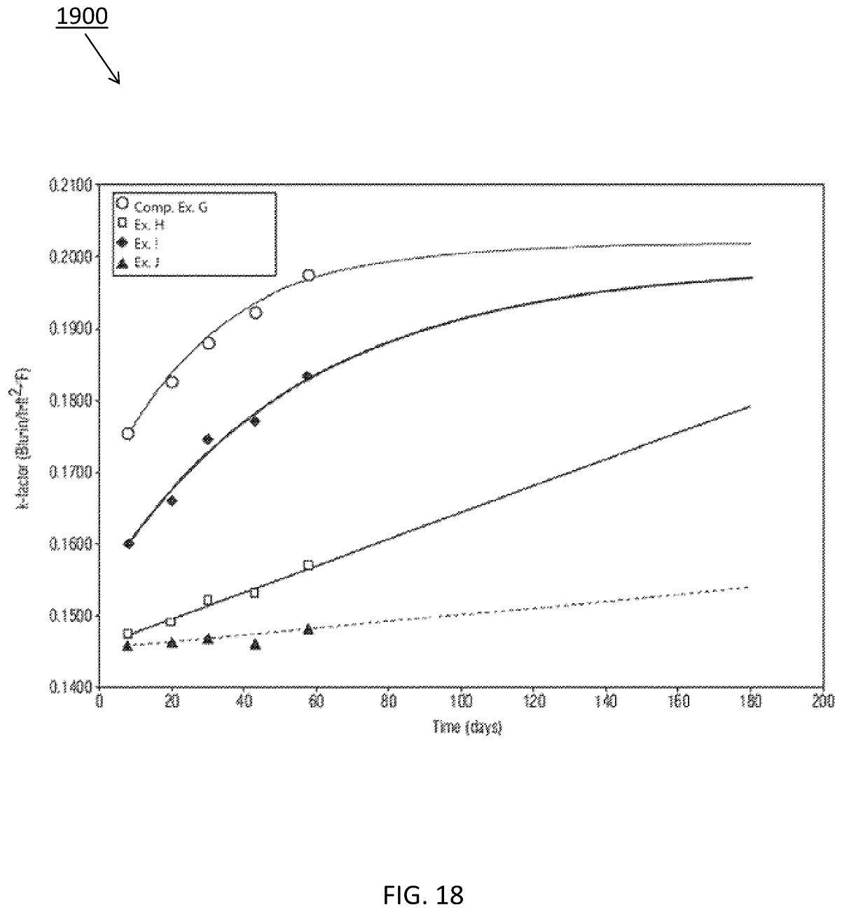

As shown in Table 12 and the graph 1900 of FIG. 18, the effectiveness of the barrier coating at significantly slowing the diffusion rates of the blowing agents increased with increased coating weight, as indicated by the improved R-values and reduced 180 day k-values, as compared to the control (Comp. Ex. G).

### Example 3

A barrier coating composition comprising an aqueous dispersion of styrene butadiene rubber was brushed onto one or more surfaces of 1-inch samples of extruded polystyrene foam and dried to form a barrier coated polystyrene foam. The polystyrene foam was formed using a blowing agent composition comprising a blend of HFO-1336mzz-Z and HFC-152a. Locations of the application of the barrier coating composition are provided in Table 13.

TABLE 13

| | | 180 days | |
|---|---|---|---|
| | | k-value | |
| Sample | Coated | (BTU · in/ | 180 days |
| No. | Surfaces | h · ft² · ° F.) | R/in |
| Comp. Ex. M | No coating | 0.1976 | 5.06 |
| Ex. U | Top/bottom/4 edges | 0.1954 | 5.12 |
| Ex. V | Top and | 0.1963 | 5.09 |
| | bottom only | | |
| Ex. W | Top/bottom/3 edges | 0.1956 | 5.11 |
| Ex. X | 4 edges only | 0.1981 | 5.05 |

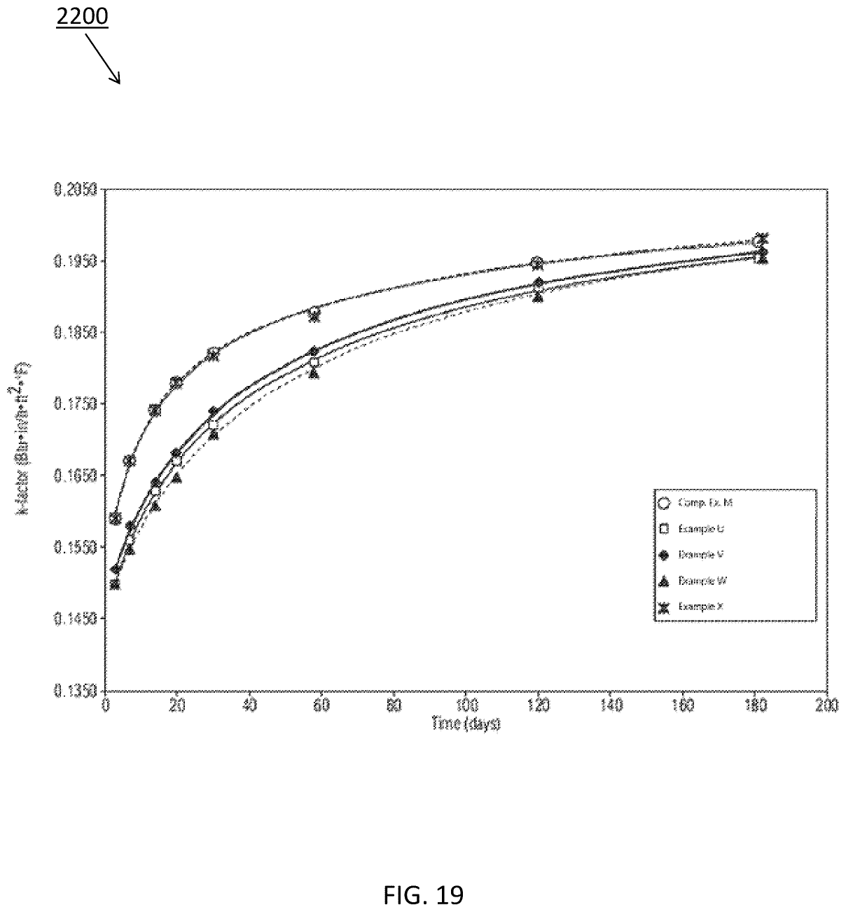

As shown in the graph 2200 of FIG. 19, each of the samples that had at least the top and bottom surfaces coated with the barrier coating composition (Samples U-W) exhibited improved thermal properties (lower k-value and increased R-value) as compared to the control sample (Comp. Ex. M) and the sample with only the edges coated (Sample X).

### Example 4

Extruded polystyrene foam samples were prepared using a co-rotating twin screw single extrusion foam manufacturing line. Polystyrene was melted in the extruder and mixed with an injected blowing agent composition to form a homogeneous foamable composition. The foamable composition (excluding the blowing agent) included polystyrene, flame retardant masterbatch, and graphite masterbatch, and is reported as the “solids” in Table 14. An aqueous dispersion of styrene butadiene rubber (50 wt. % solids in water) was injected directly into the extruder at various concentrations. The polystyrene foam was formed using a blowing agent composition comprising a blend of HFO-1336mzz-Z and HFC-152a in a constant amount across all samples. The foamable compositions were then extruded to produce 1-inch XPS foam samples. Each of the foamable compositions is provided in Table 14.

TABLE 14

| Sample No. | Solids (wt. %) | SBR (wt. %) |
|---|---|---|
| Comp. Ex. N | 100 | 0.00 |
| Ex. Y | 99.95 | 0.05 |
| Ex. Z | 99.90 | 0.10 |
| Ex. AA | 99.85 | 0.15 |
| Ex. BB | 99.80 | 0.20 |
| Ex. CC | 99.75 | 0.25 |
| Ex. DD | 99.62 | 0.38 |
| Ex. EE | 99.50 | 0.50 |

Table 15, below, lists the properties of the resulting XPS foam samples.

TABLE 15

| | | | | Avg. | | | |
|---|---|---|---|---|---|---|---|
| | | | 180 | Cell | Open | Compressive | Compressive |
| | Density | 180 days k-value | days | Sizes | Cells | Strength | Modulus |
| Sample No. | (lb/ft³) | (BTU · in/h · ft² · ° F.) | R/in | (mm) | (%) | (psi) | (psi) |
| Comp. Ex. | 2.27 | 0.1997 | 5.01 | 0.18 | 1.5 | 42.6 | 1180 |
| N | | | | | | | |
| Ex. Y | 2.24 | 0.1986 | 5.04 | 0.17 | 1.96 | 43.9 | 1187 |
| Ex. Z | 2.23 | 0.1991 | 5.02 | 0.17 | 0.44 | 44.7 | 1256 |
| Ex. AA | 2.17 | 0.1973 | 5.07 | 0.19 | 1.73 | 42.9 | 1269 |
| Ex. BB | 2.19 | 0.1983 | 5.04 | 0.17 | 1.19 | 44.3 | 1234 |
| Ex. CC | 2.19 | 0.1976 | 5.06 | 0.17 | 1.70 | 45.6 | 1352 |
| Ex. DD | 2.16 | 0.2011 | 4.97 | 0.17 | 0.36 | 47.3 | 1491 |
| Ex. EE | 2.30 | 0.2018 | 4.96 | 0.17 | 1.17 | 55.0 | 2015 |

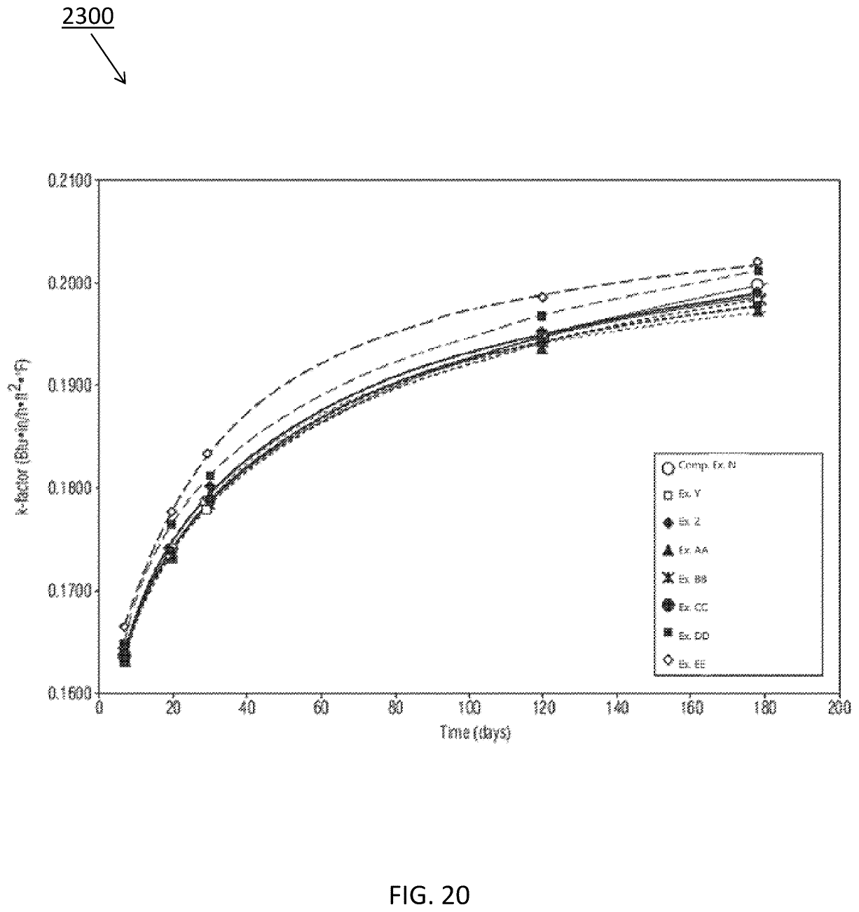

As shown in Table 15 and the graph 2300 of FIG. 20, XPS foam produced including SBR dispersion in amounts from 0.05 wt. % to 0.25 wt. % demonstrated improved insulation properties (e.g., a lower k-value) as compared to the control (Comp. Example N). Additionally, the data presented in Table 15 illustrates that the barrier coating composition can be injected during the foaming process without negatively impacting the foam properties. For example, the compressive strength and compressive modulus for each of the examples was increased as compared to the control sample (Comp. Example N).

### Example 5

Varying amounts of one of two barrier coatings (an aqueous dispersion of ethylene vinyl alcohol (EVOH) or an aqueous dispersion of polyvinyl alcohol (PVOH)) were applied with a brush to various surfaces of 1-inch XPS foam samples. Locations of the application of the barrier coating composition are provided in Table 16.

TABLE 16

| | | | | 180-days | |
|---|---|---|---|---|---|
| | | | Final Coat | k-value | |
| Sample | Coated | Coating | Weight | (BTU · in/ | 180-days |
| No. | Surfaces | Composition | (g) | h · ft² · ° F.) | R/in |
| Comp. | No coating | N/A | 0.00 | 0.2134 | 4.69 |
| Ex. O | | | | | |
| Ex. FF | Top/bottom/4 | EVOH | 7.40 | 0.2077 | 4.81 |
| | edges | | (~34.14 | | |
| | | | g/m²) | | |
| Ex. GG | Top/4 edges | EVOH | 18.01 | 0.1955 | 5.12 |
| | | | (~83.08 | | |
| | | | g/m²) | | |
| Ex. HH | Top only | EVOH | 4.51 | 0.2087 | 4.79 |
| | | | (~20.81 | | |
| | | | g/m²) | | |
| Ex. II | Top/bottom/4 | EVOH | 17.30 | 0.1910 | 5.24 |
| | edges | | (~79.81 | | |
| | | | g/m²) | | |
| Ex. JJ | Top/bottom/4 | PVOH | 8.39 | 0.1860 | 5.38 |
| | edges | | (~38.70 | | |
| | | | g/m²) | | |
| Ex. KK | Top/4 edges | PVOH | 11.23 | 0.1787 | 5.60 |
| | | | (~51.81 | | |
| | | | g/m²) | | |
| Ex. LL | Top only | PVOH | 7.98 | 0.1736 | 5.76 |
| | | | (~36.81 | | |
| | | | g/m²) | | |
| Ex. MM | Top/bottom/4 | PVOH | 8.00 | 0.1959 | 5.11 |
| | edges | | (~36.91 | | |
| | | | g/m²) | | |

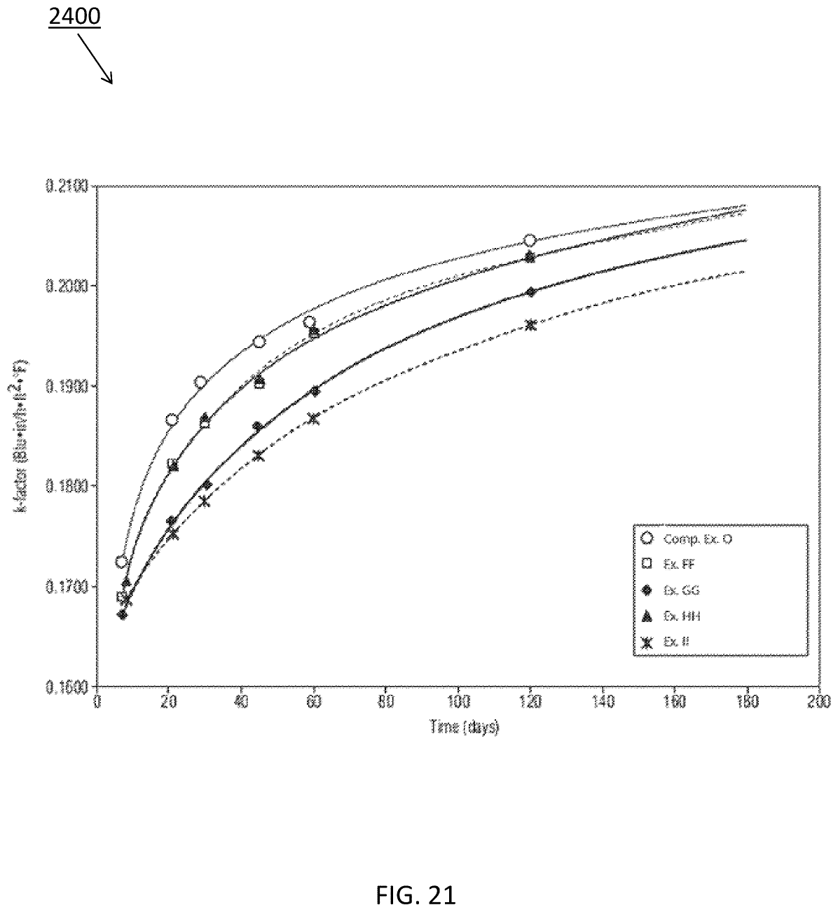

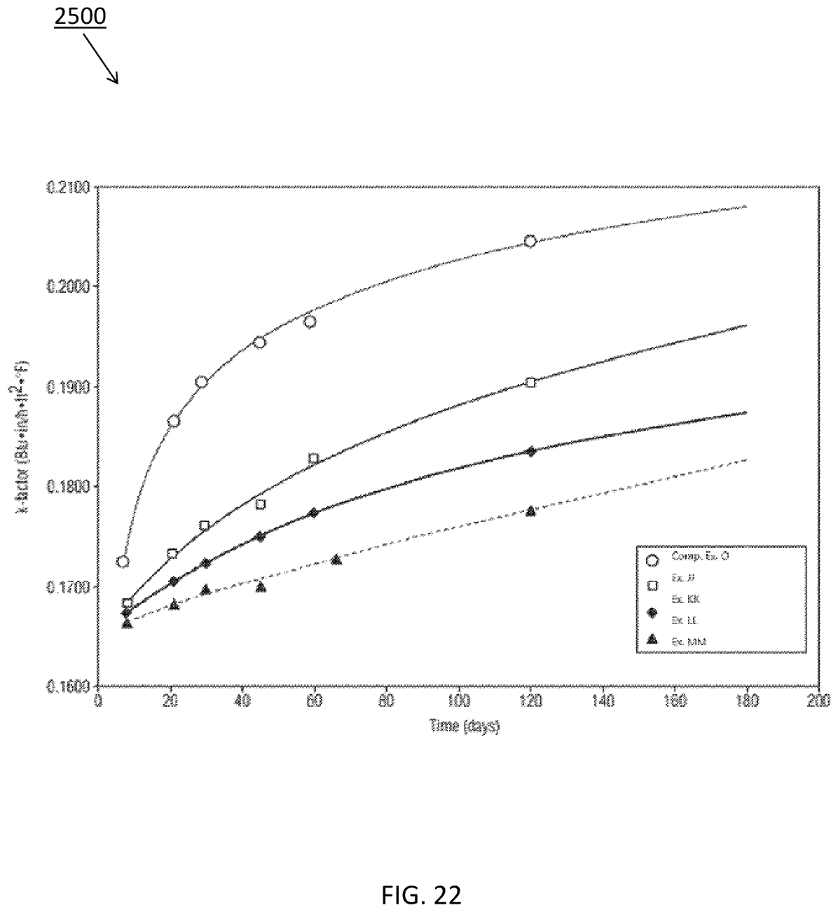

As shown in Table 16 and the graphs 2400 and 2500 of FIGS. 21 and 22, respectively, both the EVOH and PVOH coatings were effective at significantly slowing the diffusion rates of the blowing agents, as indicated by the improved R-values and reduced 180 day k-values, as compared to the control (Comp. Example O). For Example LL, PVOH improved the R-value of the foam sample by about 23%, as compared to the control (Comp. Example O). Additionally, the results show that it is not necessarily true that more coating leads to better thermal conductivity. Rather, Example LL, having about 36.81 g/m² of coating applied to the sample demonstrates a better 180-day thermal conductivity value than Examples KK, JJ, and MM, each having a heavier application of PVOH-based barrier coating. Thus, a balance must be struck between coat weight and impact to the foam product's thermal conductivity to achieve optimal performance.

### Example 6

Various barrier coatings and barrier coating combinations were applied to 1-inch XPS foam samples, as set forth in Table 17. PUD 1 and PUD 2 are two different commercially available polyurethane dispersions. For Samples OO and PP, the PVOH coating system was applied to the foam surface first and allowed to dry and then the PUD 1 or PUD 2 were applied to the top of the PVOH coating.

TABLE 17

| | | 180 days k-value | 180 days |
|---|---|---|---|
| Sample No. | Coating | (BTU · in/h · ft² · ° F.) | R/in |
| Comp. Ex. P | None | 0.2078 | 4.81 |
| Ex. NN | PVOH | 0.1901 | 5.26 |
| Comp. Ex. Q | PUD1 | 0.2084 | 4.80 |
| Comp. Ex. R | PUD2 | 0.2086 | 4.79 |
| Ex. OO | PVOH + PUD1 | 0.1759 | 5.69 |
| Ex. PP | PVOH + PUD2 | 0.1795 | 5.57 |

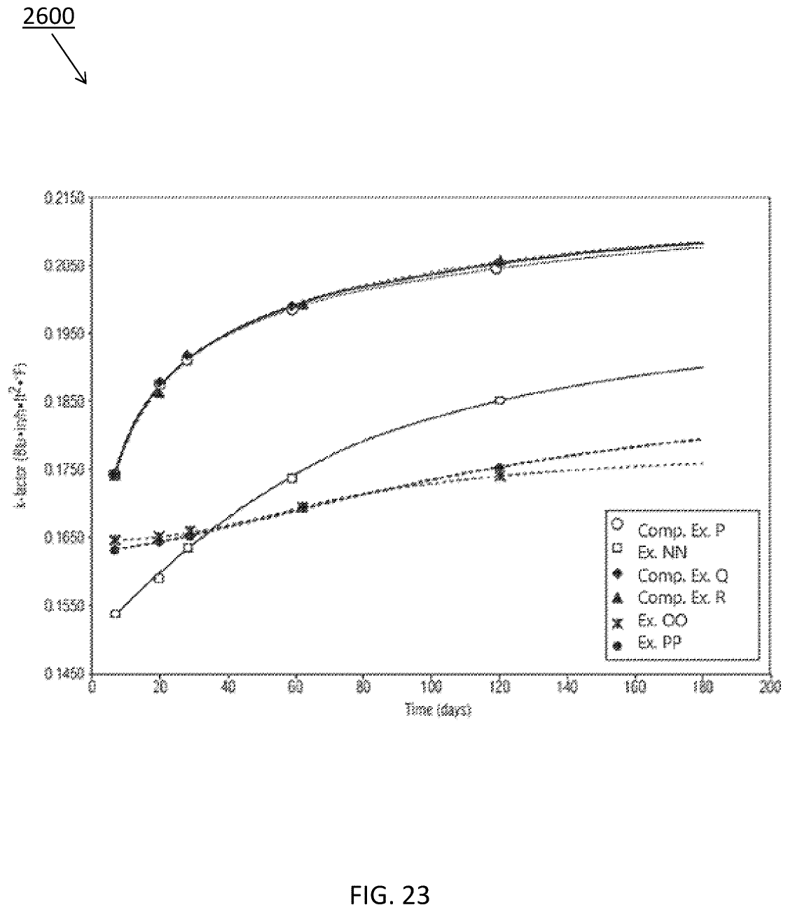

As shown in the graph 2600 of FIG. 23, the PUD 1 and PUD 2 applied coatings by themselves (Comp. Examples Q and R, respectively) did not provide any barrier properties to the foam. However, when applied to the surface of the applied PVOH coating (Samples OO and PP, respectively), they enhanced the barrier properties of the PVOH coating (Sample NN). Without wishing to be bound by theory, it is believed that the application of a PUD or hydrophobic coating to a PVOH or EVOH coating, which tend to be more hydrophilic and susceptible to moisture, can protect the hydrophilic coating and enhance the resistant properties of the hydrophilic coating.

### Example 7

Extruded polystyrene foams including various blowing agent compositions were prepared and coated with the barrier coating composition in accordance with aspects and embodiments of the present disclosure to evaluate the effects of the barrier coating on the thermal conductivity properties of the foams. Each of the foamable compositions is provided in Table 18.

TABLE 18

| | | Methyl | | Flame | |
|---|---|---|---|---|---|
| | CO₂ | Formate | IAA | Retardant | Density |
| Sample No. | (wt. %) | (wt. %) | (wt. %) | (wt. %) | (lb/ft³) |
| Comp. Ex. S | 3.31 | 1.50 | 0.60 | 1.00 | 2.27 |
| Ex. QQ | 3.31 | 1.50 | 0.60 | 1.00 | 2.27 |
| Ex. RR | 3.31 | 1.50 | 0.60 | 1.00 | 2.27 |
| Ex. SS | 3.31 | 1.50 | 0.60 | 1.00 | 2.27 |

A barrier coating composition comprising DIOFAN® A050 (a PVDC dispersion containing about 58 wt. % solids commercially available from Solvay) was applied with a brush to various surfaces of 1-inch XPS foam samples at various coat weights, as set forth in Table 19.

TABLE 19

| | | | 180 days | |
|---|---|---|---|---|
| | | Final Coat | k-value | |
| | | Weight | (BTU · in/ | 180 days |
| Sample No. | Coating | (g) | h · ft² · ° F.) | R/in |
| Comp. Ex. S | No Coating | — | 0.2298 | 4.35 |
| Ex. QQ | PVDC-based | 6.22 | 0.2050 | 4.88 |
| | | (~28.69 g/m²) | | |
| Ex. RR | PVDC-based | 11.93 | 0.1970 | 5.20 |
| | | (~55.03 g/m²) | | |
| Ex. SS | PVDC-based | 21.03 | 0.1766 | 5.66 |
| | | (~95.21 g/m²) | | |

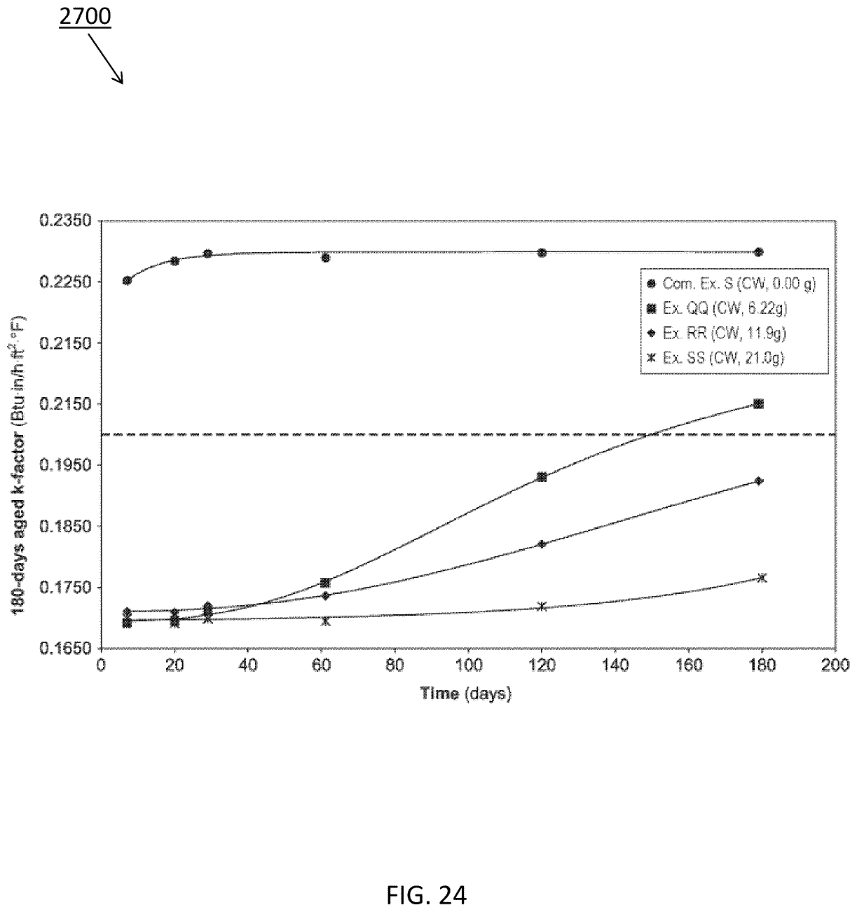

As shown in Table 19 and the graph 2700 of FIG. 24, the effectiveness of the barrier coating at significantly slowing the diffusion rates of the blowing agents increased with increased coating weight, as indicated by the improved R-values and reduced 180 day k-values, as compared to the control.

### Example 8

Extruded polystyrene foam samples were prepared using a co-rotating twin screw extrusion foam line. Polystyrene was melted in the extruder and mixed with an injected blowing agent composition to form a homogeneous foamable composition. Each foamable composition was the same, and included 100 wt. % polystyrene, flame retardant masterbatch, and graphite masterbatch. A blowing agent blend comprising a blend of a fluorinated alkene and a hydrofluorocarbon was included as a constant between all samples, in both concentration and composition.

The foamable compositions were extruded to produce 1-inch XPS foam samples, each having a density of about 2.2 pcf.

Comparative Sample 1 was left uncoated, while Samples 1 to 5 were coated with an exemplary barrier coating composition on at least one side using a hand sprayer, as outlined in Table 20, below. The barrier coating composition is provided below in Table 21.

TABLE 20

| | | Foam + | Foam + | |
|---|---|---|---|---|
| | Foam Sample | Coat | Coat | Final Coat |
| | Wt. | 1 Wt. | 2 Wt. | Weight |
| Sample No. | (g) | (g) | (g) | (g/m²) |
| Comparative | 79.28 | — | — | — |
| Sample 1 | | | | |
| Sample 1 | 79.06 | 80.27 | 83.69 | 9.84 |
| Sample 2 | 79.05 | 80.27 | 83.88 | 13.13 |
| Sample 3 | 79.35 | 80.28 | 84.10 | 51.13 |
| Sample 4 | 80.41 | 80.52 | 84.01 | 38.75 |
| Sample 5 | 80.56 | 81.34 | 85.37 | 51.77 |

TABLE 21
Barrier Coating Formulations (based on wt. % solids)

| | Sample 1 | | Sample 2 | | Sample 3 | | Sample 4 | | Sample 5 | |
|---|---|---|---|---|---|---|---|---|---|---|
| PVDC | 99.9 | wt. % | 99.8 | wt. % | 99.7 | wt. % | 99.6 | wt. % | 99.5 | wt. % |
| barrier | | | | | | | | | | |
| polymer | | | | | | | | | | |
| Rheology | 0.1 | wt. % | 0.2 | wt. % | 0.3 | wt. % | 0.4 | wt. % | 0.5 | wt. % |
| modifier | | | | | | | | | | |

Thermal conductivity for each Sample was tested in accordance with ASTM C578 (70 F and 45% relative humidity) on the following interval schedule: Day 7 (k7), Day 20 (k20), Day 30 (k30), Day 60 (k60), Day 120, and Day 180, and the performance is provided below in Table 22.

TABLE 22

| | k-value (Btu · in/h · ft² · ° F.) | | | | | |
|---|---|---|---|---|---|---|
| Sample No. | k7 | k20 | k30 | k60 | k120 | k180 |
| Comparative | 0.1641 | 0.1753 | 0.1806 | 0.1879 | 0.1943 | 0.1981 |
| Sample 1 | | | | | | |
| Sample 1 | 0.1399 | 0.1415 | 0.1421 | 0.1450 | 0.1496 | 0.1534 |
| Sample 2 | 0.1402 | 0.1412 | 0.1433 | 0.1467 | 0.1527 | 0.1568 |
| Sample 3 | 0.1405 | 0.1415 | 0.1434 | 0.1470 | 0.1527 | 0.1566 |
| Sample 4 | 0.1454 | 0.1520 | 0.1558 | 0.1631 | 0.1706 | 0.1753 |
| Sample 5 | 0.1410 | 0.1417 | 0.1434 | 0.1458 | 0.1516 | 0.1555 |

As illustrated in Table 22, the uncoated Comparative Sample demonstrated a thermal conductivity k-value of greater than 0.175 BTU·in/h·ft²·° F. as early as day 20 (k20), while each of the inventive Samples coated with the barrier coating composition remained wth k-factors below 0.175 BTU·in/h·ft²·° F. after 180 days and below 0.18 Btu·in/h·ft²·° F. after 180 days.

### Example 9

Extruded polystyrene foam samples were prepared using a co-rotating twin screw extrusion foam line. Polystyrene was melted in the extruder and mixed with an injected blowing agent composition to form a homogeneous foamable composition. Each foamable composition was the same, and included 100 wt. % polystyrene, flame retardant masterbatch, and graphite masterbatch. A blowing agent blend comprising about 50 wt. % CO₂ and about 50 wt. % of a blend of an HFO and an HFC, based on the total weight of the blowing agent, was included at a constant recipe and total amount across all foam samples.

The foamable compositions were extruded to produce 1-inch XPS foam samples, each having a density of about 2.3 pcf.

Comparative Sample 2 was left uncoated, while Samples 6 to 10 were coated with an exemplary barrier coating composition on at least one side using a hand sprayer, as outlined in Table 23, below. The barrier coating composition is provided below in Table 24.

TABLE 23

| | | Foam + | Foam + | |
|---|---|---|---|---|
| | Foam Sample | Coat 1 | Coat 2 | Final Coat |
| Sample | Wt. | Wt. | Wt. | Wt. |
| No. | (g) | (g) | (g) | (g/m²) |
| Comparative | 75.13 | — | — | — |
| Sample | | | | |
| 2 | | | | |
| Sample 6 | 75.28 | 82.35 | 84.24 | 96.44 |
| Sample 7 | 74.55 | 83.54 | 86.96 | 133.6 |
| Sample 8 | 75.49 | 84.89 | 89.45 | 150.3 |
| Sample 9 | 74.95 | 87.00 | 92.93 | 193.5 |
| Sample 10 | 74.60 | 88.78 | 95.70 | 227.1 |

TABLE 24
Barrier Coating Formulation

| Adjusted pH | 7.03 | |
|---|---|---|
| Barrier Polymer | 94.7 | wt. % |
| pH adjuster | 0.95 | wt. % |
| defoamer | 0.2 | wt. % |
| Non-ionic wetting agent | 0.2 | wt. % |
| Rheology modifier | 0.3 | wt. % |
| UV absorber | 2.8 | wt. % |
| Anti-blocker | 0.95 | wt. % |

Thermal conductivity for each Sample was tested in accordance with ASTM C578 (70 F and 45% relative humidity) on the following interval schedule: Day 7 (k7), Day 20 (k20), Day 30 (k30), and Day 60 (k60) and the performance is provided below in Table 25.

TABLE 25

k-value (Btu · in/h · ft² · ° F.)

| Sample No. | k7 | k20 | k30 | k60 |
|---|---|---|---|---|
| Comparative | 0.1879 | 0.2013 | 0.2050 | 0.2099 |
| Sample 2 | | | | |
| Sample 6 | 0.1707 | 0.1861 | 0.1911 | 0.1986 |
| Sample 7 | 0.1603 | 0.1696 | 0.1749 | 0.1831 |
| Sample 8 | 0.1581 | 0.1609 | 0.1626 | 0.1674 |
| Sample 9 | 0.1584 | 0.1597 | 0.1609 | 0.1623 |
| Sample 10 | 0.1583 | 0.1596 | 0.1608 | 0.1618 |

As illustrated in Table 25, the uncoated Comparative Sample demonstrated a thermal conductivity k-value of greater than 0.2 BTU·in/h·ft²·° F. as early as day 20 (k20), while each of the inventive Samples coated with the barrier coating composition remained with k-factors below 0.2 BTU·in/h·ft²·° F., even after 60 days.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

From the foregoing, it will be seen that this invention is one well-adapted to attain all the ends and objects hereinabove set forth together with other advantages which are obvious and which are inherent to the structure.

It will be understood that certain features and subcombinations are of utility and can be employed without reference to other features and subcombinations. This is contemplated by and is within the scope of the claims.

While specific elements and steps are discussed in connection to one another, it is understood that any element and/or steps provided herein is contemplated as being combinable with any other elements and/or steps regardless of explicit provision of the same while still being within the scope provided herein. Since many possible embodiments can be made of the disclosure without departing from the scope thereof, it is to be understood that all matter herein set forth or shown in the accompanying drawings is to be interpreted as illustrative and not in a limiting sense.

The invention claimed is:

1. A sheathing system to externally envelop at least a portion of a building structure, the system comprising: at least one panel including a first structural layer having a first surface and a second surface opposite the first surface; a second structural layer having a fifth surface and a sixth surface opposite the fifth surface; an insulation layer having a third surface and a fourth surface opposite the third surface, the third surface of the insulation layer being at least partially secured to the second surface of the first structural layer and the fifth surface of the second structural layer being at least partially secured to the fourth surface of the insulation layer, the insulation layer being formed from a foamable composition comprising: a) a matrix composition, and b) a blowing agent composition comprising 15 wt. % to 60 wt. % of a fluorinated alkene and 40 wt. % to 85 wt. % of at least one co-blowing agent; and a barrier coating applied to at least one surface of the insulation layer in a total amount between 3 g/m² to 225 g/m², the barrier coating being formed from a barrier coating composition comprising: 40 wt. % to 99.9 wt. % of a barrier polymer, based on a total solids content of the barrier coating composition, the barrier polymer having a minimum degree of crystallinity of 10%, and 0.1 wt. % to 20 wt. % of at least one additive, wherein the barrier coating composition has a surface tension no greater than 40 mN/m, and wherein the sheathing system has a 180-day R/in value of at least 4.8.

2. The sheathing system of claim 1, wherein a distance from the first surface of the first structural layer to the sixth surface of the second structural layer is 3.5 inches or less.

3. The sheathing system of claim 1, wherein the sheathing system has a racking performance of greater than 640 plf.

4. The sheathing system of claim 1, wherein the first structural layer comprises a polymer material, said polymer material comprising any one or more of polycarbonate, polyester, polypropylene, polymethyl methacrylate, poly vinyl chloride, polyethylene, high density polyethylene, and acrylonitrile butadiene styrene (ABS), and combinations thereof.

5. The sheathing system of claim 1, wherein the second structural layer comprises a wood composite material, and
wherein a thickness of the second structural layer is in the range of ¼ inch to 1⅛ inches.

6. The sheathing system of claim 5, wherein the wood composite material comprises at least one of oriented strand board, fiberboard, and plywood.

7. The sheathing system of claim 1, wherein the fluorinated alkene is one or more of (cis and/or trans)-1,1,1,4,4,4-hexafluoro-2-butene (HFO-1336mzz) and (cis and/or trans)-1,3,3,3-tetrafluoropropene (HFO-1234ze).

8. The sheathing system of claim 1, wherein the barrier coating composition has a viscosity no greater than 250 cP at 30% solids.

9. The sheathing system of claim 1, wherein the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

10. The sheathing system of claim 1, wherein the barrier polymer has a minimum degree of crystallinity of 30%.

11. A sheathing system to externally envelop at least a portion of a building structure, the system comprising: at least one panel including a first structural layer having a first surface and a second surface opposite the first surface; a second structural layer having a fifth surface and a sixth surface opposite the fifth surface; an insulation layer having a third surface and a fourth surface opposite the third surface, the third surface of the insulation layer being at least partially secured to the second surface of the first structural layer and the fifth surface of the second structural layer being at least partially secured to the fourth surface of the insulation layer, the insulation layer being formed from a foamable composition comprising: a) a polymer matrix composition; and b) a blowing agent composition comprising 15 wt. % to 60 wt. % of a fluorinated alkene and 40 wt. % to 85 wt. % of a co-blowing agent; and a barrier coating present on each surface of the insulation layer in a total amount between 3 g/m² and 225 g/m², the barrier coating being formed from a barrier coating composition comprising a semi-crystalline polymer and at least one wetting agent, the barrier coating composition having a surface tension no greater than 10 mN/m above a surface energy of the polymer foam and a viscosity between 50 cP and 175 cP at 30% solids or less, wherein the sheathing system has a 180-day R/in value of at least 4.8 and a compressive strength between 10 and 110 psi, measured in accordance with ASTM C578.

12. The sheathing system of claim 11, wherein a distance from the first surface of the first structural layer to the sixth surface of the second structural layer is 1.5 inches or less.

13. The sheathing system of claim 11, wherein the sheathing system has a racking performance of greater than 640 plf.

14. The sheathing system of claim 11, wherein the first structural layer comprises a polymer material, said polymer material comprising any one or more of polycarbonate, polyester, polypropylene, polymethyl methacrylate, poly vinyl chloride, polyethylene, high density polyethylene, and acrylonitrile butadiene styrene (ABS), and combinations thereof.

15. The sheathing system of claim 11, wherein the fluorinated alkene is one or more of (cis and/or trans)-1,1,1,4,4,4-hexafluoro-2-butene (HFO-1336mzz) and (cis and/or trans)-1,3,3,3-tetrafluoropropene (HFO-1234ze).

16. The sheathing system of claim 11, wherein the co-blowing agent comprises hydrocarbons, hydrofluorocarbons (“HFC”), hydrochlorofluorocarbons (“HCFO”), carbon dioxide, methyl formate, methylal, water, or mixtures thereof.

17. The sheathing system of claim 11, wherein the barrier coating composition has a viscosity no greater than 150 cP at 30% solids.

18. The sheathing system of claim 11, wherein the barrier polymer comprises any one or more of poly(vinylidene chloride), polyvinyl alcohol, poly(ethylene-co-vinyl alcohol), poly(vinylidene fluoride), polyurethane, styrene butadiene, polyvinyl chloride, poly(acrylates), polyamides, polyesters, polystyrene, polyglycolic acid, poly(ethylene 2,5-furandicarboxylate), poly(butylene succinate), bio-based ethylene, and copolymers thereof.

19. The sheathing system of claim 11, wherein the barrier polymer has a minimum degree of crystallinity of 30%.

20. The sheathing system of claim 11, wherein the barrier coating has a pH between 4 and 7.
